(19) United States
(12) Patent Application Publication
(10) Pub. No.: US 2011/0211590 A1
(43) Pub. Date: Sep. 1, 2011

(54) Presenting messages through a channel of a non-communication productivity application interface

(75) Inventors: Edward K.Y. Jung, Bellevue, WA (US); Eric C. Leuthardt, St. Louis, MO (US); Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US); Lowell L. Wood, JR., Bellevue, WA (US)

(73) Assignee: Searete LLC, a limited liability corporation of the State of Delaware

(21) Appl. No.: 12/798,915

(22) Filed: Apr. 12, 2010

Related U.S. Application Data
(63) Continuation-in-part of application No. 12/660,526, filed on Feb. 26, 2010.
Application No. 12/660,526 is a continuation-in-part of application No. 12/798,753, filed on Apr. 9, 2010.

(51) Int. Cl. H04J 3/00

(52) U.S. Cl. 370/464

(57) ABSTRACT

A computationally implemented method includes, but is not limited to: providing at least to one or more associated end users from a group of associated end users a non-communication (NC) productivity application interface including a channel for accessing messages; and presenting to the one or more associated end users, via the channel, at least a first one or more messages and a second one or more messages, the first one or more messages being associated with the group of associated end users and the second one or more messages being independent of the group of associated end users. In addition to the foregoing, other method aspects are described in the claims, drawings, and text forming a part of the present disclosure.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

### RELATED APPLICATIONS

For purposes of the USPTO extra-statutory requirements, the present application constitutes a continuation-in-part of U.S. patent application Ser. No. 12/660,526, entitled PROVIDING A MODIFIED NON-COMMUNICATION APPLICATION INTERFACE FOR PRESENTING A MESSAGE, naming Edward K. Y. Jung; Eric C. Leuthardt; Royce A. Levien; Richard T. Lord; Robert W. Lord; Mark A. Malamud; John D. Rinaldo, Jr.; Lowell L. Wood, Jr. as inventors, filed Feb. 26, 2010, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 12/661,410, entitled PROVIDING A MODIFIED NON-COMMUNICATION APPLICATION INTERFACE FOR PRESENTING A MESSAGE, naming Edward K. Y. Jung; Eric C. Leuthardt; Royce A. Levien; Richard T. Lord; Robert W. Lord; Mark A. Malamud; John D. Rinaldo, Jr.; Lowell L. Wood, Jr. as inventors, filed Mar. 15, 2010, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar.

18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

### SUMMARY

A computationally implemented method includes, but is not limited to providing at least to one or more associated end users from a group of associated end users a non-communication (NC) productivity application interface including a channel for accessing messages; and presenting to the one or more associated end users, via the channel, at least a first one or more messages and a second one or more messages, the first one or more messages being associated with the group of associated end users and the second one or more messages being independent of the group of associated end users. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

A computationally implemented system includes, but is not limited to: means for providing at least to one or more associated end users from a group of associated end users a non-communication (NC) productivity application interface including a channel for accessing messages; and means for presenting to the one or more associated end users, via the channel, at least a first one or more messages and a second one or more messages, the first one or more messages being associated with the group of associated end users and the second one or more messages being independent of the group of associated end users. In addition to the foregoing, other system aspects are described in the claims, drawings, and text forming a part of the present disclosure.

A computationally implemented system includes, but is not limited to: circuitry for providing at least to one or more associated end users from a group of associated end users a non-communication (NC) productivity application interface including a channel for accessing messages; and circuitry for presenting to the one or more associated end users, via the channel, at least a first one or more messages and a second one or more messages, the first one or more messages being associated with the group of associated end users and the second one or more messages being independent of the group of associated end users. In addition to the foregoing, other system aspects are described in the claims, drawings, and text forming a part of the present disclosure.

A computer program product including a signal-bearing medium bearing one or more instructions for providing at least to one or more associated end users from a group of associated end users a non-communication (NC) productivity application interface including a channel for accessing messages; and one or more instructions for presenting to the one or more associated end users, via the channel, at least a first one or more messages and a second one or more messages, the first one or more messages being associated with the group of associated end users and the second one or more messages being independent of the group of associated end users. In addition to the foregoing, other computer program product aspects are described in the claims, drawings, and text forming a part of the present disclosure.

A method for presenting multiple messages from multiple sources through a channel of a non-communication productivity application interface, the method includes providing at least to one or more associated end users from a group of associated end users a non-communication (NC) productivity application interface including a channel for accessing messages; and presenting, using a processor, to the one or more associated end users, via the channel, at least a first one or more messages and a second one or more messages, the first one or more messages being associated with the group of associated end users and the second one or more messages being independent of the group of associated end users.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIGS. 1a and 1b show a high-level block diagram of a Computing System 10 operating in a network environment.

FIG. 2a shows another perspective of the non-communication productivity application interface providing module 102 of the Computing System 10 of FIG. 1b.

FIG. 2b shows another perspective of the messages presenting module 104 of the Computing System 10 of FIG. 1b.

FIG. 3a shows a conventional web-based non-communication productivity application interface as displayed on a display screen.

FIG. 3b shows one implementation of a web-based non-communication productivity application interface with a channel for displaying messages as displayed on a display screen.

FIG. 3c shows another implementation of the web-based non-communication productivity application interface of FIG. 3b as displayed on a display screen.

FIG. 3d shows one implementation of another web-based non-communication productivity application interface with a two-window channel for displaying messages as displayed on a display screen.

FIG. 3e shows one implementation of another web-based non-communication productivity application interface with a channel for displaying messages as displayed on a display screen.

FIG. 3f shows another implementation of the web-based non-communication productivity application interface of FIG. 3e as displayed on a display screen.

FIG. 3g shows one implementation of another web-based non-communication productivity application interface with a two-window channel for displaying messages as displayed on a display screen.

FIG. 3h shows one implementation of another web-based non-communication productivity application interface with a channel for displaying messages as displayed on a display screen.

FIG. 3i shows another implementation of the web-based non-communication productivity application interface of FIG. 3h as displayed on a display screen.

FIG. 3j shows one implementation of another web-based non-communication productivity application interface with a two-window channel for displaying messages as displayed on a display screen.

FIG. 3k shows one implementation of another web-based non-communication productivity application interface with a channel for displaying messages as displayed on a display screen.

FIG. 3l shows another implementation of the web-based non-communication productivity application interface of FIG. 3k as displayed on a display screen.

FIG. 3m shows one implementation of another web-based non-communication productivity application interface with a two-window channel for displaying messages as displayed on a display screen.

FIG. 4 is a high-level logic flowchart of a process.

FIG. 5a is a high-level logic flowchart of a process depicting alternate implementations of the non-communication (NC) productivity application interface providing operation 402 of FIG. 4.

FIG. 5b is a high-level logic flowchart of a process depicting alternate implementations of the non-communication (NC) productivity application interface providing operation 402 of FIG. 4.

FIG. 5c is a high-level logic flowchart of a process depicting alternate implementations of the non-communication (NC) productivity application interface providing operation 402 of FIG. 4.

FIG. 5d is a high-level logic flowchart of a process depicting alternate implementations of the non-communication (NC) productivity application interface providing operation 402 of FIG. 4.

FIG. 5e is a high-level logic flowchart of a process depicting alternate implementations of the non-communication (NC) productivity application interface providing operation 402 of FIG. 4.

FIG. 5f is a high-level logic flowchart of a process depicting alternate implementations of the non-communication (NC) productivity application interface providing operation 402 of FIG. 4.

FIG. 5g is a high-level logic flowchart of a process depicting alternate implementations of non-communication (NC) productivity application interface providing operation 402 of FIG. 4.

FIG. 6a is a high-level logic flowchart of a process depicting alternate implementations of the messages presenting operation 404 of FIG. 4.

FIG. 6b is a high-level logic flowchart of a process depicting alternate implementations of the messages presenting operation 404 of FIG. 4.

FIG. 6c is a high-level logic flowchart of a process depicting alternate implementations of the messages presenting operation 404 of FIG. 4.

FIG. 6d is a high-level logic flowchart of a process depicting alternate implementations of the messages presenting operation 404 of FIG. 4.

FIG. 6e is a high-level logic flowchart of a process depicting alternate implementations of the messages presenting operation 404 of FIG. 4.

FIG. 6f is a high-level logic flowchart of a process depicting alternate implementations of the messages presenting operation 404 of FIG. 4.

FIG. 6g is a high-level logic flowchart of a process depicting alternate implementations of the messages presenting operation 404 of FIG. 4.

FIG. 6h is a high-level logic flowchart of a process depicting alternate implementations of the messages presenting operation 404 of FIG. 4.

FIG. 6i is a high-level logic flowchart of a process depicting alternate implementations of the messages presenting operation 404 of FIG. 4.

FIG. 6j is a high-level logic flowchart of a process depicting alternate implementations of the messages presenting operation 404 of FIG. 4.

FIG. 6k is a high-level logic flowchart of a process depicting alternate implementations of the messages presenting operation 404 of FIG. 4.

FIG. 6l is a high-level logic flowchart of a process depicting alternate implementations of the messages presenting operation 404 of FIG. 4.

FIG. 7 is another high-level block diagram showing one implementation of the computing system 10 of FIG. 1b.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Since the introduction and the subsequent integration of personal computers into the workplace, certain software programs that run on such devices have proven to be essential tools for having a productive and efficient workplace. For example, certain software programs commonly referred to as “productivity software” or “productivity applications” have become indispensable tools for many of today's businesses. There are currently a number of productivity applications available on the market including, for example, word processors, spreadsheets, presentations programs, database management programs, graphics or diagramming programs, communication programs and/or email clients, and so forth. These productivity applications may be categorized into at least two groups, one group of productivity applications that can perform communication functionalities, and a second group of productivity applications that do not generally perform communication functionalities but instead are designed to perform other functionalities. For purposes of the following description, the second group of productivity applications will be referred to as non-communication (NC) productivity applications.

Examples of productivity applications that belong to the first group (e.g., “communication” productivity applications) include, for example, personal information manager applications (e.g., Microsoft Outlook) and email clients (e.g., Hotmail, Gmail, etc.). Examples of productivity applications that belong to the second group (e.g., NC productivity applications) include word processors (e.g., Microsoft Word, Apple's Pages, and WordPerfect), spreadsheets (e.g., Apple's Numbers and Microsoft Excel), presentation programs (e.g., Microsoft PowerPoint and Apple's Keynote), diagramming programs (e.g., Microsoft Visio), and so forth.

Currently, the most well-known suite of productivity applications is Microsoft's Office, which includes, among other things, Microsoft Word (a word processing application), Microsoft Excel (a spreadsheet), Microsoft PowerPoint (e.g. a presentation application), and so forth. For a number of years, such productivity applications were generally provided to end users via CD disks or via downloads from the Internet. Once downloaded from a CD disk or from the Internet, a productivity application would reside in and be entirely executed at a client device.

In recent years, a number of companies have begun offering a variety of software programs including productivity applications through “cloud computing.” In cloud computing, software programs may not be stored and executed at an end user's client device but instead, may reside on the Internet. That is, in cloud computing a number of network devices including a number of computers, servers, and/or data storage systems that may be located at multiple network sites may be employed in order to store, maintain, and execute software programs. About the only thing that client devices of end users may need to have in order to utilize a software application (e.g., productivity application) is an application interface for accessing the software application. Such application interfaces are typically provided by the company providing the “web-based” software application.

In some cases, these web-based applications that are available through the Internet may be provided to end users for free (e.g., without any fee being charged for usage). For example, search giant Google provides a suite of productivity applications called “Docs” for free. Since Google currently does not charge a fee to end users for using their web-based productivity applications, Google generates their revenue by other means such as through advertising. Although web-based productivity applications, such as those included in Google Docs, are fully functional productivity applications, these applications tend to have less features and less functionalities than their “pay-for” counterparts (e.g., those productivity applications that are only available through purchase such as the productivity applications included in Microsoft Office).

As a result, the current perception of these free web-based productivity applications are that although these applications are functional, they are “not as good” as their pay-for counterparts. For this reason as well as for security concerns (e.g., these web-based productivity applications require the processing and/or storage of data at third party servers), the adoption of these free web-based productivity applications for use by enterprises (e.g., companies, businesses, organizations, clubs, and so forth) has been slow and somewhat limited.

In accordance with various embodiments, methods, systems, circuitry, and computer program products that are designed to, among other things, provide a non-communication (NC) productivity application interface that includes a channel for accessing a plurality of messages to one or more associated end users from a group of associated end users. The methods, systems, circuitry, and computer program products may then be designed to present to the one or more associated end users, via the channel, at least a first one or more messages and a second one or more messages, the first one or more messages being associated with the group of associated end users and the second one or more messages being independent of the group of associated end users. For these embodiments, the NC productivity application interface to be provided may be for accessing one or more web-based NC productivity applications. In various embodiments, the first one or more messages to be presented may originally be provided by an enterprise associated with the group of associated end users, by an organizational unit of the enterprise, or by a member of the enterprise. In contrast, the second one or more messages to be presented may be “independent” from the group of associated end users as a result of being provided by one or more third parties (e.g., advertisers) who are independent and/or unrelated to the group of associated end users (or independent of an enterprise or organization associated with the group of associated end users)

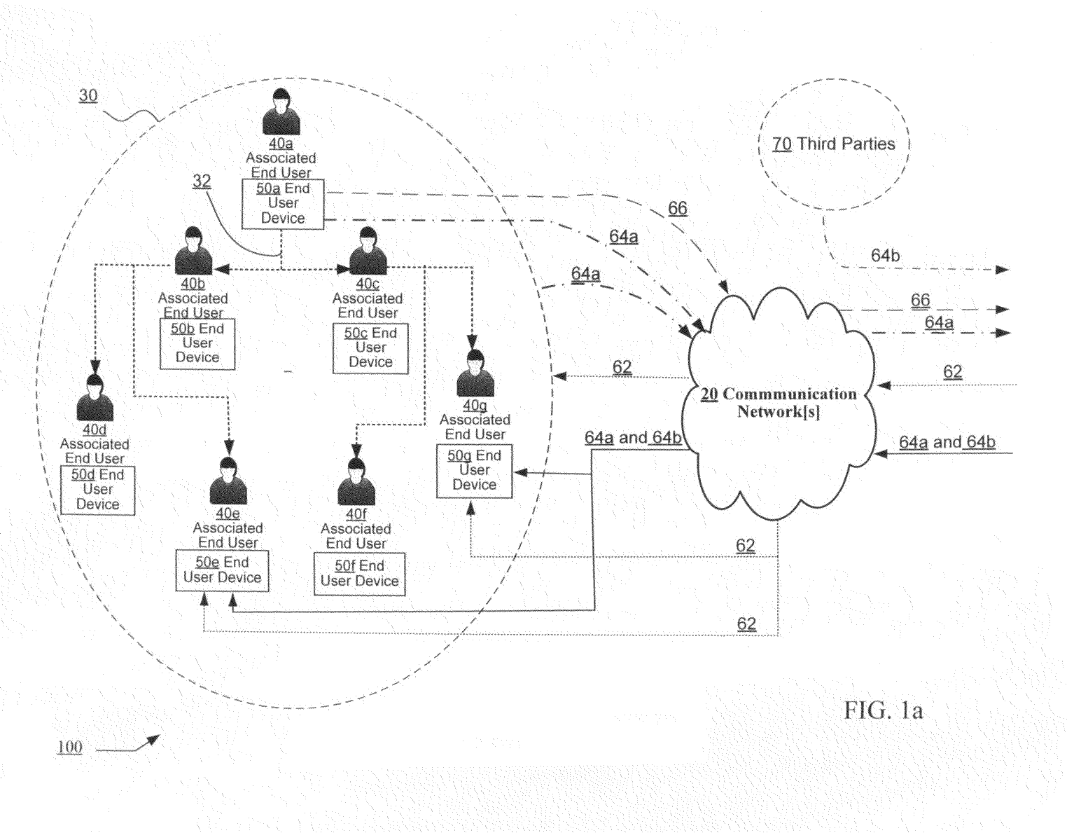

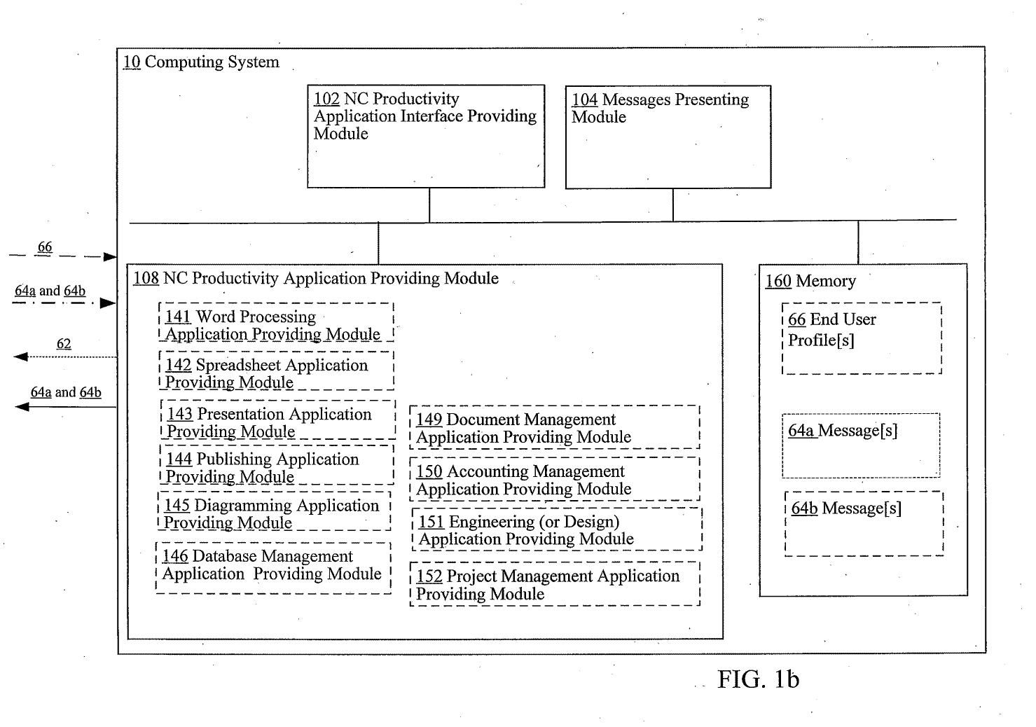

Turning now to FIGS. 1a, and 1b illustrating an example environment 100 in which the methods, systems, circuitry, and computer program products in accordance with various embodiments may be implemented by a computing system 10. In some embodiments, the computing system 10 may be a network device such as a server. Alternatively, the computing system 10 may be a plurality of network devices such as a plurality of network computers, servers, and storage devices.

In some embodiments, the computing system 10 may provide a non-communication (NC) productivity application interface 62 including a channel for accessing messages to an entire group of associated end users 40a, 40b, 40c, 40d, 40e, 40f, and 40g. In alternative embodiments, however, the computing system 10 may provide the NC productivity application interface 62 only to one or more selective end users such as, for example, associated end users 40e and 40g.

That is, in some embodiments, each of the group of associated end users 40a to 40g may be provided with the NC productivity application interface 62 including the channel for accessing messages, while in other embodiments, only selective end users (e.g., associated end users 40e and 40g in the illustrated example of FIGS. 1a and 1b) may be provided with the NC productivity application interface 62 that includes the channel for accessing the messages (e.g., messages 64a and 64b). In various embodiments, the NC productivity application interface 62 to be provided may be for using or accessing one or more web-based NC productivity applications such as a word processing application, a spreadsheet application, a presentation application, a publishing application, a diagramming application, a data management application, a personal information management application, a search application, a document management application, an accounting application, and/or a project management application.

Note that in the following description, “*” represents a wildcard. Thus, references to, for example, associated end users 40* of FIG. 1a may be in reference to associated end user 40a, associated end user 40b, associated end user 40c, associated end user 40d, associated end user 40e, associated end user 40f, and/or associated end user 40g. In various embodiments, the group of associated end users 40* may be associated with respect to each other because they may each be associated with or may be members of an organization such as an enterprise 30 (e.g., a business enterprise such as a company or corporation), or may be members of other types of organizations such as non-profit group, a social or athletic club, and so forth. In some cases, the enterprise 30 may at least be partly defined by a hierarchical structure. For instance, and as illustration, ref 32 of FIG. 1a indicates exemplary hierarchical relationships between members (e.g., associated end users 40*) of the enterprise 30.

In order to provide the NC productivity application interface 62 (including the channel to access messages) to the entire group of associated end users 40* or to only selective end users such as associated end users 40e and 40g (as depicted in the exemplary environment 100 of FIGS. 1a and 1b), the computing system 10 may transmit the NC productivity application interface 62 (or at least electronic copies of the NC productivity application interface 62) to the group of associated end users 40* or to only selective associated end users 40e and 40g via one or more communication networks 20. In various embodiments, the one or more communication networks 20 may include one or more of a local area network (LAN), metropolitan area network (MAN), a wireless local area network (WLAN), a personal area network (PAN), a Worldwide Interoperability for Microwave Access (WiMAX), public switched telephone network (PTSN), a general packet radio service (GPRS) network, a cellular network, and so forth.

In some cases, the NC productivity application interface 62 or at least the electronic copies of the NC productivity application interface 62 may be transmitted via the Internet. As will be further described herein, in order to provide the NC productivity application interface 62 to one or more of the associated end users 40*, the NC productivity application interface 62 (or the electronic copies of the NC productivity application interface 62) may be provided in electronic signal form to client devices (e.g., end user devices 50* such as laptops, desktops, Netbook, workstations, Smartphones, and so forth) of those associated end users 40* who are designated to receive such an interface. In some embodiments, the NC productivity application interface 62 (or electronic copies of the NC productivity application interface 62) to be provided may be an audio interface (e.g., an interface that may be indicated via an audio system such as a speaker/microphone system) or a display interface (e.g., an interface that may be displayed through, for example, a display monitor).

In addition to providing the NC productivity application interface 62 (or at least the electronic copies of the NC productivity application interface 62) including the channel for accessing messages, the computing system 10 may be designed to present via the channel of the NC productivity application interface 62 and to selective ones of the group of associated end users 40* at least a first one or more messages 64a and a second one or more messages 64b, the first one or more messages 64a being associated with the group of associated end users 40* and the second one or more messages 64b being independent of the group of associated end users 40*. In various embodiments, the first one or more messages 64a may be associated with the group of associated end users 40* when the first one or more messages 64a are provided by one of the associated end users 40*(i.e., one of the associated end user from the group of associated end users 40*), by an organization or an enterprise 30 associated with the group of associated end users 40*, or by an organizational unit of the enterprise 30 associated with the group of associated end users 40*. In contrast, the second one or more messages 64b may be independent of the group of associated end users 40* when the second one or more messages 64b are provided by a third party 70 that is independent or unrelated to the group of associated end users 40*. Examples of such a third party 70 may include an advertiser or a third party business or enterprise that is not related at least directly to the group of associated end users 40*.

In various embodiments, the computing system 10 may be designed to direct messages (e.g., messages 64a and 64b in FIGS. 1a and 1b) to specific associated end users 40* without being provided with the specific identities (e.g., names, usernames, employee ID numbers, etc.) of those associated end users 40* who should (e.g. who deserves) be receiving the messages 64*. In particular, the computing system 10 may be designed to present the first one or more messages 64a and the second one or more messages 64b based on, for example, detectable or inferable characteristics of the associated end users 40*. In some cases, these selective associated end users (e.g., associated end users 40e and 40g) may also be the only ones to be provided with the NC productivity application interface 62 that includes the channel for accessing messages (e.g., messages 64a and 64b).

In order to direct the first one or more messages 64a and/or the second one or more messages 64b to the proper associated end users 40* without being provided with the identities of those associated end users 40*, the computing system 10 may be designed to, for example, identify those associated end users 40* who have one or more characteristics (e.g., traits) that at least proximately matches with one or more characteristics indicated by one or more end user profiles 66. An end user profile 66 may merely be a collection of one or more characteristics (e.g., end user interests, educational background, technical specialty, gender, age and so forth) of those end users, such as associated end users 40e and 40g in FIGS. 1a and 1b, who should (deserves to) be provided with or have access to one or more messages (e.g., the first one or more messages 64a and/or the second one or more messages 64b of FIGS. 1a and 1b).

To determine which of the group of associated end users 40* has one or more characteristics that match with the one or more characteristics indicated by the one or more end user profiles 66, the computing system 10 may compare the one or more end user profiles 66 with the computer usage of the entire group of associated end users 40* in order to identify those end users (e.g., associated end users 40e and 40g in the illustrated example of FIGS. 1a and 1b) who should be presented with at least the first one or more messages 64a. In particular, the computing system 10 may examine the computer research activities (e.g., Internet search activities), the computer work-products (e.g., word processing documents, spreadsheet documents, etc.), and/or the communication messages (e.g., email, text messages, instant messages or IMs) of the group of associated end users 40* in order to look for specific words, phrases, icons, symbols, and so forth that may be relevant to the one or more characteristics indicated by the one or more end user profiles 66. By finding such words, phrases, icons, symbols, and so forth in the research activities, work-products, and/or communication messages of the group of associated end users 40*, those end users, such as associated end users 40e and 40g of the illustrated example of FIGS. 1a and 1b, who should be presented with at least the first one or more messages 64a may be identified.

For example, suppose the first one or more messages 64a are meant to be presented to end users who are at least 50 years of age as indicated by, for example, an end user profile 66. In such a scenario, the computing system 10 may look at the research activities, work-products, and/or communication messages of the group of associated end users 40* in order to find particular words and/or phrases such as “Association for the Advancement of Retired Persons” or “AARP,” arthritis, “birth date of May 3, 1948,” and so forth that are associated with those who are over the age of 50. If such words and/or phrases are found in the research activities, work-products, and/or communication messages, then an inference may be made that those end users, such as associated end users 40e and 40g, associated with the research activities, the work-products, and/or the communication messages containing such words and/or phrases may be at least 50 years of age. By making such an inference, those associated end users 40e and 40g who should be presented with the first one or more messages 64a may be identified.

As will be further described herein, this technique of using one or more end user profiles 66 may also be employed in order to direct the second one or more messages 64b to the proper end users (e.g. associated end users 40e and 40g). Similarly, and as will be further discussed with respect to the processes and operations to be described herein, this technique of using one or more end user profiles 66 may also be used in order to determine which associated end users 40* are to be provided with the NC productivity application interface 62 (with the channel for accessing messages 64*) in embodiments where the NC productivity application interface 62 is only provided to selective associated end users 40* (e.g., associated end users 40e and 40g).

Although it was indicated that in some implementations an end user profile 66 may indicate one or more characteristics of end users (e.g., associated end users 40*) who should be presented with the first one or more messages 64a and/or the second one or more messages 64b, in other implementations, however, an end user profile 66 may indicate the characteristics of those end users who should not be presented with the first one or more messages 64a and/or the second one or more messages 64b. For these implementations, the end user profile 66 may be used in order to identify those associated end users 40* who should be presented with the first one or more messages 64a and/or the second one or more messages 64b by identifying those associated end users 40* who do not have the characteristics indicated by the end user profile 66.

In some embodiments, the one or more end user profiles 66 that may be used to, for example, identify those associated end users 40* who should receive the first one or more messages 64a and/or the second one or more messages 64b may be provided by one or more sources of the first one or more messages 64a and/or the second one or more messages 64b. For example, in the illustrated example of FIGS. 1a and 1b, the one or more end user profiles 66 may be provided by an associated end user 40a, by an enterprise 30 associated with the group of associated end users 40*, and/or by one or more third parties 70. That is, the associated end user 40a and/or the enterprise 30 may be the source or sources of the first one or more messages 64a in various embodiments. In contrast, the third party 70 (e.g., a third party enterprise unaffiliated with the group of associated end users 40* or the enterprise 30) may be the source for the second one or more messages 64b (e.g. advertisements). Note that in some cases, the first one or more messages 64a and the second one or more messages 64b may be stored in a memory 160 (e.g., volatile or non-volatile memory) prior to being distributed to selected end users such as associated end users 40e and 40g. The first one or more messages and the second one or more messages 64b may be provided to the computing system 10 in a variety of forms including, for example, as an email message, a text message, an IM, and so forth.

Turning specifically now to the computing system 10 of FIG. 1b. The computing system 10, as depicted, may include a variety of modules, sub-modules, and various other components. The computing system 10, in some embodiments, may be a single network device such as a single network computer, a single server, a single workstation, and so forth. Alternatively, the computing system 10 may be a collection of network devices including a collection of one or more servers, one or more network computers, one or more storage devices and/or one or more other network devices. Thus, the computing system 10 may be implemented at a single network site or at multiple network sites.

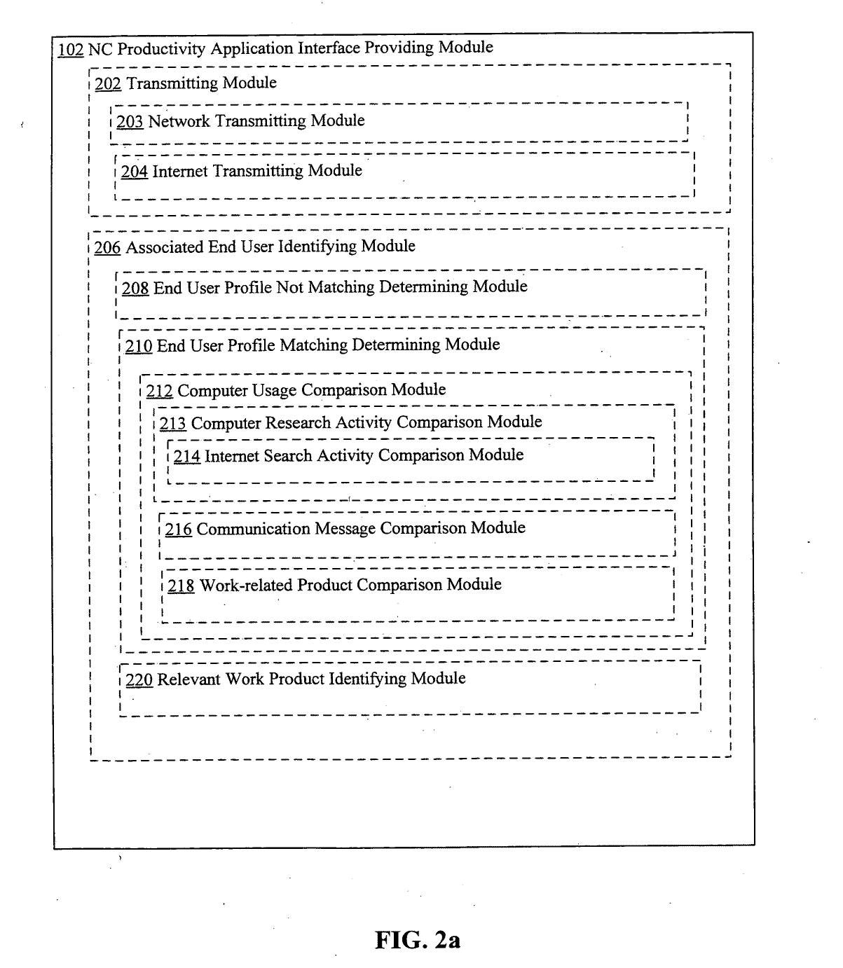

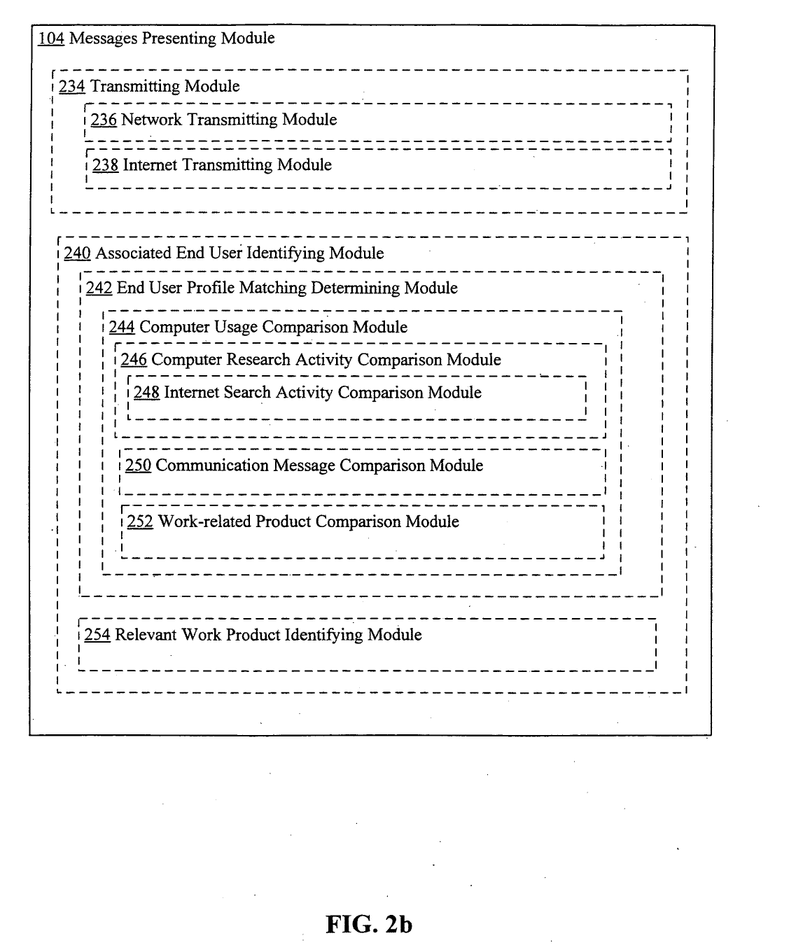

As shown, the computing system 10 may include at least a non-communication (NC) productivity application interface providing module 102 (which may further include one or more sub-modules as illustrated in FIG. 2a) and a messages presenting module 104 (which may further include one or more sub-modules as illustrated in FIG. 2b). In various embodiments, the computing system 10 may also include a non-communication (NC) productivity application providing module 108 and/or a memory 160. Although not depicted, the computing system 10 may also include other additional components such as a search engine and/or a web browser server in various alternative embodiments.

In various embodiments, the NC productivity application interface providing module 102 may be configured to, for example, provide a non-communication (NC) productivity application interface 62 including a channel for accessing messages (e.g., first one or more messages 64a and second one or more messages 64b) to at least one or more associated end users 40e and 40g from a group of associated end users 40*. In contrast, the messages presenting module 104 of the computing system 10 may be designed to present to the one or more associated end users 40e and 40g, via the channel of the NC productivity application interface 62, at least a first one or more messages 64a and a second one or more messages 64b, the first one or more messages 64a being associated with the group of associated end users 40* and the second one or more messages 64b being independent of the group of associated end users 40*.

As indicated earlier, the computing system 10 may include a non-communication productivity application providing module 108 that may be designed to provide access to one or more web-based non-communication productivity applications. In some cases, the access to the one or more web-based non-communication productivity applications may be via one or more NC productivity application interfaces 62. In some embodiments, the NC productivity application providing module 108 may further include one or more sub-modules for providing access to specific productivity applications including, for example, a word processing application providing module 141, a spreadsheet application providing module 142, a presentation application providing module 143, a publishing application providing module 144, a diagramming application providing module 145, a database management application providing module 146, a personal information management application providing module 147, a search application providing module 148, a document management application providing module 149, an accounting management application providing module 150, an engineering or design application providing module 151, and/or a project management application providing module 152. In some embodiments, the NC productivity application providing module 108 and its sub-modules may be implemented using multiple servers.

In some embodiments, the computing system 10 may include a memory 160 for storing various types of data. For these embodiments, memory 160 may comprise of one or more of one or more mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In some embodiments, memory 160 may be located at a single network site. Alternatively, memory 160 may be located at multiple network sites.

In various embodiments, memory 160 may store the one or more end user profiles 66 that may be referenced in order to determine which end users 40* should be presented with the first one or more messages 64a and/or the second one or more messages 64b. Additionally, memory 160 may also store the first one or more messages 64a and/or the second one or more messages 64b that may have been originally provided by one or more members (e.g., end users 40*) of an organization or an enterprise 30, by the organization or the enterprise 30, by an organizational unit of the enterprise 30, and/or by one or more third parties 70. In some cases, memory 160 may store a second one or more messages 64b that may be advertisements from one or more third party advertisers who may not be directly related to the group of associated end users 40* or to the organization or enterprise 30 that may be associated with the group of associated end users 40*.

Referring now to FIG. 2a illustrating a particular implementation of the NC productivity application interface providing module 102 of FIG. 1b. As illustrated, the NC productivity application interface providing module 102 may include one or more sub-modules in various alternative implementations. For example, in some implementations, the NC productivity application interface providing module 102 may include a transmitting module 202 (which may further include a network transmitting module 203 and/or an Internet transmitting module 204) and/or an associated end user identifying module 206. In implementations where the NC productivity application interface providing module 102 includes the associated end user identifying module 206, the associated end user identifying module 206 may further include an end user profile not matching determining module 208, a relevant work product identifying module 220, and/or an end user profile matching determining module 210.

In implementations, where the end user profile matching determining module 210 is included in the associated end user identifying module 206, the end user profile matching determining module 210 may further include one or more additional sub-modules. For example, in some implementations, the end user profile matching determining module 210 may include a computer usage comparison module 212 (which may further include a computer research activity comparison module 213 (which may further include an Internet search activity comparison module 214), a communication message comparison module 216, and/or a work-related product comparison module 218. Specific details related to the above-described sub-modules of the NC productivity application interface providing module 102 will be provided below with respect to the operations and processes to be described herein.

Referring now to FIG. 2b illustrating a particular implementation of the messages presenting module 104 of FIG. 1b. As illustrated, the messages presenting module 104 may also include one or more sub-modules in various alternative implementations. For example, in some implementations, the messages presenting module 104 may include a transmitting module 234 (which may further include a network transmitting module 236 and/or an Internet transmitting module 238) and/or an associated end user identifying module 240. In embodiments where the messages presenting module 104 includes the associated end user identifying module 240, the associated end user identifying module 240 may further include one or more sub-modules. For example, in some implementations, the associated end user identifying module 240 may include an end user profile matching determining module 242 and/or a relevant work product identifying module 254. In embodiments where the associated end user identifying module 240 includes the end user profile matching determining module 242, the end user profile matching determining module 242 may include a computer usage comparison module 244 that may further include a computer research activity comparison module 246 (which may further include an Internet search activity comparison module 248), a communication message comparison module 250, and/or a work-related product comparison module 252. Specific details related to the above-described sub-modules of the messages presenting module 104 will be provided below with respect to the operations and processes to be described herein.

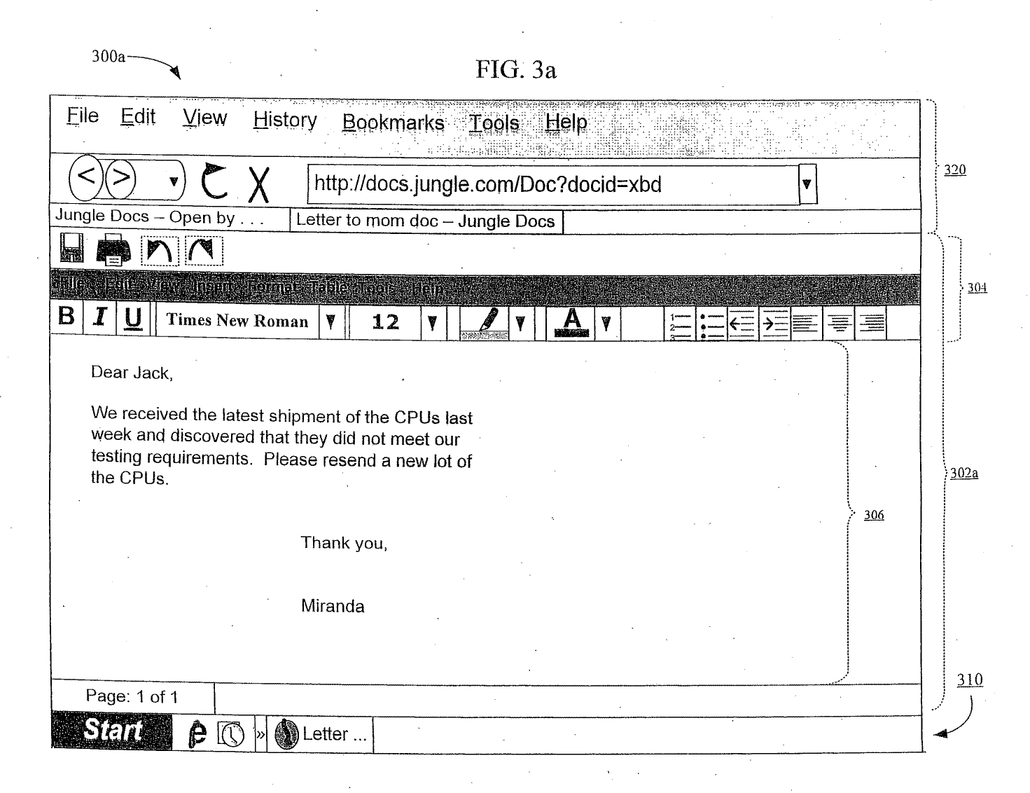

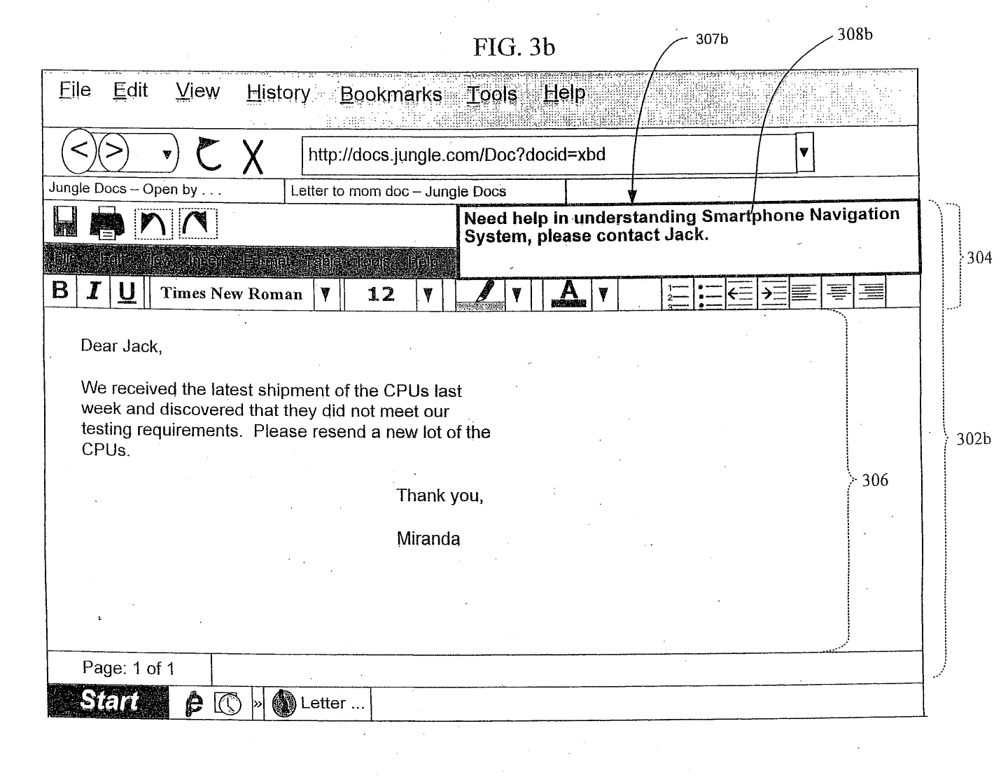

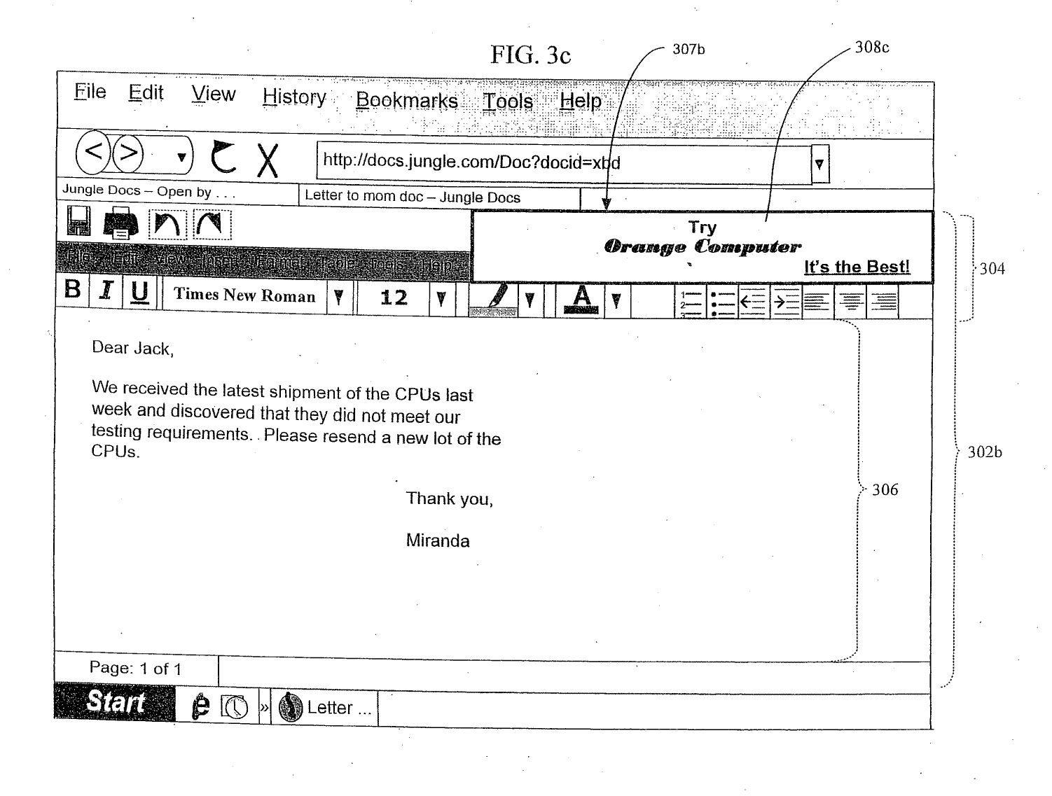

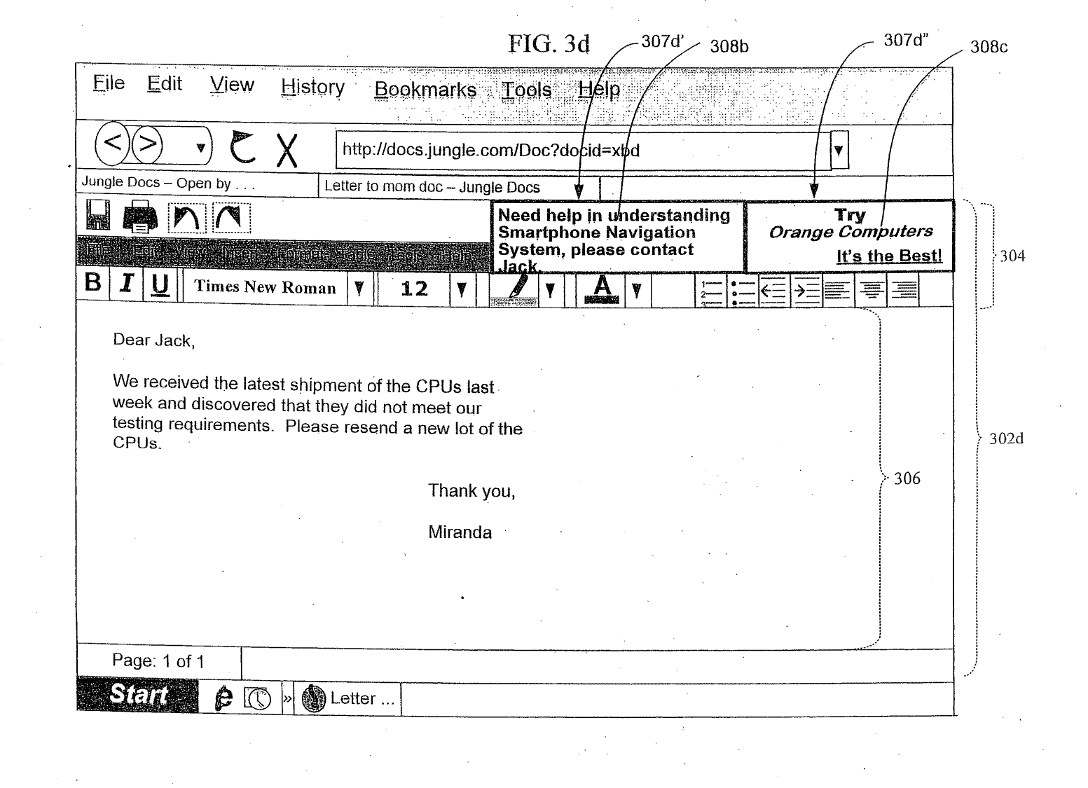

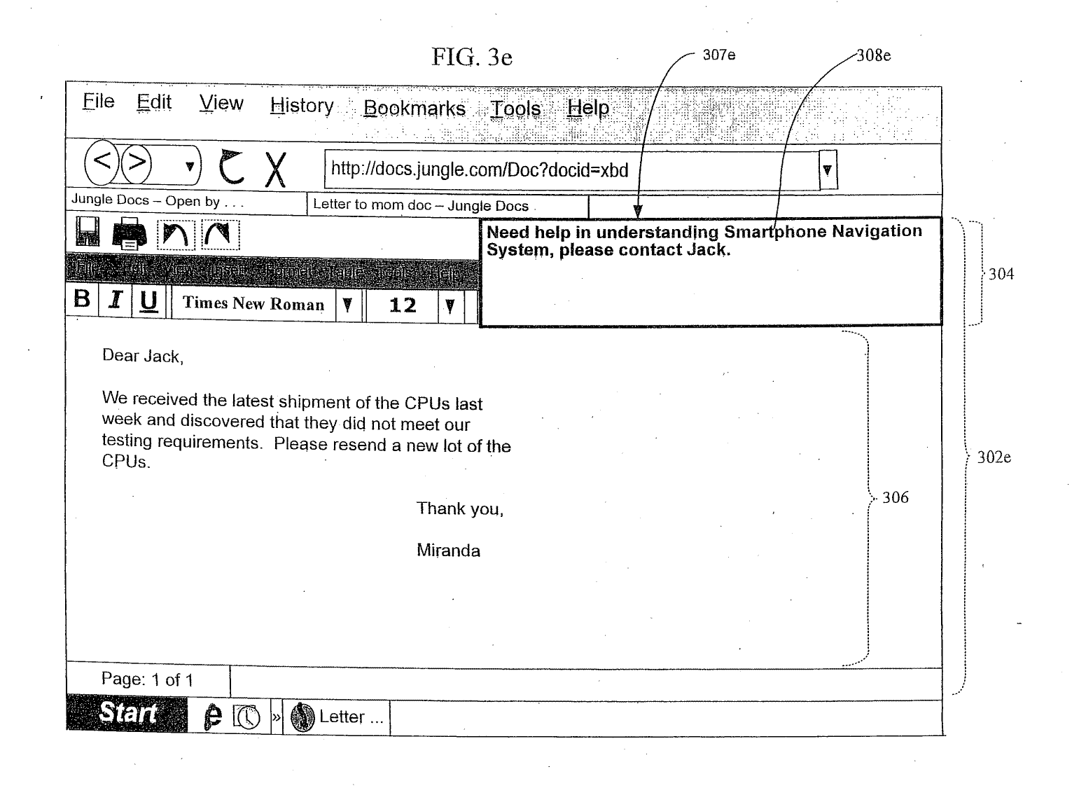

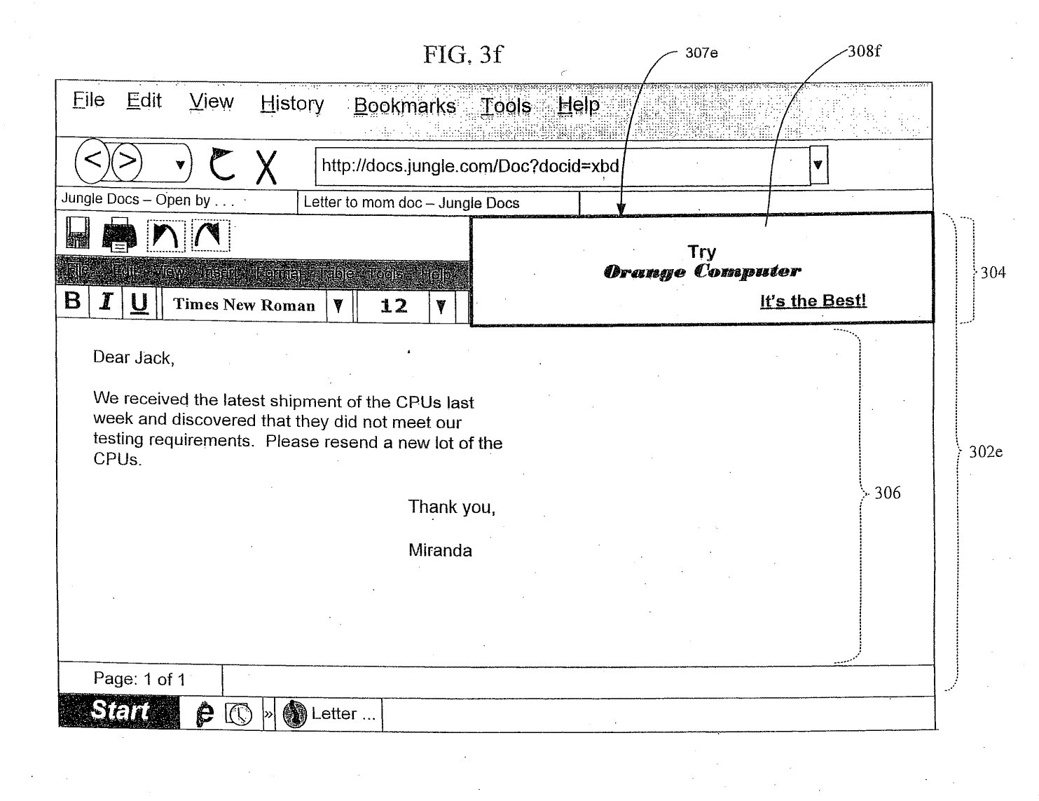

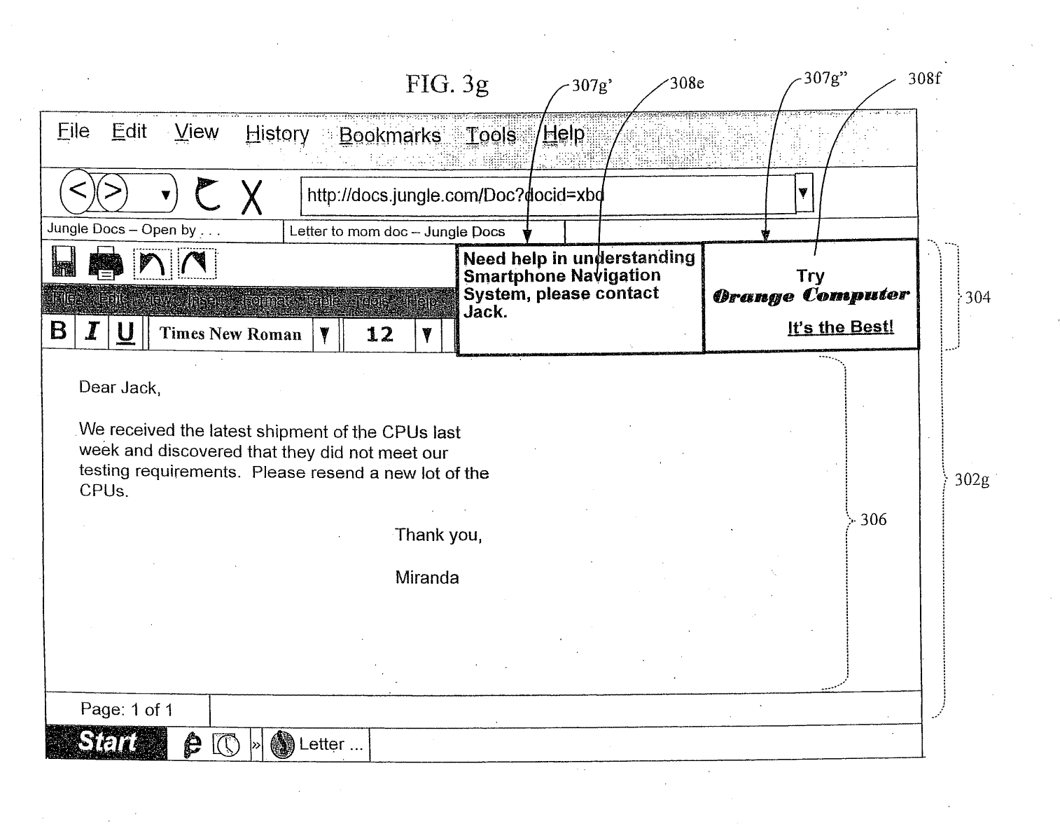

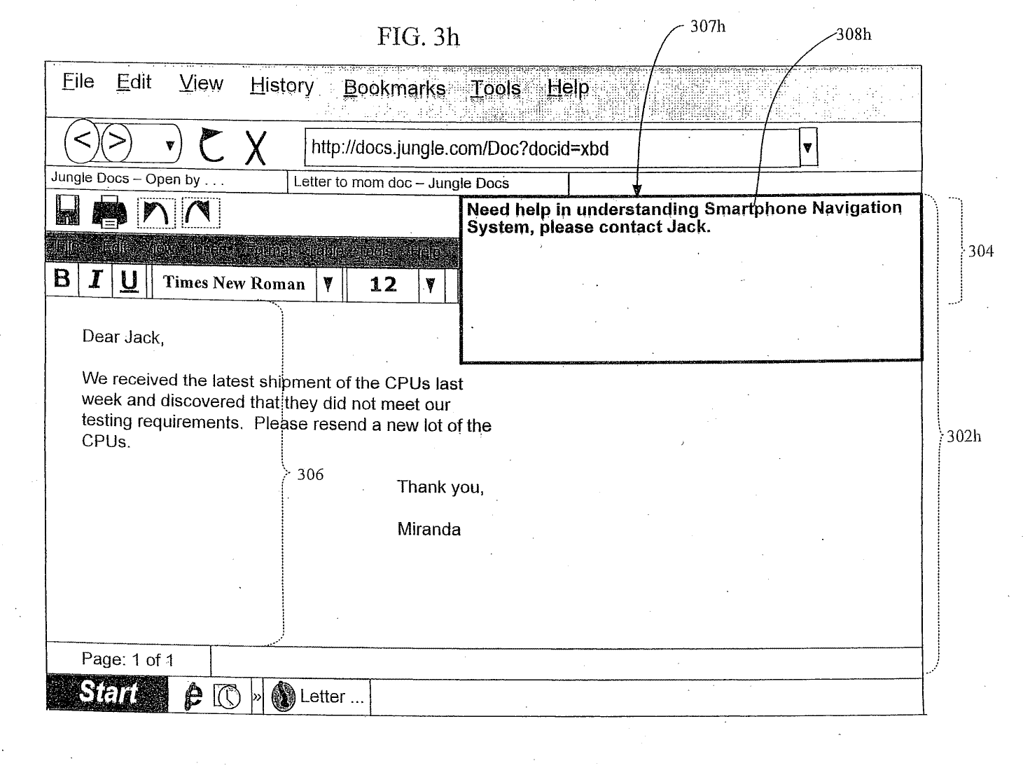

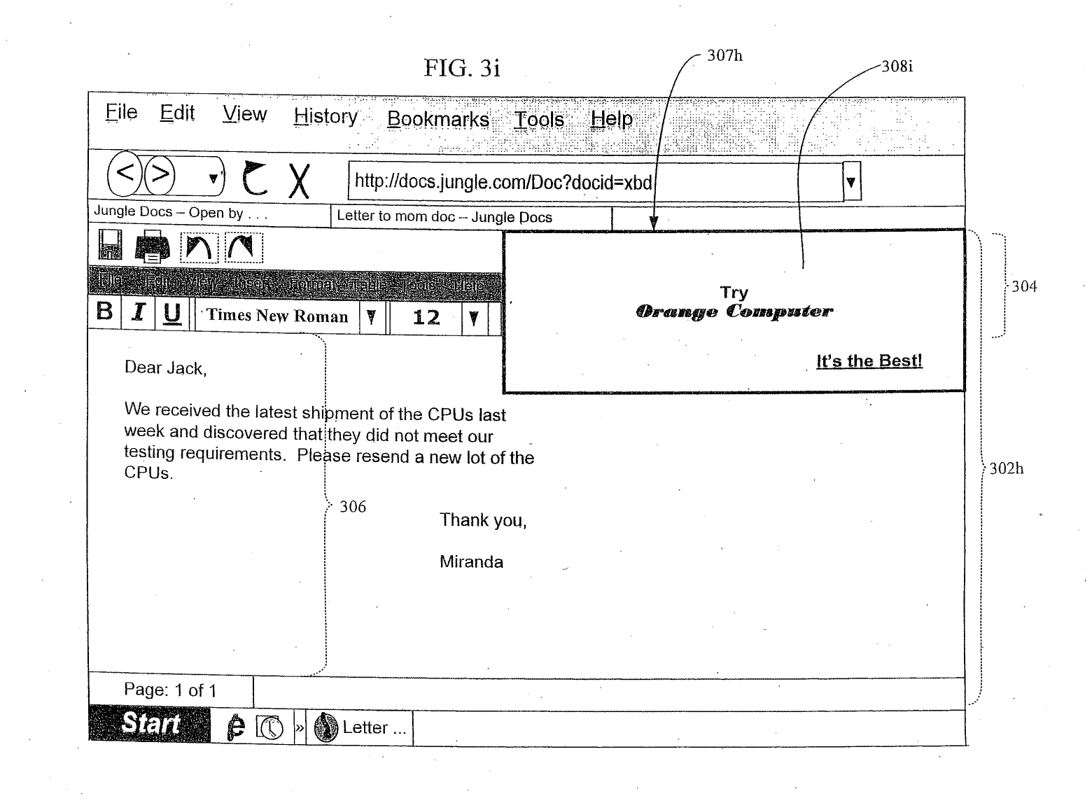

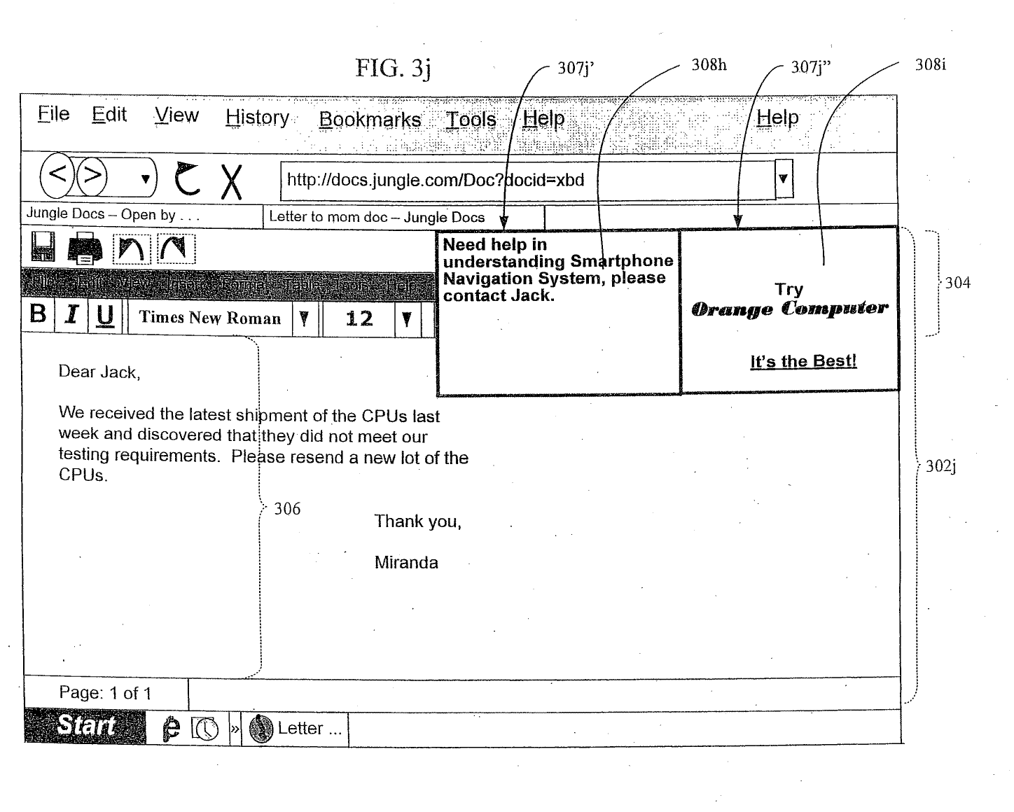

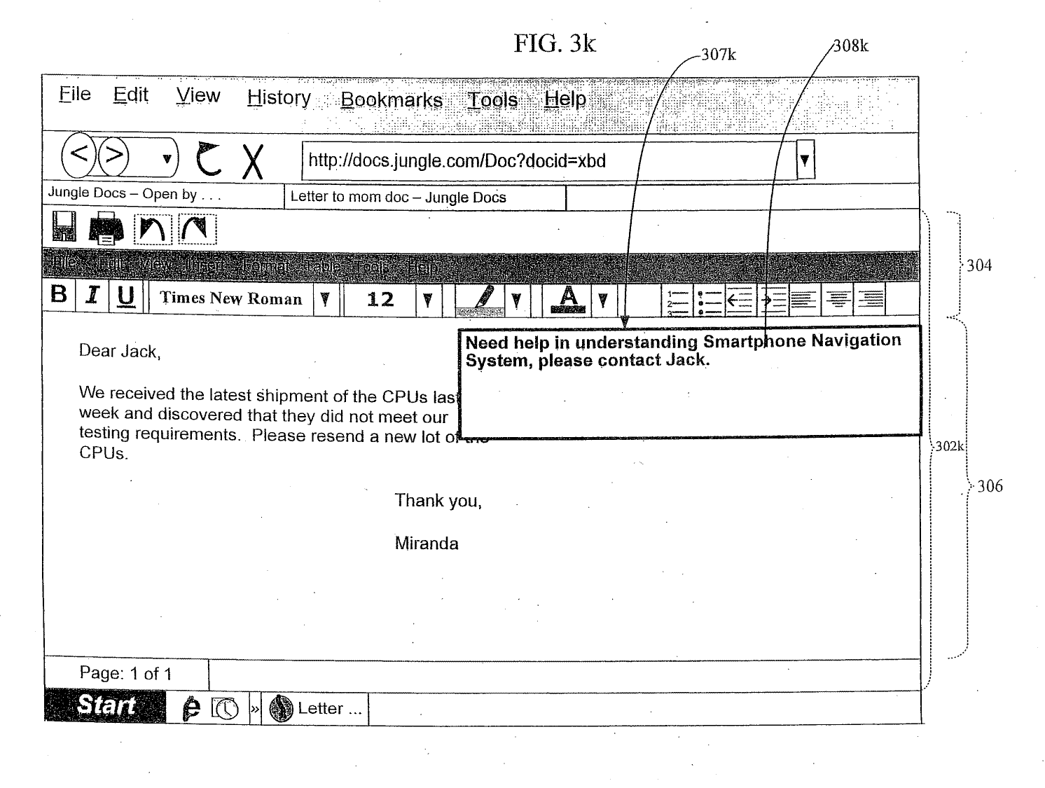

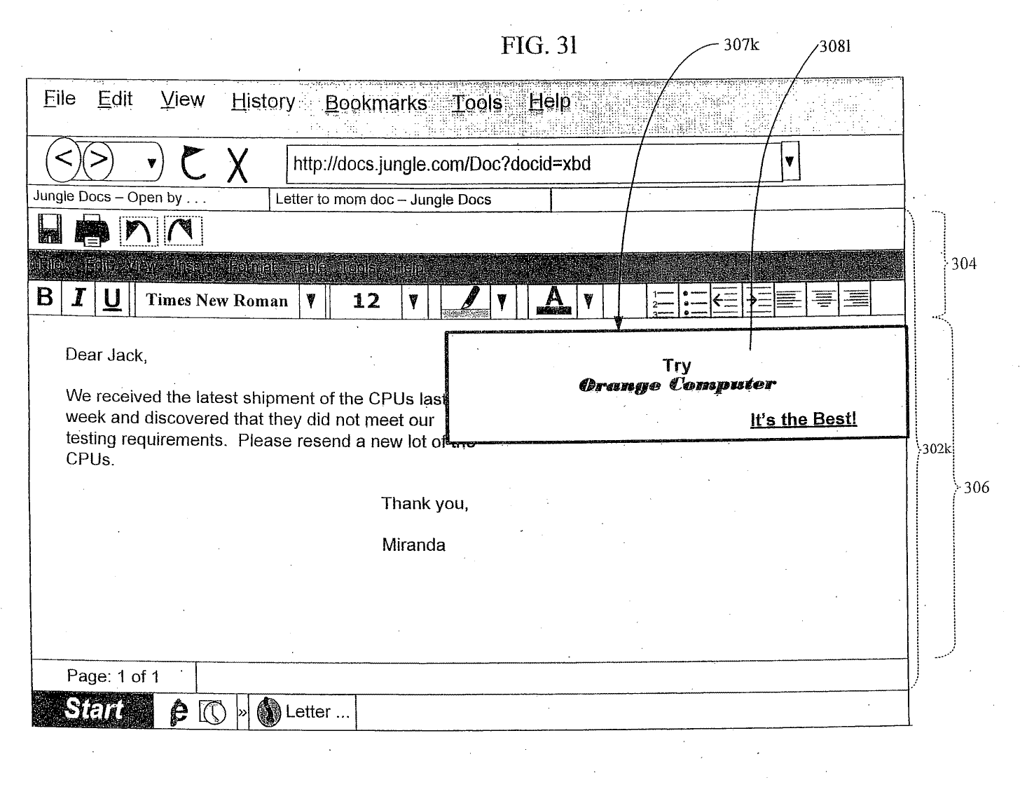

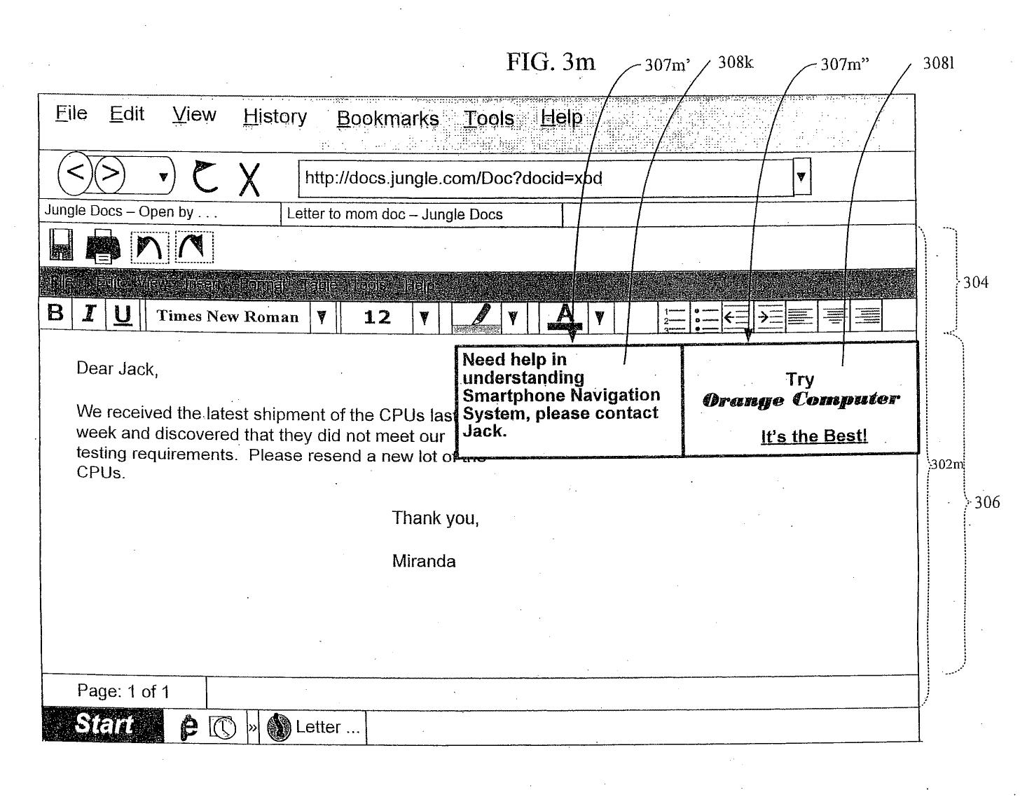

FIG. 3a illustrates a conventional non-communication productivity application interface for accessing a web-based word processing application in the form of a display interface 302a that is presented on a display screen 300a. In this illustrated example of the conventional NC productivity application interface in the form of the display interface 302a, the conventional NC productivity application interface (e.g., display interface 302a) does not include a channel for accessing messages. For example, in the illustrated example, the display screen 300a merely includes a display interface 302a but does not include a channel such as a window or a port for accessing or displaying messages. In this example, the display interface 302a is the NC productivity application interface for accessing a web-based non-communication productivity application which, in this example, is a web-based word processing application. At the bottom of the display monitor screen 300a is the operating system's status bar 310, while at the top of the computer monitor display 300a is a web-browser tool/status bar 320.

The display interface 302a for the conventional NC productivity application interface includes two portions, a tool-bar portion 304 and a workspace portion 306. The tool-bar portion 304 includes various functional/command icons to, among other things, execute various commands and functionalities. In some cases, the tool-bar portion 304 may also be a tool/status bar. The workspace portion 306 is the portion of the display interface 302a through which, for example, an end user 40* may enter data, view the entered data, and/or to receive and/or view the resulting processed data. In the example illustrated in FIG. 3a, the display interface 302a is being employed in order to draft a letter.

Note that for ease of illustration and explanation, only the display interfaces (e.g., display interfaces 302* of FIGS. 3b to 3m) associated with a web-based word processing application will be discussed and illustrated herein. That is, the display interfaces of other web-based non-communication productivity applications (e.g., spreadsheet applications, presentation applications, data management applications, diagramming applications, and so forth) although are not discussed or illustrated in the following, the following discussions directed to display interfaces 302* of FIGS. 3b to 3m and associated with a web-based word processing application will be equally applicable to the display interfaces of other non-communication productivity applications since the display interfaces of these other non-communication productivity applications will generally include similar components such as at least a tool-bar portion 304 and a workspace portion 306. For example, the display interfaces for a web-based spreadsheet application, a web-based diagramming application, a web-based presentation application, and so forth will all have at least a tool-bar portion 304 and a workspace portion 306.

As described above and in accordance with various embodiments, the computing system 10 may be designed to provide an NC productivity application interface 62 including a channel for accessing messages in a variety of forms including, for example, in audio form or in display form. For example, FIGS. 3b, 3c, 3d, 3e, 3f, 3g, 3h, 3i, 3j, 3k, 3l, and 3m illustrate eight alternative implementations of the NC productivity application interface 62 in display forms (e.g., display interfaces 302b, 302d, 302e, 302g, 302h, 302j, 302k, and 302m of FIGS. 3b to 3m).

Turning now to FIGS. 3b and 3c illustrating one implementation of the NC productivity application interface 62 of FIGS. 1a and 1b in display form (e.g., display interface 302b) that includes a channel for accessing messages. In particular, FIGS. 3b and 3c shows a display interface 302b at two different points or intervals in time. For example, FIG. 3b shows the display interface 302b for accessing a web-based productivity application (e.g., word processing application) that includes a channel (e.g., in the form of a display window 307b) for accessing a message 308b during a first point or interval in time. In this example, the channel for accessing the message 308b is a display window 307b that is disposed on the tool-bar portion 304 of the display interface 302b. Note that in this example, the display window 307b is not disposed on any of the icons included in the conventional display interface 302a of FIG. 3a. Instead, the display window 307b is disposed on the unused portion of the tool-bar portion 304. Within the display window 307b is the message 308b that, in this example, is from a member of an enterprise 30 (e.g., “Jack”). In other words, message 308b is equivalent to one of the first one or more messages 64a of FIGS. 1a and 1b.

Turning now to FIG. 3c, which shows the display interface 302b of FIG. 3b during a second point or interval in time. In the display interface 302b, the display window 307b displays a different message 308c from the message 308b displayed through display window 307b during the first point or interval in time as depicted in FIG. 3b. In this case, the message 308c that is displayed is an advertisement from a third party 70. In other words, message 308c is equivalent to one of the second one or more messages 64b of FIGS. 1a and 1b. Thus, in this implementation (e.g., as illustrated by FIGS. 3b and 3c), the first one or more messages 64a (e.g., message 308b of FIG. 3b) and the second one or more messages 64b (e.g., message 308c of FIG. 3c) of FIGS. 1a and 1b may be presented sequentially through a channel that includes only a single window 307b.

Turning now to FIG. 3d depicting another implementation of the NC productivity application interface 62 of FIGS. 1a and 1b in display form (e.g. display interface 302d) that includes a channel for accessing or presenting messages. In particular, FIG. 3d shows a display interface 302d with a channel for accessing messages that comprises of two display windows 307d′ and 307d″ for concurrently displaying multiple messages (e.g., messages 308b and 308c). Thus, in the implementation depicted in FIG. 3d, the first one or more messages 64a (e.g., message 308b) and the second one or more messages 64b (e.g., message 308c) of FIGS. 1a and 1b may be concurrently displayed through multiple display windows 307d′ and 307d″. Further note that the combination of display window 307d′ and display window 307d″ of FIG. 3d occupies the same real estate on the tool-bar portion 304 as occupied by the display window 307b of FIGS. 3b and 3c. Although only two display windows 307d′ and 307d″ were described and illustrated in the embodiment described here, in other embodiments, a channel for accessing a message may include more than two display windows 307d′ and 307d″.

Referring now to FIGS. 3e and 3f illustrating another implementation of the NC productivity application interface 62 of FIGS. 1a and 1b in display form (e.g., display interface 302e) that includes a channel for accessing messages. In particular, FIGS. 3e and 3f show a display interface 302e at two different points or intervals in time. For example, FIG. 3e shows the display interface 302e for accessing a web-based productivity application (e.g., word processing application) that includes a channel (e.g., in the form of a display window 307e) for accessing a message 308e during a first point or interval in time. In this example, the channel for accessing the message 308e is a display window 307e that is disposed entirely on a tool-bar portion 304 of the display interface 302e. More particularly, and unlike the display window 307b of FIG. 3b (which was disposed on an unused portion of the tool-bar portion 304), the display window 307e in this implementation is disposed on a portion of the tool-bar portion 304 that previously included functional/command icons (see the conventional display interface 302a of FIG. 3a). Within the display window 307e is the message 308e that, in this example, is from a member of an enterprise 30. In other words, message 308e is equivalent to one of the first one or more messages 64a of FIGS. 1a and 1b.

Turning now to FIG. 3f, which shows the display interface 302e of FIG. 3e during a second point or interval in time. In the display interface 302e, the display window 307e displays a different message 308f from the message 308e displayed through display window 307e during the first point or interval in time as depicted in FIG. 3e. In this case, the message 308f that is displayed is an advertisement from a third party 70. In other words, message 308f is equivalent to one of the second one or more messages 64b of FIGS. 1a and 1b. Thus, in this implementation (e.g., as illustrated by FIGS. 3e and 3f), the first one or more messages 64a (e.g., message 308e of FIG. 3e) and the second one or more messages 64b (e.g., message 308f of FIG. 3f) of FIGS. 1a and 1b may be presented sequentially (e.g., at different times) through a channel that includes only a single display window 307e.

Turning now to FIG. 3g depicting another implementation of the NC productivity application interface 62 of FIGS. 1a and 1b in display form (e.g. display interface 302g) that includes a channel for accessing or presenting messages. In particular, FIG. 3g shows a display interface 302g with a channel for accessing messages that comprises of two display windows 307g′ and 307g″ for concurrently displaying multiple messages (e.g., messages 308e and 308f). Thus, in the implementation depicted in FIG. 3g, the first one or more messages 64a (e.g., message 308e) and the second one or more messages 64b (e.g., message 3080 of FIGS. 1a and 1b may be concurrently displayed through multiple display windows 307g′ and 307g″. Further note that the combination of display window 307g′ and display window 307g″ of FIG. 3g occupies the same real estate on the tool-bar portion 304 as occupied by the window 307e of FIGS. 3e and 3f.

Turning now to FIGS. 3h and 3i illustrating yet another implementation of the NC productivity application interface 62 of FIGS. 1a and 1b in display form (e.g., display interface 302h) that includes a channel for accessing messages. In particular, FIGS. 3h and 3i show a display interface 302h at two different points or intervals in time. For example, FIG. 3h shows the display interface 302h for accessing a web-based productivity application (e.g., word processing application) that includes a channel (e.g., in the form of a display window 307h) for accessing a message 308h during a first point or interval in time. In this example, the channel for accessing the message 308h is a display window 307h that is disposed at least partly on a tool-bar portion 304 and at least partly on a workspace portion 306 of the display interface 302h. Within the display window 307h is the message 308h that is from a member of an enterprise 30. In other words, message 308h is equivalent to one of the first one or more messages 64a of FIGS. 1a and 1b.

Turning now to FIG. 3i, which shows the display interface 302h of FIG. 3h during a second point or interval in time. In the display interface 302h, the display window 307h displays a different message 308i from the message 308h displayed through display window 307h during the first point or interval in time as depicted in FIG. 3h. In this case, the message 308i that is displayed through display window 307h is an advertisement from a third party 70. In other words, message 308i is equivalent to one of the second one or more messages 64b of FIGS. 1a and 1b. Thus, in this implementation (e.g. as illustrated by FIGS. 3h and 3i), the first one or more messages 64a (e.g., message 308h of FIG. 3h) and the second one or more messages 64b (e.g., message 308i of FIG. 3i) of FIGS. 1a and 1b may be presented sequentially (e.g., at different times) through a channel that includes only a single display window 307h.

Turning now to FIG. 3j depicting another implementation of the NC productivity application interface 62 of FIGS. 1a and 1b in display form (e.g. display interface 302j) that includes a channel for accessing or presenting messages. In particular, FIG. 3j shows a display interface 302j with a channel for accessing messages that comprises of two display windows 307j′ and 307j″ for concurrently displaying multiple messages (e.g., messages 308h and 308i). Thus, in the implementation depicted in FIG. 3j, the first one or more messages 64a (e.g., message 308h) and the second one or more messages 64b (e.g., message 308i) of FIGS. 1a and 1b may be concurrently displayed through multiple display windows 307j′ and 307j″. Further, note that the combination of display window 307j′ and display window 307j″ of FIG. 3j occupies the same real estate on the tool-bar portion 304 and the workspace portion 306 as occupied by the display window 307h of FIGS. 3h and 3i.

Turning now to FIGS. 3k and 3l illustrating yet another implementation of the NC productivity application interface 62 of FIGS. 1a and 1b in display form (e.g., display interface 302k) that includes a channel for accessing messages. In particular, FIGS. 3k and 3l show a display interface 302k at two different points or intervals in time. For example, FIG. 3k shows the display interface 302k for accessing a web-based productivity application (e.g., word processing application) that includes a channel (e.g., in the form of a display window 307k) for accessing a message 308k during a first point or interval in time. In this example, the channel for accessing the message 308k is a display window 307k that is disposed on at least a portion of a workspace portion 306 of the display interface 302k. Within the display window 307k is the message 308k that is from a member of an enterprise 30. In other words, message 308k is equivalent to one of the first one or more messages 64a of FIGS. 1a and 1b.

Turning now to FIG. 3l, which shows the display interface 302k of FIG. 3k during a second point or interval in time. In the display interface 302k, the display window 307k displays a different message 308l from the message 308k displayed through display window 307k during the first point or interval in time as depicted in FIG. 3k. In this case, the message 308l that is displayed through display window 307k is an advertisement from a third party 70. In other words, message 308l is equivalent to one of the second one or more messages 64b of FIGS. 1a and 1b. Thus, in this implementation (e.g. as illustrated by FIGS. 3k and 3l), the first one or more messages 64a (e.g., message 308k of FIG. 3k) and the second one or more messages 64b (e.g., message 308l of FIG. 3l) of FIGS. 1a and 1b may be presented sequentially (e.g., at different times) through a channel that includes only a single display window 307k.

Turning now to FIG. 3m depicting another implementation of the NC productivity application interface 62 of FIGS. 1a and 1b in display form (e.g. display interface 302m) that includes a channel for accessing or presenting messages. In particular, FIG. 3m shows a display interface 302m with a channel for accessing messages that comprises of two display windows 307m′ and 307m″ for concurrently displaying multiple messages (e.g., messages 308k and 308l). Thus, in the implementation depicted in FIG. 3m, the first one or more messages 64a (e.g., message 308k) and the second one or more messages 64b (e.g., message 308l) of FIGS. 1a and 1b may be concurrently displayed through multiple display windows 307m′ and 307m″. Further, note that the combination of display window 307m′ and display window 307m″ of FIG. 3m occupies the same real estate on the workspace portion 306 as occupied by the display window 307k of FIGS. 3k and 3l.

Note that although in the above descriptions of FIGS. 3b to 3m it was described that the display windows 307* that were included in the display interfaces 302* displays messages 308*, in alternative implementations, the display windows 307* may merely provide accesses to the messages 308*. For example, in some implementations, a display window 307* may allow access to a message 308* by including a link such as a URL address or a hyperlink in the display window 307* to direct an end user to the message 308*.

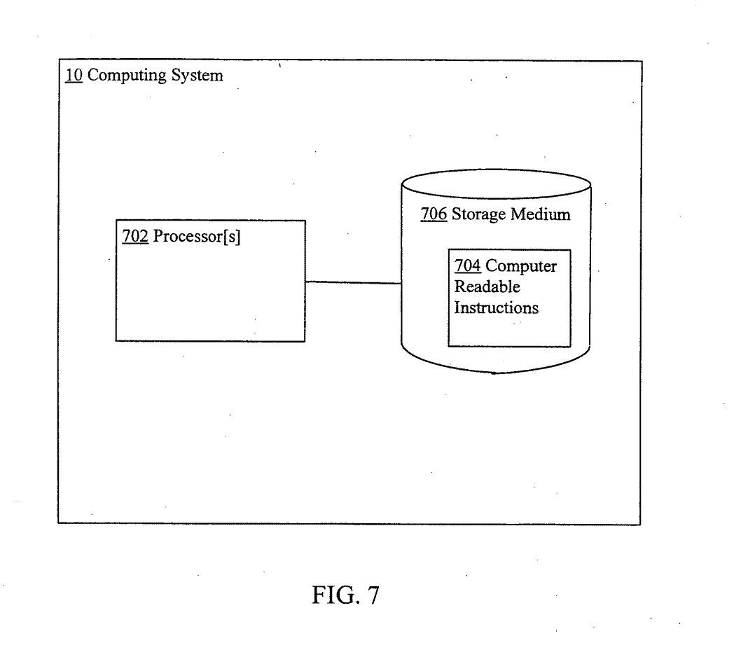

Referring back to the computing system 10 of FIG. 1b, the various modules (e.g., the NC productivity application interface providing module 102, the messages presenting module 104, and so forth) along with their sub-modules included in the computing system 10 may be implemented using hardware, software, firmware, or any combination thereof. For example, in some implementations, the NC productivity application interface providing module 102 and/or the messages presenting module 104 may be implemented with one or more processors 702 (e.g., microprocessors, controllers, and so forth) executing computer readable instructions 704 (e.g., computer program product) stored in a storage medium 706 (e.g., volatile or non-volatile memory) such as a signal-bearing medium as depicted in the computing system 10 of FIG. 7. Alternatively, hardware such as circuitry including application specific integrated circuit (ASIC) may be employed in order to implement such modules in some alternative implementations. In still other alternative implementations, programmable circuitry such as field programmable gate arrays (FPGA) may be employed in order to implement such modules.

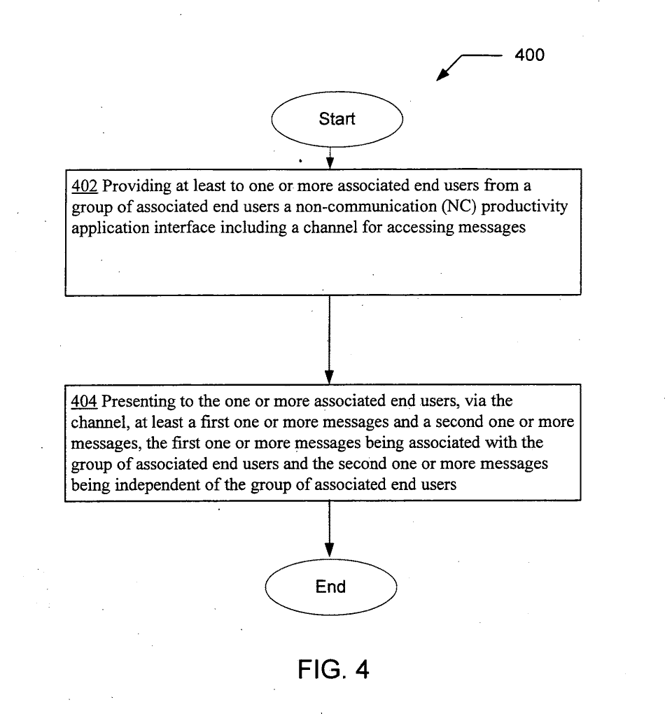

A more detailed discussion related to the computing system 10 of FIG. 1b will now be provided with respect to the processes and operations to be described herein. FIG. 4 illustrates an operational flow 400 representing example operations related to, among other things, providing to one or more associated end users a non-communication (NC) productivity application interface that includes a channel for accessing messages, and presenting to the one or more associated end users at least a first one or more messages and a second one or more messages via the channel, the first one or more messages being associated with the group of associated end users and the second one or more messages being unassociated with the group of associated end users.

In FIG. 4 and in the following figures that include various examples of operational flows, discussions and explanations may be provided with respect to the exemplary environment 100 described above as illustrated in FIGS. 1a and 1b, and/or with respect to other examples (e.g., as provided in FIGS. 2a, 2b, 3a, 3b, 3c, 3d, 3e, 3f, 3g, 3h, 3i, 3j, 3k, 3l, and 3m) and contexts. However, it should be understood that the operational flows may be executed in a number of other environments and contexts, and/or in modified versions of FIGS. 1a, 1b, 2a, 2b, 3a, 3b, 3c, 3d, 3e, 3f, 3g, 3h, 3i, 3j, 3k, 3l, and 3m. Also, although the various operational flows are presented in the sequence(s) illustrated, it should be understood that the various operations may be performed in other orders other than those which are illustrated, or may be performed concurrently.

Further, in FIG. 4 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

In any event, after a start operation, the operational flow 400 may move to a non-communication (NC) productivity application interface providing operation 402 for providing at least to one or more associated end users from a group of associated end users a non-communication (NC) productivity application interface including a channel for accessing messages. For instance, and as an illustration, the NC productivity application interface providing module 102 of the computing system 10 of the example environment 100 of FIGS. 1a and 1b providing (e.g., transmitting or supplying) at least to one or more associated end users (e.g., end users 40e and 40g in the example environment 100 illustrated in FIGS. 1a and 1b) from a group of associated end users 40* an NC productivity application interface 62 including a channel for accessing messages (e.g., messages 64a and 64b).

In various implementations, the NC productivity application interface 62 to be provided through the NC productivity application interface providing operation 402 may provide access to one or more web-based NC productivity applications (e.g., applications that may be accessed via, for example, the Internet). In some implementations, in order to provide the NC productivity application interface 62 to the one or more associated end users 40e and 40g, electronic copies of the NC productivity application interface 62 may be provided or transmitted to the client devices (e.g., end user devices 50e and 50g) of the one or more associated end users 40e and 40g.

In addition to the NC productivity application interface providing operation 402, operational flow 400 may also include a messages presenting operation 404 for presenting to the one or more associated end users, via the channel, at least a first one or more messages and a second one or more messages, the first one or more messages being associated with the group of associated end users and the second one or more messages being independent of the group of associated end users as further illustrated in FIG. 4. For instance, the messages presenting module 104 of the computing system 10 of FIG. 1b presenting (e.g., transmitting or supplying) to the one or more associated end users (e.g., end users 40e and 40g in the illustrated example 100 of FIGS. 1a and 1b), via the channel, at least a first one or more messages 64a and a second one or more messages 64b, the first one or more messages 64a being associated with the group of associated end users 40* and the second one or more messages 64b being independent of the group of associated end users 40*. Note that the phrase “being independent of the group of associated end users” as recited above in reference to the “second one or more messages” may be in reference to the second one or more messages being at least originally provided by an entity or a third party that is completely separate from or unrelated to the group of associated end users 40*.

As briefly described above, in various implementations, the NC productivity application interface providing operation 402 and the messages presenting operation 404 of FIG. 4 may be executed by the computing system 10 of the example environment 100 of FIGS. 1a and 1b. In some implementations, such a computing system 10 may be a network device, such as a network server, or may be a plurality of network servers. Thus, such operations may be executed at a single network site or at multiple network sites. As will be further described herein, the NC productivity application interface providing operation 402 and the messages presenting operation 404 of FIG. 4 may be executed in a variety of different ways in various alternative implementations.

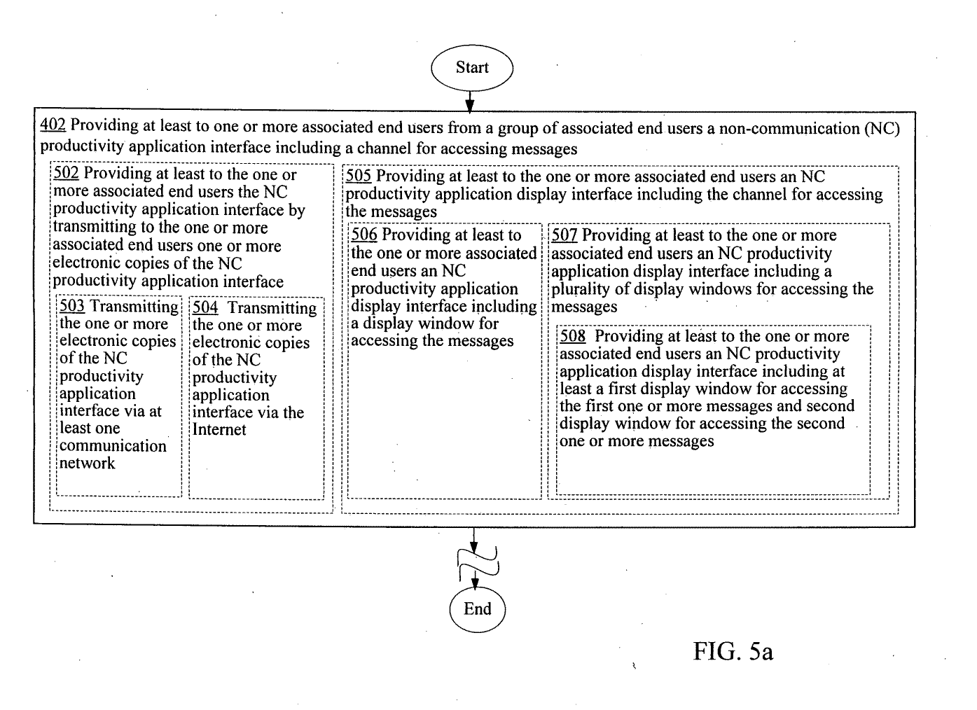

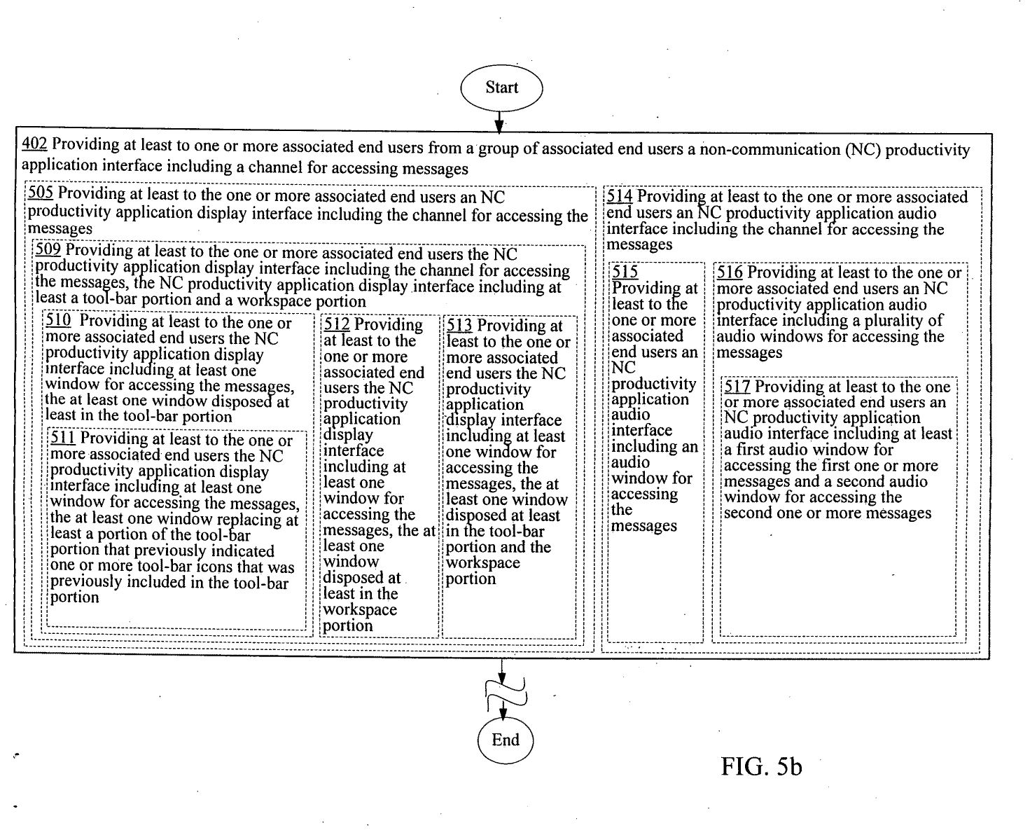

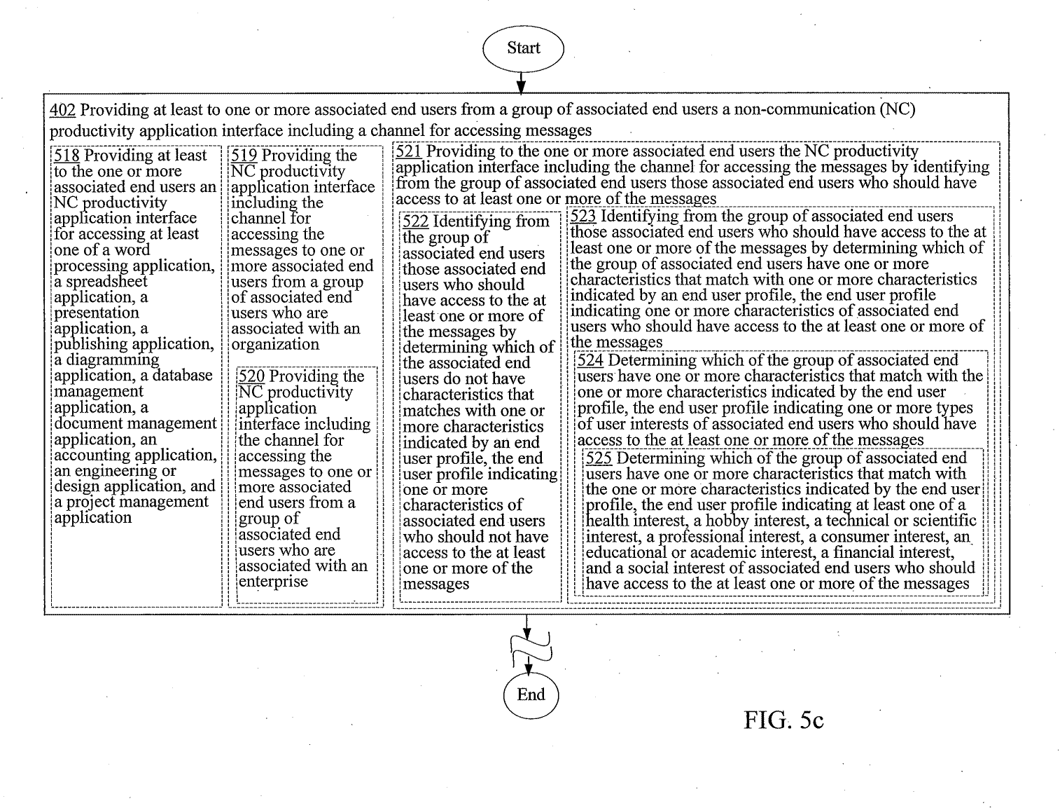

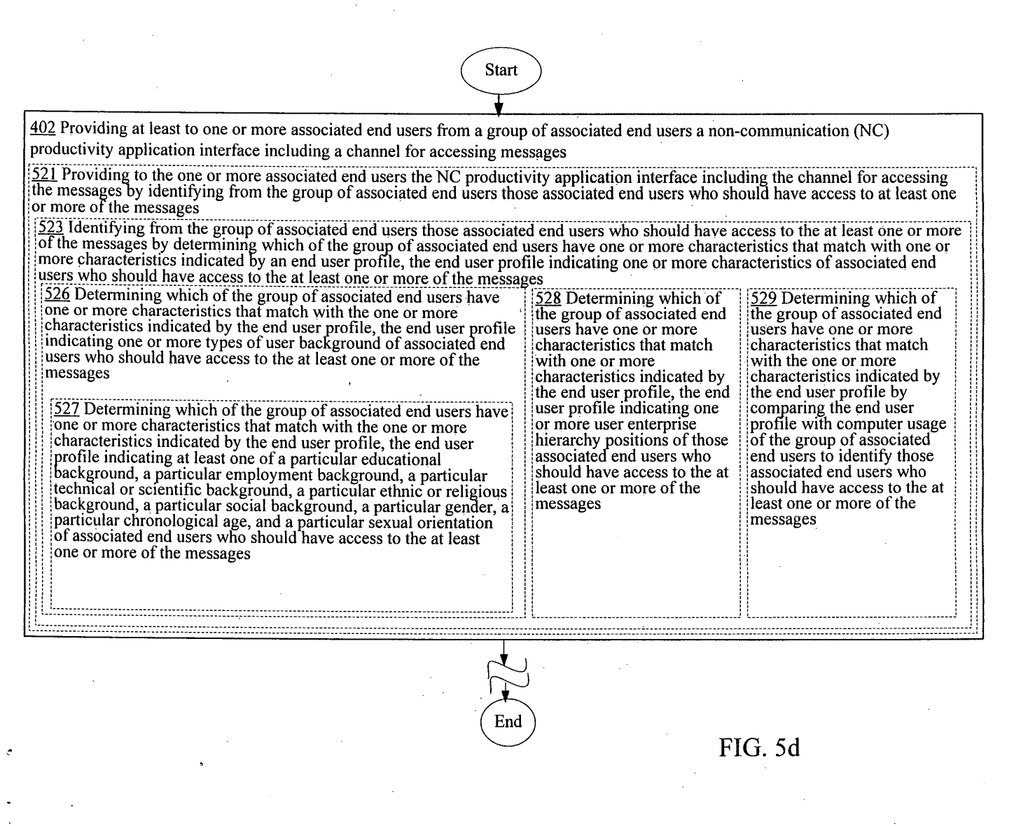

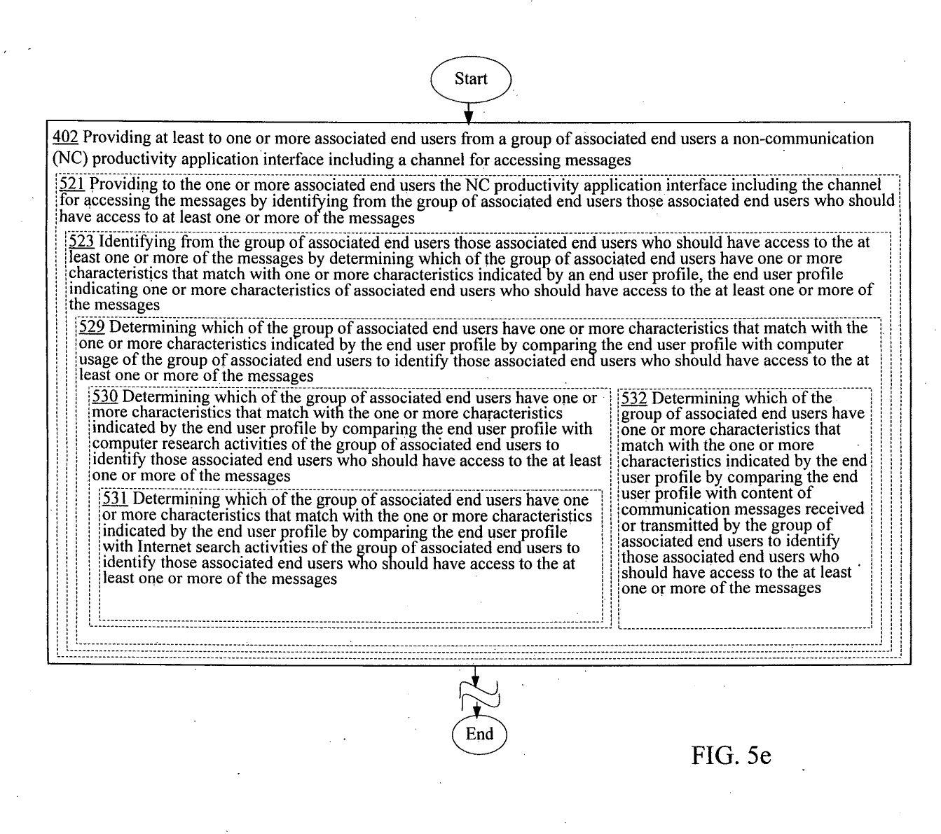

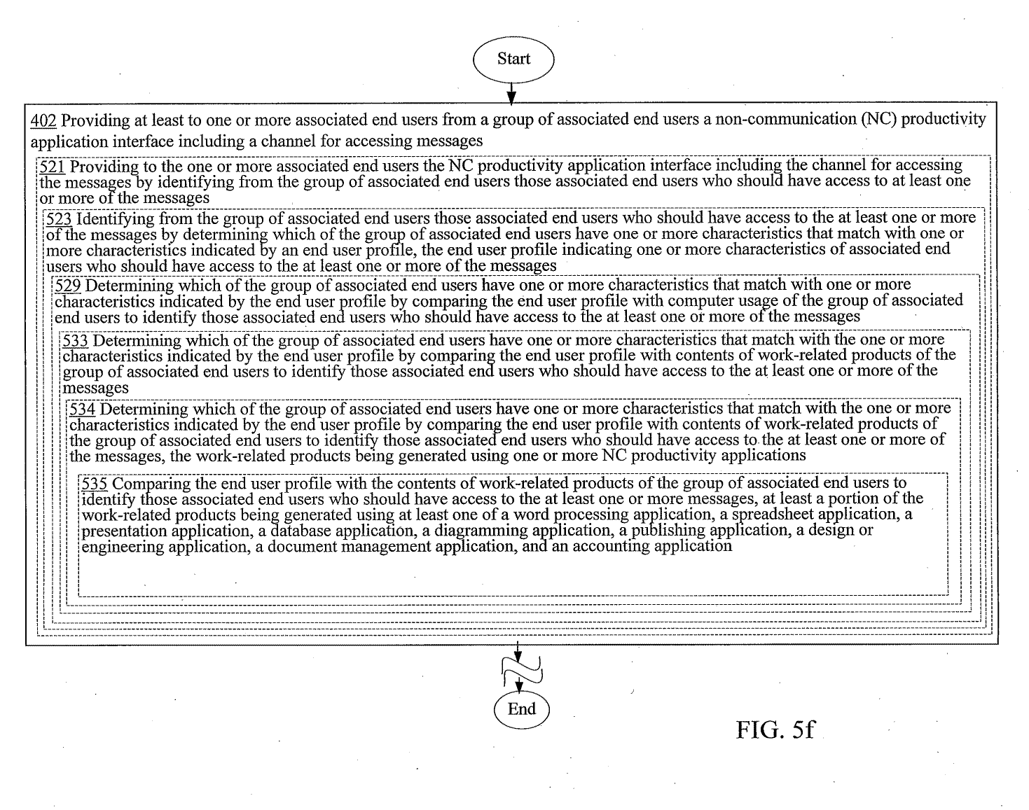

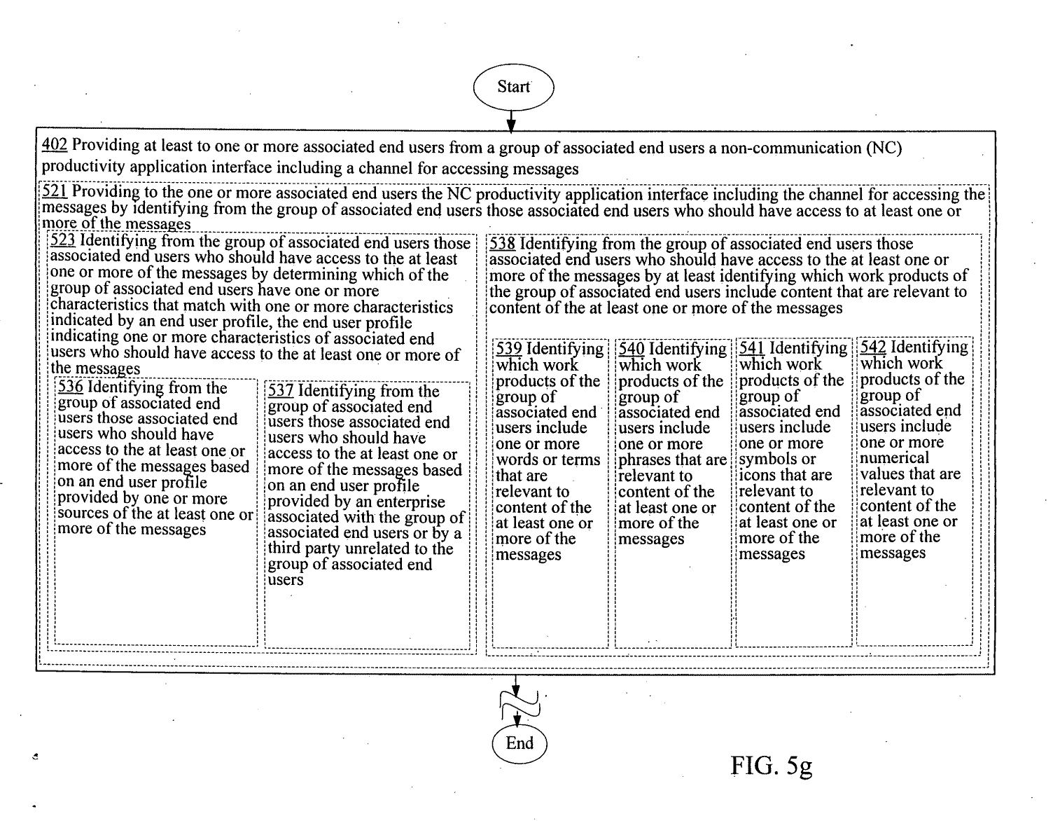

For example, FIGS. 5a, 5b, 5c, 5d, 5e, 5f, and 5g illustrate the various ways that the NC productivity application interface providing operation 402 of FIG. 4 may be executed in various alternative implementations. In some implementations, for instance, the NC productivity application interface providing operation 402 of FIG. 4 may include an operation 502 for providing at least to the one or more associated end users the NC productivity application interface by transmitting to the one or more associated end users one or more electronic copies of the NC productivity application interface as depicted in FIG. 5a. For instance, the NC productivity application interface providing module 102 including the transmitting module 202 (see FIG. 2a) of the computing system 10 of FIG. 1b providing at least to the one or more associated end users 40e and 40g the NC productivity application interface 62 when the transmitting module 202 transmits to the one or more associated end users 40e and 40g one or more electronic copies of the NC productivity application interface 62.

In some cases, operation 502 may further include an operation 503 for transmitting the one or more electronic copies of the NC productivity application interface via at least one communication network as further depicted in FIG. 5a. For instance, the network transmitting module 203 (see FIG. 2a) of the computing system 10 of FIG. 1b transmitting the one or more electronic copies of the NC productivity application interface 62 via at least one communication network 20 (e.g., LAN, MAN, WLAN, WiMAX, PTSN, PAN, cellular networks, and so forth).

In the same or different implementations, operation 502 may include an operation 504 for transmitting the one or more electronic copies of the NC productivity application interface via the Internet as further depicted in FIG. 5a. For instance, the Internet transmitting module 204 of the computing system 10 of FIG. 1b transmitting the one or more electronic copies of the NC productivity application interface 62 via the Internet.

The NC productivity application interface to be provided through the NC productivity application interface providing operation 402 of FIG. 4 may be a display interface, an audio interface, or other types of interface in various alternative implementations. For example, in some implementations, the NC productivity application interface providing operation 402 may include an operation 505 for providing at least to the one or more associated end users an NC productivity application display interface including the channel for accessing the messages as further depicted in FIG. 5a. For instance, the NC productivity application interface providing module 102 of the computing system 10 providing at least to the one or more associated end users 40e and 40g an NC productivity application display interface (e.g., an interface that may be shown or displayed through, for example, a display monitor) including the channel for accessing the messages 64a and 64b.

As illustrated in FIG. 5a, operation 505 may further include one or more operations. For example, in some implementations, operation 505 may include an operation 506 for providing at least to the one or more associated end users an NC productivity application display interface including a display window for accessing the messages. For instance, the NC productivity application interface providing module 102 of the computing system 10 providing at least to the one or more associated end users 40e and 40g an NC productivity application display interface (e.g., display interface 302b, 302c, 302d, etc. of FIGS. 3b, 3c, and so forth) including a display window 307* (see FIGS. 3b, 3c, and so forth) for accessing the messages 64a and 64b.

In some implementations, operation 505 may further include an operation 507 for providing at least to the one or more associated end users an NC productivity application display interface including a plurality of display windows for accessing the messages as further depicted in FIG. 5a. For instance, the NC productivity application interface providing module 102 of the computing system providing at least to the one or more associated end users 40e and 40g an NC productivity application display interface (e.g., display interface 302d, 302g, 302j, or 302m of FIGS. 2d, 2g, 2j, and 2m) including a plurality of display windows (e.g., display windows 307d′ and 307d″ of FIG. 3d, display windows 307g′ and 307g″ of FIG. 3g, and so forth) for accessing the messages 64a (e.g., message 308e in FIGS. 3g) and 64b (e.g., message 308f in FIG. 3g).

Operation 507, in turn, may further include an operation 508 for providing at least to the one or more associated end users an NC productivity application display interface including at least a first display window for accessing the first one or more messages and second display window for accessing the second one or more messages as depicted in FIG. 5a. For instance, the NC productivity application interface providing module 102 of the computing system 10 providing at least to the one or more associated end users an NC productivity application display interface (display interface 302d, 302g, 302j, or 302m of FIG. 3d, 3g, 3j, or 3m) including at least a first display window (e.g., display window 307d′, 307g′, 307j′, or 307m′ of FIG. 3d, 3g, 3j, or 3m) for accessing the first one or more messages 64a and second display window (e.g., display window 307d″, 307g″, 307j″, or 307m″ of FIG. 3d, 3g, 3j, or 3m) for accessing the second one or more messages 64b.

In the same or different implementations, operation 505 may include an operation 509 for providing at least to the one or more associated end users the NC productivity application display interface including the channel for accessing the messages, the NC productivity application display interface including at least a tool-bar portion and a workspace portion as depicted in FIG. 5b. For instance, the NC productivity application interface providing module 102 of the computing system 10 providing at least to the one or more associated end users 40e and 40g the NC productivity application display interface (e.g., display interface 302* of FIGS. 3b to 3m) including the channel for accessing the messages 64a and 64b, the NC productivity application display interface including at least a tool-bar portion 304 and a workspace portion 306.

As further illustrated in FIG. 5b, operation 509 may further include one or more additional operations in various alternative implementations. For example, in some implementations, operation 509 may include an operation 510 for providing at least to the one or more associated end users the NC productivity application display interface including at least one window for accessing the messages, the at least one window disposed at least in the tool-bar portion. For instance, the NC productivity application interface providing module 102 of the computing system 10 providing at least to the one or more associated end users 40e and 40g the NC productivity application display interface (e.g., display interface 302* of FIGS. 3b to 3j) including at least one window (e.g., display window 307* of FIGS. 3b to 3j) for accessing the messages 64a and 64b, the at least one window disposed at least in the tool-bar portion 304.

In some cases, operation 510 may further include an operation 511 for providing at least to the one or more associated end users the NC productivity application display interface including at least one window for accessing the messages, the at least one window replacing at least a portion of the tool-bar portion that previously indicated one or more tool-bar icons that was previously included in the tool-bar portion as further depicted in FIG. 5b. For instance, the NC productivity application interface providing module 102 of the computing system 10 providing at least to the one or more associated end users 40e and 40g the NC productivity application display interface (e.g., display interface 302* of FIG. 3e, 3f, or 3g) including at least one window (e.g., display window 307e, 307g′, or 307g″ of FIG. 3e, 3f, or 3g) for accessing the messages 64a and 64b, the at least one window replacing at least a portion of the tool-bar portion 304 that previously indicated one or more tool-bar icons (see FIG. 3a) that was previously included in the tool-bar portion 304.

In some implementations, operation 509 may include an operation 512 for providing at least to the one or more associated end users the NC productivity application display interface including at least one window for accessing the messages, the at least one window disposed at least in the workspace portion as further depicted in FIG. 5b. For instance, the NC productivity application interface providing module 102 of the computing system 10 providing at least to the one or more associated end users 40e and 40g the NC productivity application display interface (e.g., display interface 302* of FIGS. 3h to 3m) including at least one window (e.g., display window 307* of FIGS. 3h to 3m) for accessing the messages 64a and 64b, the at least one window disposed at least in the workspace portion 306.

In some implementations, operation 509 may include an operation 513 for providing at least to the one or more associated end users the NC productivity application display interface including at least one window for accessing the messages, the at least one window disposed at least in the tool-bar portion and the workspace portion as depicted in FIG. 5b. For instance, the NC productivity application interface providing module 102 of the computing system 10 providing at least to the one or more associated end users 40e and 40g the NC productivity application display interface (e.g., display interface 302* of FIGS. 3h to 3j) including at least one window (e.g., display window 307* of FIGS. 3h to 3j) for accessing the messages 64a and 64b, the at least one window disposed at least in the tool-bar portion 304 and the workspace portion 306.

In some implementations, the NC productivity application interface provided through the NC productivity application interface providing operation 402 of FIG. 4 may be an audio interface rather than, for example, a display interface. For example, in some implementations, the NC productivity application interface providing operation 402 of FIG. 4 may include an operation 514 for providing at least to the one or more associated end users an NC productivity application audio interface including the channel for accessing the messages as further depicted in FIG. 5b. For instance, the NC productivity application interface providing module 102 of the computing system 10 providing (e.g., transmitting or supplying) at least to the one or more associated end users 40e and 40g an NC productivity application audio interface including the channel for accessing the messages 64a and 64b.

As further illustrated in FIG. 5b, operation 514 may include one or more additional operations in various alternative implementations. For example, in some implementations, operation 514 may further include an operation 515 for providing at least to the one or more associated end users an NC productivity application audio interface including an audio window for accessing the messages as further depicted in FIG. 5b. For instance, the NC productivity application interface providing module 102 of the computing system 10 providing at least to the one or more associated end users 40e and 40g an NC productivity application audio interface including an audio window (e.g., an audio window may merely be a specified time period or interval) for accessing (e.g., indicating) the messages 64a and 64b.

In the same or different implementations, operation 514 may include an operation 516 for providing at least to the one or more associated end users an NC productivity application audio interface including a plurality of audio windows for accessing the messages as further depicted in FIG. 5b. For instance, the NC productivity application interface providing module 102 of the computing system 10 providing at least to the one or more associated end users 40e and 40g an NC productivity application audio interface including a plurality of audio windows (e.g., time intervals or increments) for accessing the messages 64a and 64b.

In some cases, operation 516 may further include an operation 517 for providing at least to the one or more associated end users an NC productivity application audio interface including at least a first audio window for accessing the first one or more messages and a second audio window for accessing the second one or more messages as further depicted in FIG. 5b. For instance, the NC productivity application interface providing module 102 of the computing system 10 providing at least to the one or more associated end users 40e and 40g an NC productivity application audio interface including at least a first audio window (e.g., second time window) for accessing the first one or more messages 64a and a second audio window (e.g., second time window) for accessing the second one or more messages 64b.

In some implementations, the NC productivity application interface providing operation 402 of FIG. 4 may include an operation 518 for providing at least to the one or more associated end users an NC productivity application interface for accessing at least one of a word processing application, a spreadsheet application, a presentation application, a publishing application, a diagramming application, a database management application, a personal information management application, a search application, a document management application, an accounting application, an engineering or design application, and a project management application as depicted in FIG. 5c. For instance, the NC productivity application interface providing module 102 of the computing system 10 providing at least to the one or more associated end users 40e and 40g an NC productivity application interface 62 for accessing at least one of a word processing application, a spreadsheet application, a presentation application, a publishing application, a diagramming application, a database management application, a personal information management application, a search application, a document management application, an accounting application, an engineering or design application, and a project management application.

In the same or different implementations, the NC productivity application interface providing operation 402 of FIG. 4 may include an operation 519 for providing the NC productivity application interface including the channel for accessing the messages to one or more associated end users from a group of associated end users who are associated with an organization as further depicted in FIG. 5c. For instance, the NC productivity application interface providing module 102 of the computing system 10 providing (e.g., transmitting or supplying) the NC productivity application interface 62 including the channel for accessing the messages 64a and 64b to one or more associated end users 40e and 40g from a group of associated end users 40* who are associated with an organization (e.g., a school, an academic group, a social organization, and so forth).

In some cases, operation 519 may, in turn include an operation 520 for providing the NC productivity application interface including the channel for accessing the messages to one or more associated end users from a group of associated end users who are associated with an enterprise as depicted in FIG. 5c. For instance, the NC productivity application interface providing module 102 of the computing system 10 providing (e.g., transmitting or supplying) the NC productivity application interface 62 including the channel for accessing the messages 64a and 64b to one or more associated end users 40e and 40g from a group of associated end users 40* who are associated with an enterprise (e.g., a business enterprise).

In order to provide the NC productivity application interface 62 to the one or more associated end users 40e and 40g in the NC productivity application interface providing operation 402 of FIG. 4, those associated end users 40e and 40g who should (e.g., who are targeted or designated to) have access to the messages 64a and 64b may initially be identified. For example, in some implementations, the NC productivity application interface providing operation 402 of FIG. 4 may include an operation 521 for providing to the one or more associated end users the NC productivity application interface including the channel for accessing the messages by identifying from the group of associated end users those associated end users who should have access to at least one or more of the messages as depicted in FIG. 5c. For instance, the NC productivity application interface providing module 102 including the associated end user identifying module 206 (see FIG. 2a) of the computing system 10 providing to the one or more associated end users 40e and 40g the NC productivity application interface 62 including the channel for accessing the messages 64a and 64b by having the associated end user identifying module 206 identify from the group of associated end users 40* those associated end users 40e and 40g who should have access to at least one or more of the messages (e.g., first one or more messages 64a and/or second one or more messages 64b).

As further illustrated in FIG. 5c, operation 521 may further include one or more additional operations in various alternative implementations. For example, in some implementations, operation 521 may further include an operation 522 for identifying from the group of associated end users those associated end users who should have access to the at least one or more of the messages by determining which of the associated end users do not have characteristics that matches with one or more characteristics indicated by an end user profile, the end user profile indicating one or more characteristics of associated end users who should not have access to the at least one or more of the messages as depicted in FIG. 5c. For instance, the associated end user identifying module 206 including the end user profile not matching determining module 208 (see FIG. 2a) of the computing system 10 identifying from the group of associated end users 40* those associated end users 40e and 40g who should have access to the at least one or more of the messages (e.g., first one or more messages 64a and/or second one or more messages 64b) by having the end user profile not matching determining module 208 determine which of the associated end users 40* do not have characteristics that match with one or more characteristics indicated by an end user profile 66, the end user profile 66 indicating one or more characteristics of associated end users who should not have access to the at least one or more of the messages 64a and 64b.

In some implementations, operation 521 may alternatively include an operation 523 for identifying from the group of associated end users those associated end users who should have access to the at least one or more of the messages by determining which of the group of associated end users have one or more characteristics that match with one or more characteristics indicated by an end user profile, the end user profile indicating one or more characteristics of associated end users who should have access to the at least one or more of the messages as depicted in FIG. 5c. For instance, the associated end user identifying module 206 including the end user profile matching determining module 210 (see FIG. 2a) of the computing system 10 identifying from the group of associated end users 40* those associated end users 40e and 40g who should have access to the at least one or more of the messages 64a and 64b by having the end user profile matching determining module 210 determine which of the group of associated end users 40* have one or more characteristics that match with one or more characteristics indicated by an end user profile 66, the end user profile 66 indicating one or more characteristics of associated end users 40e and 40g who should have access to the at least one or more of the messages (e.g., first one or more messages 64a and/or second one or more messages 64b).

In some implementations, operation 523 may further include an operation 524 for determining which of the group of associated end users have one or more characteristics that match with the one or more characteristics indicated by the end user profile, the end user profile indicating one or more types of user interests of associated end users who should have access to the at least one or more of the messages as depicted in FIG. 5c. For instance, the end user profile matching determining module 210 of the computing system 10 determining which of the group of associated end users 40* have one or more characteristics that match with the one or more characteristics indicated by the end user profile 66, the end user profile 66 indicating one or more types of user interests of associated end users 40e and 40g who should have access to the at least one or more of the messages (e.g., first one or more messages 64a and/or second one or more messages 64b).

Operation 524, in turn, may further include an operation 525 for determining which of the group of associated end users have one or more characteristics that match with the one or more characteristics indicated by the end user profile, the end user profile indicating at least one of a health interest, a hobby interest, a technical or scientific interest, a professional interest, a consumer interest, an educational or academic interest, a financial interest, and a social interest of associated end users who should have access to the at least one or more of the messages as depicted in FIG. 5c. For instance, the end user profile matching determining module 210 of the computing system 10 determining which of the group of associated end users 40* have one or more characteristics that match with the one or more characteristics indicated by the end user profile 66, the end user profile 66 indicating at least one of a health interest, a hobby interest, a technical or scientific interest, a professional interest, a consumer interest, an educational or academic interest, a financial interest, and a social interest of associated end users who should have access to the at least one or more of the messages (e.g., first one or more messages 64a and/or second one or more messages 64b).

In the same or different implementations, operation 523 may include an operation 526 for determining which of the group of associated end users have one or more characteristics that match with the one or more characteristics indicated by the end user profile, the end user profile indicating one or more types of user background of associated end users who should have access to the at least one or more of the messages as depicted in FIG. 5d. For instance, the end user profile matching determining module 210 of the computing system 10 determining which of the group of associated end users 40* have one or more characteristics that match with the one or more characteristics indicated by the end user profile 66, the end user profile 66 indicating one or more types of user background (e.g., personal background, educational background, employment background, health background, and so forth) of associated end users 40e and 40g who should have access to the at least one or more of the messages (e.g., first one or more messages 64a and/or second one or more messages 64b).

In some cases, operation 526 may further include an operation 527 for determining which of the group of associated end users have one or more characteristics that match with the one or more characteristics indicated by the end user profile, the end user profile indicating at least one of a particular educational background, a particular employment background, a particular technical or scientific background, a particular ethnic or religious background, a particular social background, a particular gender, a particular chronological age, and a particular sexual orientation of associated end users who should have access to the at least one or more of the messages as depicted in FIG. 5d. For instance, the end user profile matching determining module 210 of the computing system 10 determining which of the group of associated end users 40* have one or more characteristics that match with the one or more characteristics indicated by the end user profile 66, the end user profile 66 indicating at least one of a particular educational background, a particular employment background, a particular technical or scientific background, a particular ethnic or religious background, a particular social background, a particular gender, a particular chronological age, and a particular sexual orientation of associated end users 40e and 40g who should have access to the at least one or more of the messages (e.g., first one or more messages 64a and/or second one or more messages 64b).

In the same or different implementations, operation 523 may include an operation 528 for determining which of the group of associated end users have one or more characteristics that match with the one or more characteristics indicated by the end user profile, the end user profile indicating one or more user enterprise hierarchy positions of those associated end users who should have access to the at least one or more of the messages as further depicted in FIG. 5d. For instance, the end user profile matching determining module 210 of the computing system 10 determining which of the group of associated end users 40* have one or more characteristics that match with the one or more characteristics indicated by the end user profile 66, the end user profile 66 indicating one or more user enterprise hierarchy positions (e.g., vice-president, controller, accountant, clerk, and so forth) of those associated end users 40e and 40g who should have access to the at least one or more of the messages (e.g., first one or more messages 64a and/or second one or more messages 64b).

In the same or different implementations, operation 523 may include an operation 529 for determining which of the group of associated end users have one or more characteristics that match with the one or more characteristics indicated by the end user profile by comparing the end user profile with computer usage of the group of associated end users to identify those associated end users who should have access to the at least one or more of the messages as further depicted in FIG. 5d. For instance, the end user profile matching determining module 210 including the computer usage comparison module 212 (see FIG. 2a) of the computing system 10 determining which of the group of associated end users 40* have one or more characteristics that match with the one or more characteristics indicated by the end user profile 66 by having the computer usage comparison module 212 compare the end user profile 66 with computer usage of the group of associated end users 40* to identify those associated end users 40e and 40g who should have access to the at least one or more of the messages (e.g., first one or more messages 64a and/or second one or more messages 64b).

In various implementations, operation 529 may further include one or more additional operations. For example, in some implementations, operation 529 may further include an operation 530 for determining which of the group of associated end users have one or more characteristics that match with the one or more characteristics indicated by the end user profile by comparing the end user profile with computer research activities of the group of associated end users to identify those associated end users who should have access to the at least one or more of the messages as depicted in FIG. 5e. For instance, the end user profile matching determining module 210 including the computer research activity comparison module 213 (see FIG. 2a) of the computing system 10 determining which of the group of associated end users 40* have one or more characteristics that match with the one or more characteristics indicated by the end user profile 66 by having the computer research activity comparison module 213 compare the end user profile 66 with computer research activities of the group of associated end users 40* to identify those associated end users 40e and 40g who should have access to the at least one or more of the messages (e.g., first one or more messages 64a and/or second one or more messages 64b).

In some implementations, operation 530 may, in turn, further include an operation 531 for determining which of the group of associated end users have one or more characteristics that match with the one or more characteristics indicated by the end user profile by comparing the end user profile with Internet search activities of the group of associated end users to identify those associated end users who should have access to the at least one or more of the messages as further depicted in FIG. 5e. For instance, the end user profile matching determining module 210 including the Internet search activity comparison module 214 (see FIG. 2a) of the computing system 10 determining which of the group of associated end users 40* have one or more characteristics that match with the one or more characteristics indicated by the end user profile 66 by having the Internet search activity comparison module 214 compare the end user profile 66 with Internet search activities of the group of associated end users 40* to identify those associated end users 40e and 40g who should have access to the at least one or more of the messages (e.g., first one or more messages 64a and/or second one or more messages 64b).

In some implementations, operation 529 may include an operation 532 for determining which of the group of associated end users have one or more characteristics that match with the one or more characteristics indicated by the end user profile by comparing the end user profile with content of communication messages received or transmitted by the group of associated end users to identify those associated end users who should have access to the at least one or more of the messages as depicted in FIG. 5e. For instance, the end user profile matching determining module 210 including the communication message comparison module 216 (see FIG. 2a) of the computing system 10 determining which of the group of associated end users 40* have one or more characteristics that match with the one or more characteristics indicated by the end user profile 66 by having the communication message comparison module 216 compare the end user profile 66 with content of communication messages (e.g., emails, text messages, IM, and so forth) received or transmitted by the group of associated end users 40* to identify those associated end users 40e and 40g who should have access to the at least one or more of the messages (e.g., first one or more messages 64a and/or second one or more messages 64b).

In the same or different implementations, operation 529 may include an operation 533 for determining which of the group of associated end users have one or more characteristics that match with the one or more characteristics indicated by the end user profile by comparing the end user profile with contents of work-related products of the group of associated end users to identify those associated end users who should have access to the at least one or more of the messages as further depicted in FIG. 5f. For instance, the end user profile matching determining module 210 including the work-related product comparison module 218 (see FIG. 2a) of the computing system 10 determining which of the group of associated end users 40* have one or more characteristics that match with the one or more characteristics indicated by the end user profile 66 by having the work-related product comparison module 218 compare the end user profile 66 with contents of work-related products (e.g., text documents, financial or accounting documents, diagrams, and so forth) of the group of associated end users 40* to identify those associated end users 40e and 40g who should have access to the at least one or more of the messages (e.g., first one or more messages 64a and/or second one or more messages 64b).

Operation 533, in turn, may further include an operation 534 for determining which of the group of associated end users have one or more characteristics that match with the one or more characteristics indicated by the end user profile by comparing the end user profile with contents of work-related products of the group of associated end users to identify those associated end users who should have access to the at least one or more of the messages, the work-related products being generated using one or more NC productivity applications as further depicted in FIG. 5f. For instance, the end user profile matching determining module 210 including the work-related product comparison module 218 (see FIG. 2a) of the computing system 10 determining which of the group of associated end users 40* have one or more characteristics that match with the one or more characteristics indicated by the end user profile 66 by having the work-related product comparison module 218 compare the end user profile 66 with contents of work-related products of the group of associated end users 40* to identify those associated end users 40e and 40g who should have access to the at least one or more of the messages 64a and 64b, the work-related products being generated using one or more NC productivity applications.

In some implementations, operation 534 may further include an operation 535 for comparing the end user profile with the contents of work-related products of the group of associated end users to identify those associated end users who should have access to the at least one or more messages, at least a portion of the work-related products being generated using at least one of a word processing application, a spreadsheet application, a presentation application, a database application, a diagramming application, a publishing application, a design or engineering application, a search application, a document management application, and an accounting application as further depicted in FIG. 5f. For instance, the work-related product comparison module 218 of the computing system 10 comparing the end user profile 66 with the contents of work-related products of the group of associated end users 40* to identify those associated end users 40e and 40g who should have access to the at least one or more messages 64a and 64b, at least a portion of the work-related products being generated using at least one of a word processing application, a spreadsheet application, a presentation application, a database application, a diagramming application, a publishing application, a design or engineering application, a search application, a document management application, and an accounting application.

In some implementations, operation 523 may include an operation 536 for identifying from the group of associated end users those associated end users who should have access to the at least one or more of the messages based on an end user profile provided by one or more sources of the at least one or more of the messages as depicted in FIG. 5g. For instance, the associated end user identifying module 206 of the computing system 10 identifying (e.g., determining or ascertaining) from the group of associated end users 40* those associated end users 40e and 40g who should have access to the at least one or more of the messages 64a and 64b based on an end user profile 66 provided by one or more sources (e.g. enterprise 30 associated with the associated end user 40* and/or a third party 70 such as a third party advertiser) of the at least one or more of the messages 64a and 64b.

In the same or different implementations, operation 523 may include an operation 537 for identifying from the group of associated end users those associated end users who should have access to the at least one or more of the messages based on an end user profile provided by an enterprise associated with the group of associated end users or by a third party unrelated to the group of associated end users as depicted in FIG. 5g. For instance, the associated end user identifying module 206 of the computing system 10 identifying (e.g., finding or ascertaining) from the group of associated end users 40* those associated end users 40e and 40g who should have access to the at least one or more of the messages 64a and 64b based on an end user profile 66 provided by an enterprise 30 associated with the group of associated end users 40* or by a third party 70 unrelated to the group of associated end users 40*.

In some implementations, operation 521 may include an operation 538 for identifying from the group of associated end users those associated end users who should have access to the at least one or more of the messages by at least identifying which work products of the group of associated end users include content that are relevant to content of the at least one or more of the messages as depicted in FIG. 5g. For instance, the associated end user identifying module 206 including the relevant work product identifying module 220 (see FIG. 2a) of the computing system 10 identifying from the group of associated end users 40* those associated end users 40e and 40g who should have access to the at least one or more of the messages 64a and 64b by at least identifying which work products of the group of associated end users 40* include content that are relevant to content of the at least one or more of the messages 64a and 64b.

In some implementations, operation 538 may include an operation 539 for identifying which work products of the group of associated end users include one or more words or terms that are relevant to content of the at least one or more of the messages as further depicted in FIG. 5g. For instance, the relevant work product identifying module 220 of the computing system 10 identifying which work products of the group of associated end users 40* include one or more words or terms (e.g., verbs, nouns, adjectives, and so forth) that are relevant to content of the at least one or more of the messages 64a and 64b.

In the same or different implementations, operation 538 may include an operation 540 for identifying which work products of the group of associated end users include one or more phrases that are relevant to content of the at least one or more of the messages as further depicted in FIG. 5g. For instance, the relevant work product identifying module 220 of the computing system 10 identifying which work products of the group of associated end users 40* include one or more phrases that are relevant to content of the at least one or more of the messages 64a and 64b.

In the same or different implementations, operation 538 may include an operation 541 for identifying which work products of the group of associated end users include one or more symbols or icons that are relevant to content of the at least one or more of the messages as further depicted in FIG. 5g. For instance, the relevant work product identifying module 220 of the computing system 10 identifying which work products of the group of associated end users 40* include one or more symbols or icons that are relevant to content of the at least one or more of the messages 64a and 64b.

In the same or different implementations, operation 538 may include an operation 542 for identifying which work products of the group of associated end users include one or more numerical values that are relevant to content of the at least one or more of the messages as further depicted in FIG. 5g. For instance, the relevant work product identifying module 220 of the computing system 10 identifying which work products of the group of associated end users 40* include one or more numerical values (e.g. date and/or time) that are relevant to content of the at least one or more of the messages 64a and 64b.

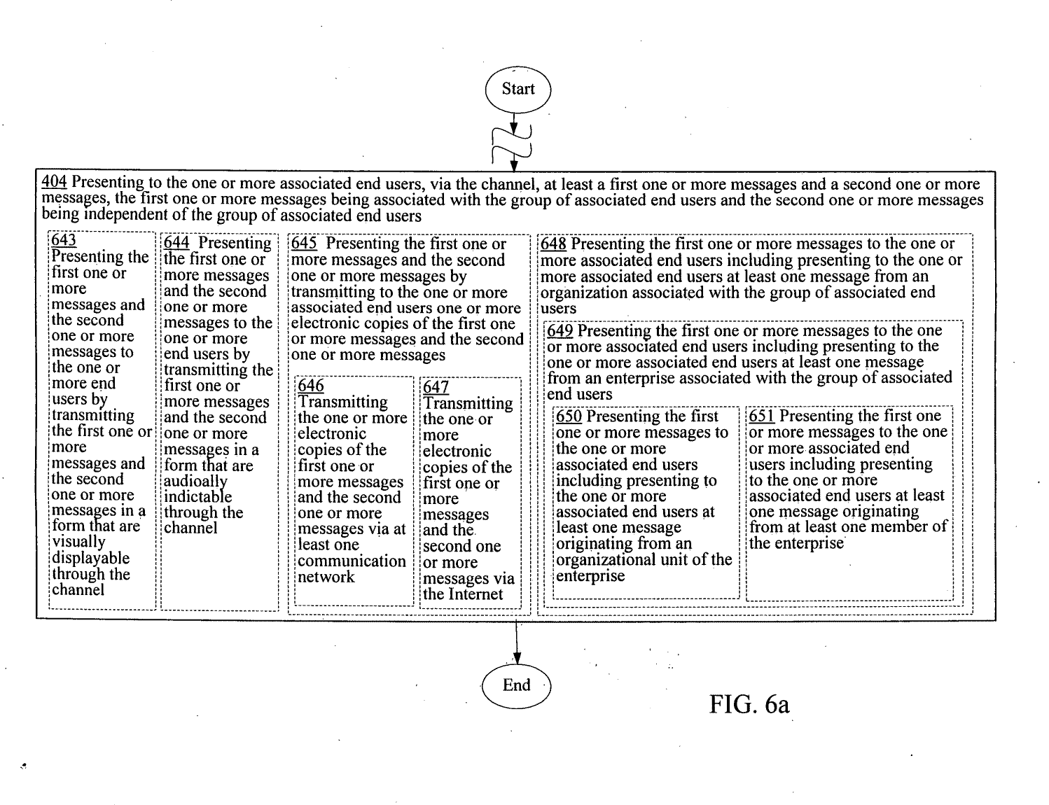

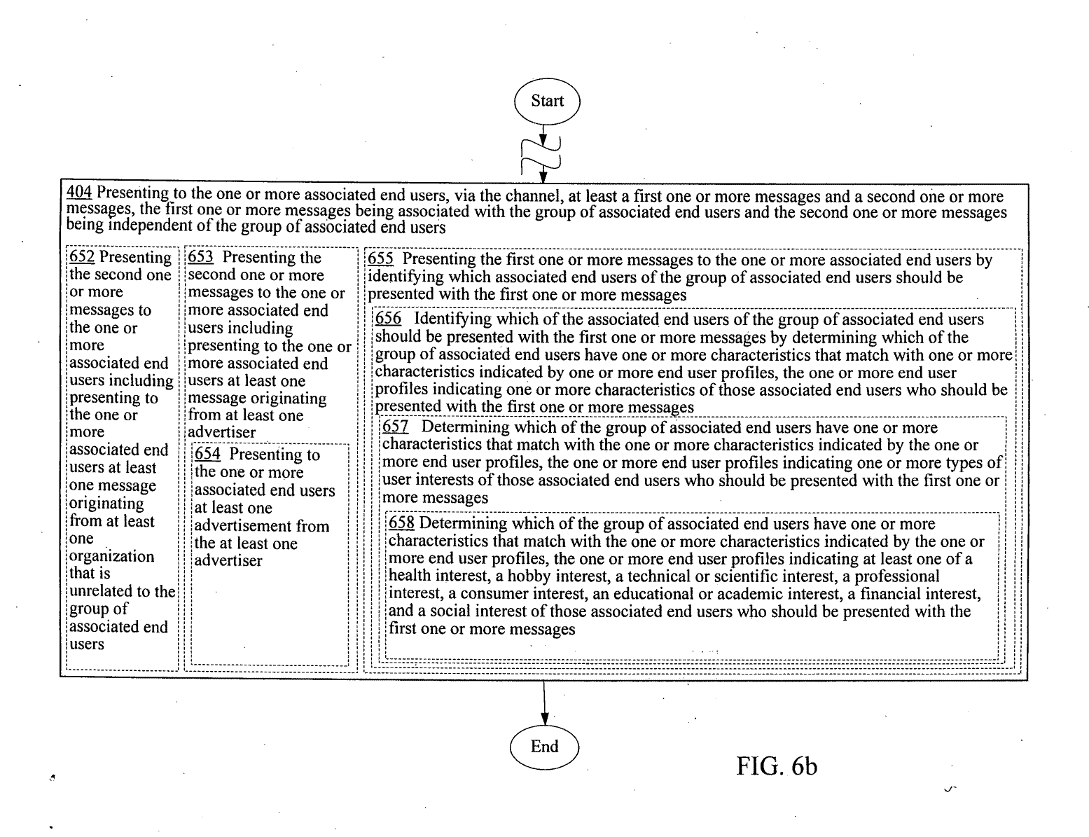

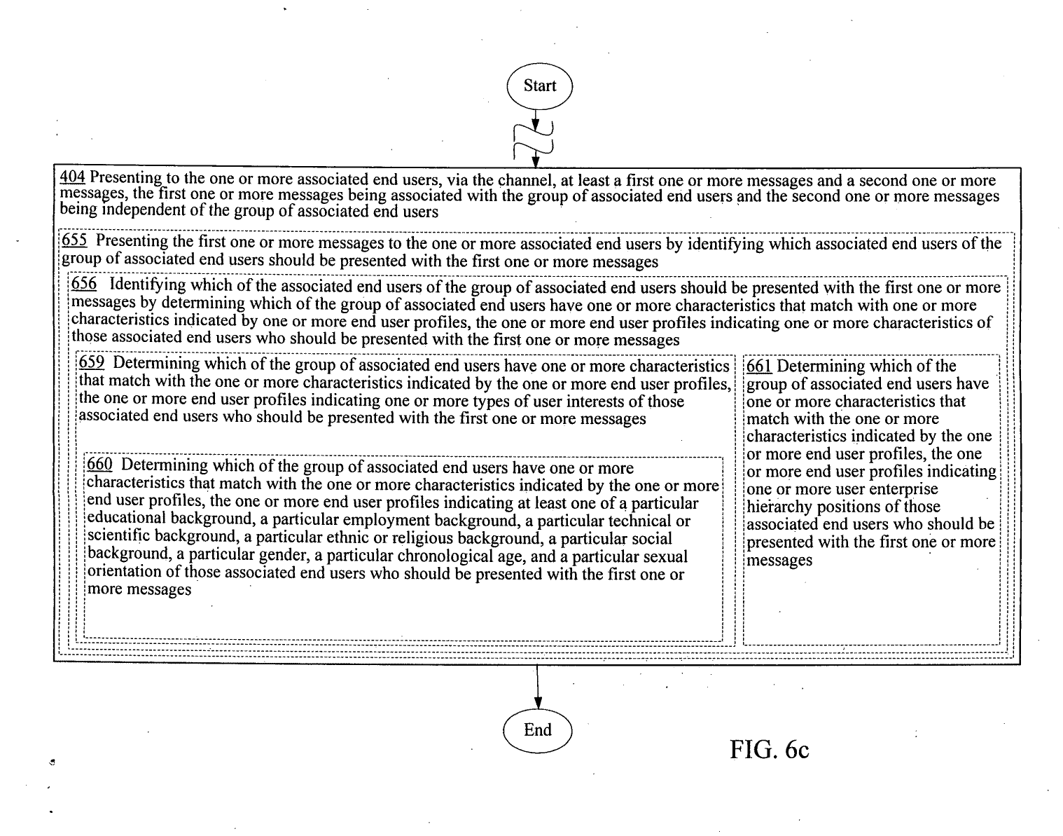

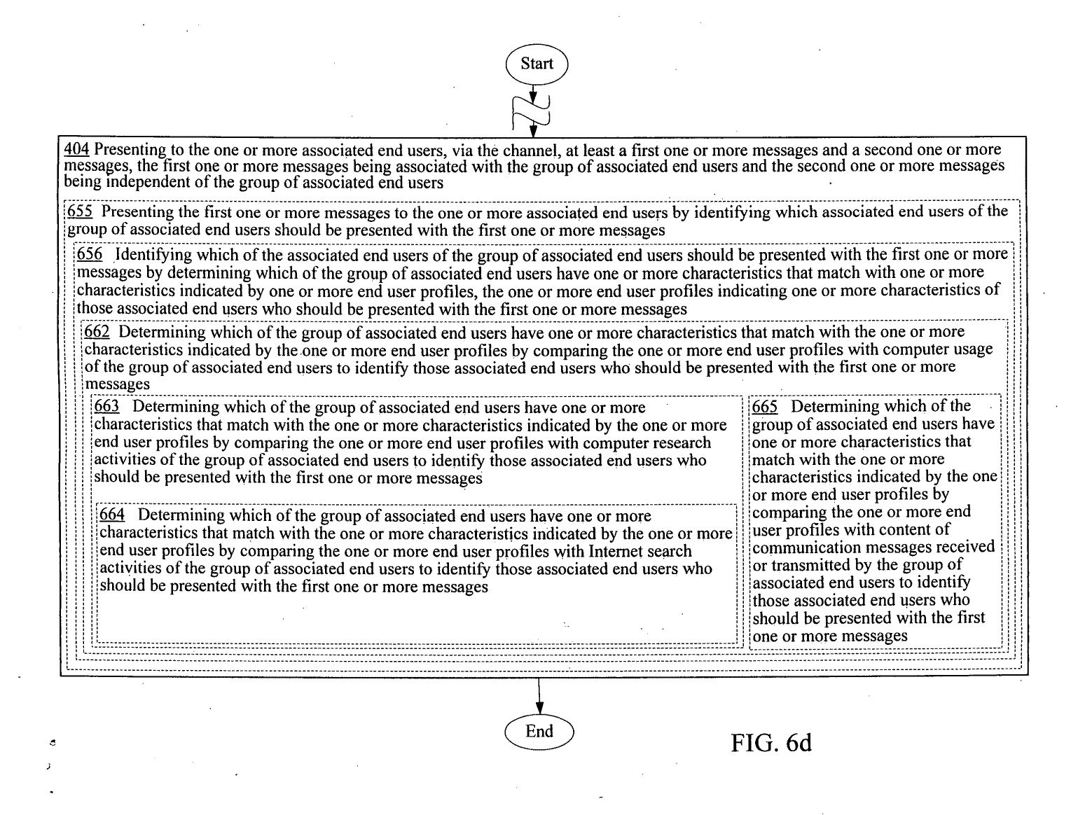

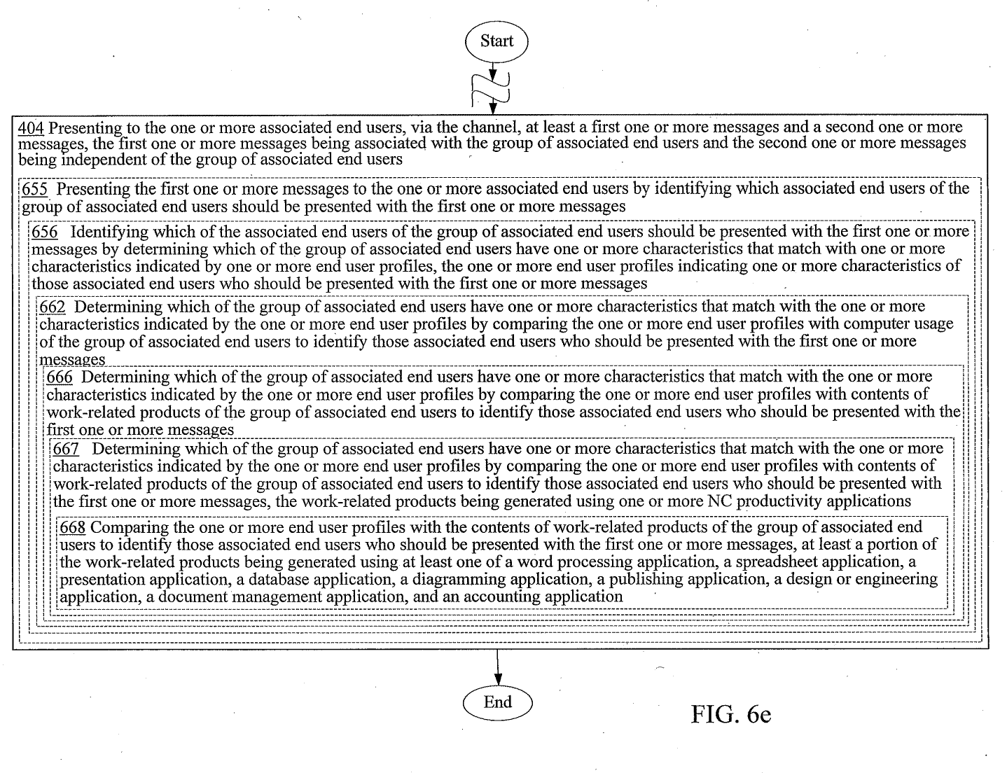

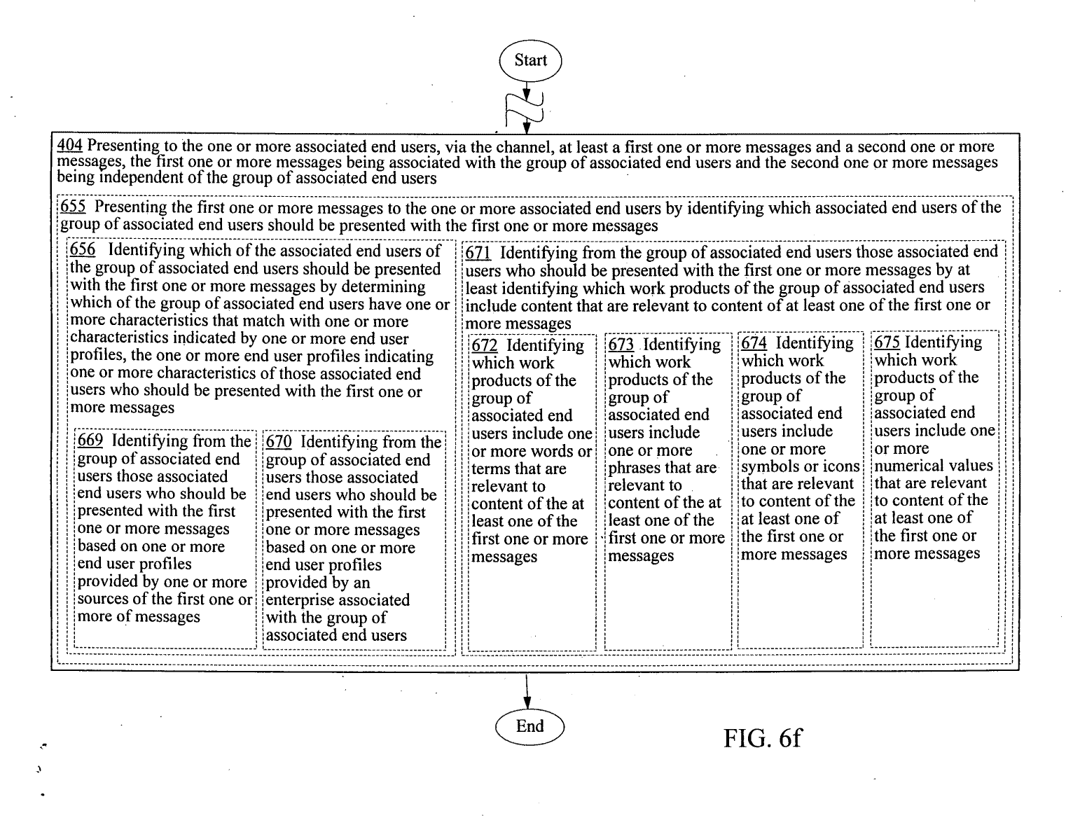

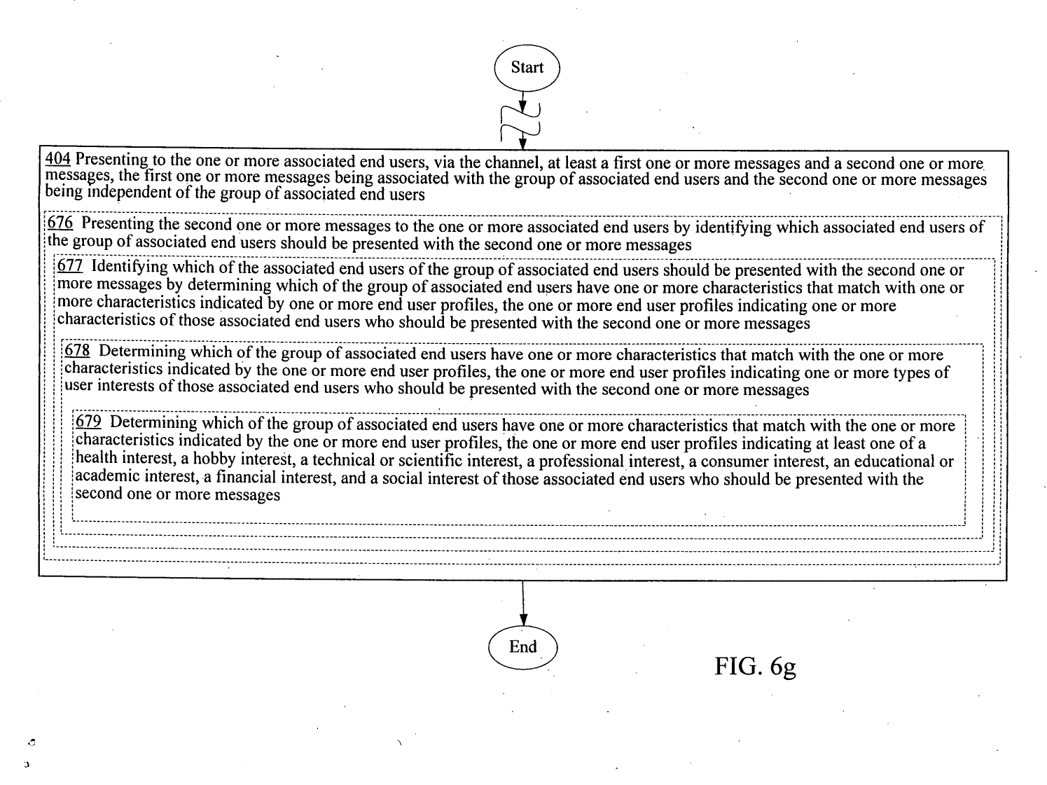

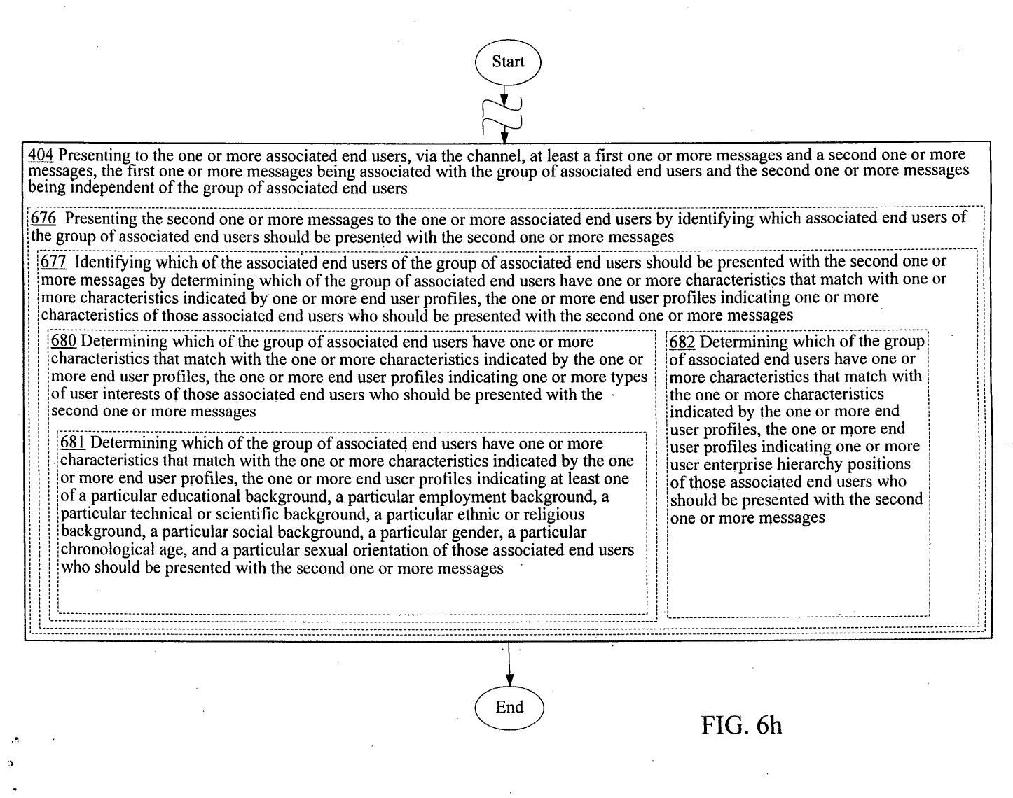

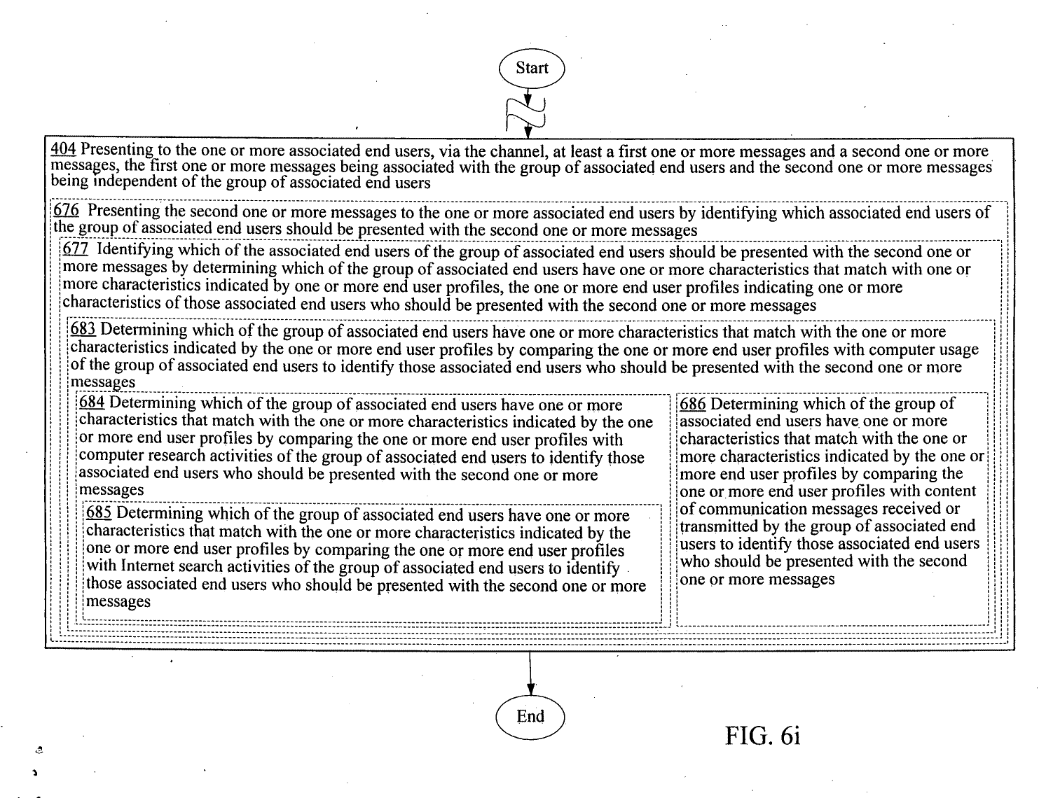

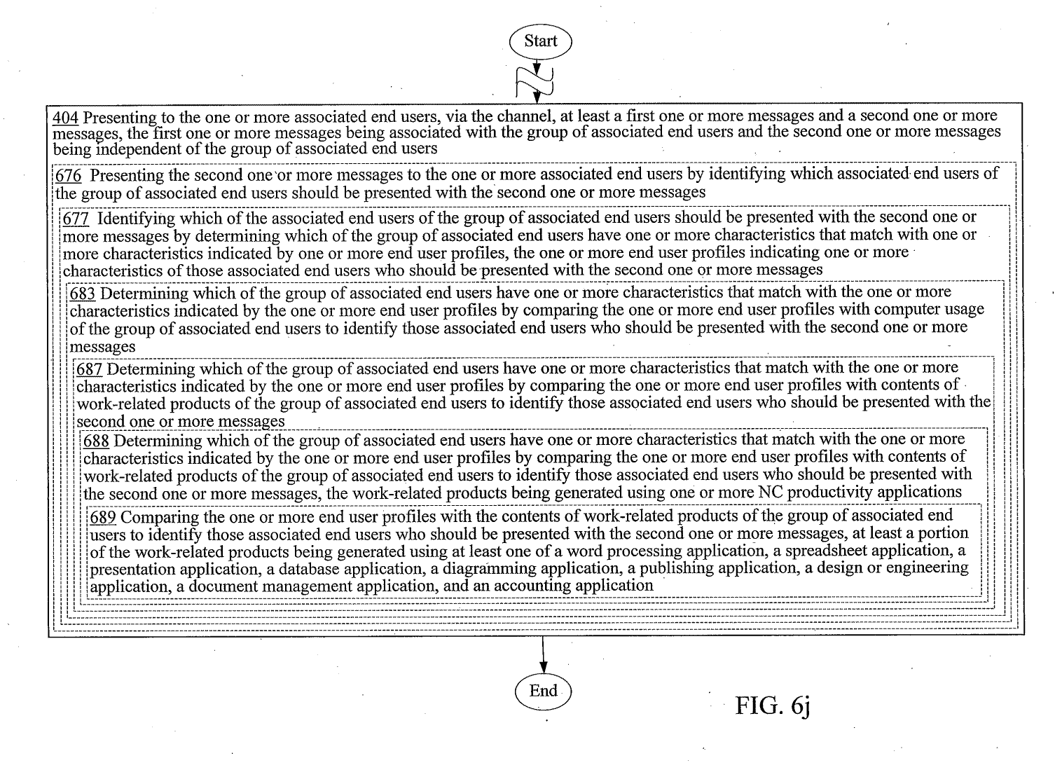

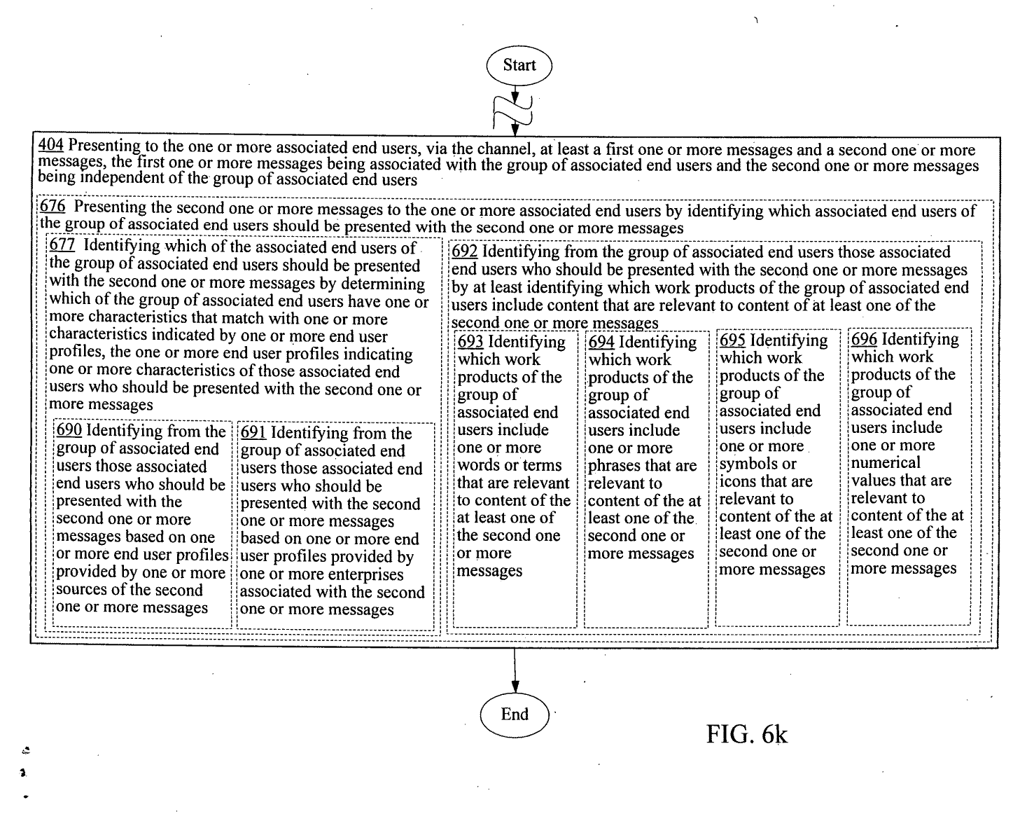

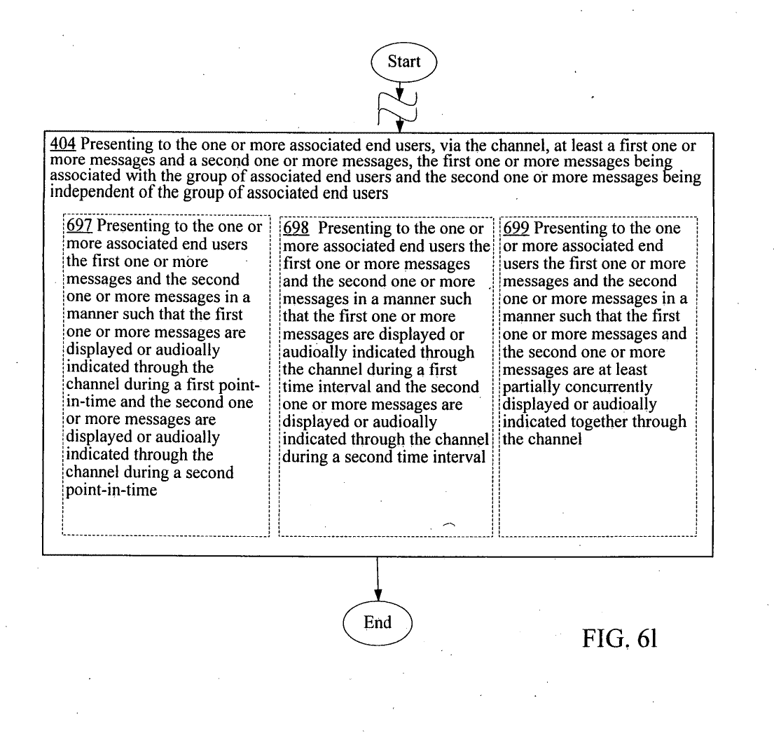

Referring back to FIG. 4, the messages presenting operation 404 of FIG. 4 may include one or more additional operations in various alternative implementations. For example, in some implementations, the messages presenting operation 404 may include an operation 643 for presenting the first one or more messages and the second one or more messages to the one or more end users by transmitting the first one or more messages and the second one or more messages in a form that are visually displayable through the channel as depicted in FIG. 6a. For instance, the message presenting module 104 including the transmitting module 234 (see FIG. 2b) of the computing system 10 presenting the first one or more messages 64a and the second one or more messages 64b to the one or more end users 40e and 40g by having the transmitting module 234 transmitting the first one or more messages 64a and the second one or more messages 64b in a form that are visually displayable through the channel. For example the first one or more messages 64a and the second one or more messages 64b may be transmitted in the form of an electronic signal that may be further processed in order to visually display the first one or more messages 64a and the second one or more messages 64b.

In the same or different implementations, the messages presenting operation 404 of FIG. 4 may include an operation 644 for presenting the first one or more messages and the second one or more messages to the one or more end users by transmitting the first one or more messages and the second one or more messages in a form that are audioally indictable through the channel as depicted in FIG. 6a. For instance, the messages presenting module 104 including the transmitting module 234 of the computing system 10 presenting the first one or more messages 64a and the second one or more messages 64b to the one or more end users 40e and 40g by having the transmitting module 234 transmitting the first one or more messages 64a and the second one or more messages 64b in a form that are audioally indictable through the channel. In other words, transmitting a first one or more messages 64a and a second one or more messages 64b in electronic signal form that may be processed in order to audioally indicate the first one or more messages 64a and the second one or more messages 64b.

In the same or different implementations, the messages presenting operation 404 of FIG. 4 may include an operation 645 for presenting the first one or more messages and the second one or more messages by transmitting to the one or more associated end users one or more electronic copies of the first one or more messages and the second one or more messages as further depicted in FIG. 6a. For instance, the messages presenting module 104 including the transmitting module 234 of the computing system 10 presenting the first one or more messages 64a and the second one or more messages 64b by having the transmitting module 234 transmitting to the one or more associated end users 40e and 40g (e.g., transmitting to the end user devices 50e and 50g used by the end users 40e and 40g) one or more electronic copies of the first one or more messages 64a and the second one or more messages 64b.

In some implementations, operation 645 may further include an operation 646 for transmitting the one or more electronic copies of the first one or more messages and the second one or more messages via at least one communication network as further depicted in FIG. 6a. For instance, the network transmitting module 236 (see FIG. 2b) of the computing system 10 transmitting the one or more electronic copies of the first one or more messages 64a and the second one or more messages 64b via at least one communication network 20 (e.g., LAN, WAN, WLAN, MAN, PAN, Client/Server Network, virtual private network, and so forth).

In the same or different implementations, operation 645 may include an operation 647 for transmitting the one or more electronic copies of the first one or more messages and the second one or more messages via the Internet as further depicted in FIG. 6a. For instance, the Internet transmitting module 238 (see FIG. 2b) of the computing system 10 transmitting the one or more electronic copies of the first one or more messages 64a and the second one or more messages 64b via the Internet.

In some implementations, the messages presenting operation 404 of FIG. 4 may include an operation 648 for presenting the first one or more messages to the one or more associated end users including presenting to the one or more associated end users at least one message from an organization associated with the group of associated end users as further depicted in FIG. 6a. For instance, the messages presenting module 104 of the computing system 10 presenting the first one or more messages 64a to the one or more associated end users 40e and 40g including presenting to the one or more associated end users 40e and 40g at least one message from an organization (e.g., a social organization, a business organization, an industry or trade organization, and so forth) associated with the group of associated end users 40*.

In some implementations, operation 648 may further include an operation 649 for presenting the first one or more messages to the one or more associated end users including presenting to the one or more associated end users at least one message from an enterprise associated with the group of associated end users as further depicted in FIG. 6a. For instance, the messages presenting module 104 of the computing system 10 presenting the first one or more messages 64a to the one or more associated end users 40e and 40g including presenting to the one or more associated end users 40e and 40g at least one message from an enterprise 30 associated with the group of associated end users 40*.

In some implementations, operation 649 may further include an operation 650 for presenting the first one or more messages to the one or more associated end users including presenting to the one or more associated end users at least one message originating from an organizational unit of the enterprise as further depicted in FIG. 6a. For instance, the messages presenting module 104 of the computing system 10 presenting the first one or more messages 64a to the one or more associated end users 40e and 40g including presenting to the one or more associated end users 40e and 40g at least one message from an organizational unit (e.g., human resources department) of the enterprise 30.

In the same or different implementations, operation 649 may include an operation 651 for presenting the first one or more messages to the one or more associated end users including presenting to the one or more associated end users at least one message originating from at least one member of the enterprise as further depicted in FIG. 6a. For instance, the messages presenting module 104 of the computing system 10 presenting the first one or more messages 64a to the one or more associated end users 40e and 40g including presenting to the one or more associated end users 40e and 40g at least one message originating from at least one member (e.g. end user 40a in the example illustrated by FIGS. 1a and 1b) of the enterprise 30.

In some implementations, the messages presenting operation 404 of FIG. 4 may include an operation 652 for presenting the second one or more messages to the one or more associated end users including presenting to the one or more associated end users at least one message originating from at least one organization that is unrelated to the group of associated end users as depicted in FIG. 6b. For instance, the messages presenting module 104 of the computing system 10 presenting the second one or more messages 64b to the one or more associated end users 40e and 40g including presenting to the one or more associated end users 40e and 40g at least one message originating from at least one organization (e.g., third party organization such as an advertiser) that is unrelated to the group of associated end users 40*.

In the same or different implementations, the messages presenting operation 404 of FIG. 4 may further include an operation 653 of presenting the second one or more messages to the one or more associated end users including presenting to the one or more associated end users at least one message originating from at least one advertiser as further depicted in FIG. 6b. For instance, the messages presenting module 104 of the computing system 10 presenting the second one or more messages 64b to the one or more associated end users 40e and 40g including presenting to the one or more associated end users 40e and 40g at least one message originating from at least one advertiser (e.g., a third party at least not directly associated with the associated end users 40*).

In some cases, operation 653 may further include an operation 654 for presenting to the one or more associated end users at least one advertisement from the at least one advertiser as depicted in FIG. 6b. For instance, the messages presenting module 104 of the computing system 10 presenting to the one or more associated end users 40e and 40g at least one advertisement from the at least one advertiser.

In some implementations, the messages presenting operation 404 of FIG. 4 may include an operation 655 for presenting the first one or more messages to the one or more associated end users by identifying which associated end users of the group of associated end users should be presented with the first one or more messages as depicted in FIG. 6b. For instance, the messages presenting module 104 including the associated end user identifying module 240 (see FIG. 2b) of the computing system 10 presenting the first one or more messages 64a to the one or more associated end users 40e and 40g by having the associated end user identifying module 240 identify which associated end users of the group of associated end users 40* “should be” presented with the first one or more messages 64a. Note that the phrase “should be” is used here rather than “are to be” since this operation merely identifies those associated end users who are designated or targeted for being presented with the first one or more messages 64a.

As further illustrated in FIG. 6b, operation 655 may further include one or more additional operations in various alternative implementations. For example, in some implementations, operation 655 may further include an operation 656 for identifying which of the associated end users of the group of associated end users should be presented with the first one or more messages by determining which of the group of associated end users have one or more characteristics that match with one or more characteristics indicated by one or more end user profiles, the one or more end user profiles indicating one or more characteristics of those associated end users who should be presented with the first one or more messages. For instance, the associated end user identifying module 240 including the end user profile matching determining module 242 (see FIG. 2b) of the computing system 10 identifying (e.g. determining) which of the associated end users of the group of associated end users 40* should be presented with the first one or more messages 64a by having the end user profile matching determining module 242 determine which of the group of associated end users 40* have one or more characteristics that match with one or more characteristics indicated by one or more end user profiles 66, the one or more end user profiles 66 indicating one or more characteristics of those associated end users 40e and 40g who should be presented with the first one or more messages 64a.

Operation 656 in turn may in some implementations include an operation 657 for determining which of the group of associated end users have one or more characteristics that match with the one or more characteristics indicated by the one or more end user profiles, the one or more end user profiles indicating one or more types of user interests of those associated end users who should be presented with the first one or more messages as further depicted in FIG. 6b. For instance, the end user profile matching determining module 242 of the computing system 10 determining which of the group of associated end users 40* have one or more characteristics that match with the one or more characteristics indicated by the one or more end user profiles 66, the one or more end user profiles 66 indicating one or more types of user interests of those associated end users who should be presented with the first one or more messages 64a.

In some cases, operation 657 may further include an operation 658 for determining which of the group of associated end users have one or more characteristics that match with the one or more characteristics indicated by the one or more end user profiles, the one or more end user profiles indicating at least one of a health interest, a hobby interest, a technical or scientific interest, a professional interest, a consumer interest, an educational or academic interest, a financial interest, and a social interest of those associated end users who should be presented with the first one or more messages as further depicted in FIG. 6b. For instance, the end user profile matching determining module 242 of the computing system 10 determining which of the group of associated end users 40* have one or more characteristics that match with the one or more characteristics indicated by the one or more end user profiles 66, the one or more end user profiles 66 indicating at least one of a health interest, a hobby interest, a technical or scientific interest, a professional interest, a consumer interest, an educational or academic interest, a financial interest, and a social interest of those associated end users 40e and 40g who should be presented with the first one or more messages 64a.

In some implementations, operation 656 of FIG. 6b for “identifying which of the associated end users of the group of associated end users should be presented with the first one or more messages by determining which of the group of associated end users have one or more characteristics that match with one or more characteristics indicated by one or more end user profiles” may further include an operation 659 for determining which of the group of associated end users have one or more characteristics that match with the one or more characteristics indicated by the one or more end user profiles, the one or more end user profiles indicating one or more types of user interests of those associated end users who should be presented with the first one or more messages as depicted in FIG. 6c. For instance, the end user profile matching determining module 242 of the computing system 10 determining which of the group of associated end users 40* have one or more characteristics that match with the one or more characteristics indicated by the one or more end user profiles 66, the one or more end user profiles 66 indicating one or more types of user interests of those associated end users 40e and 40g who should be presented with the first one or more messages 64a.

In some implementations, operation 659 may further include an operation 660 for determining which of the group of associated end users have one or more characteristics that match with the one or more characteristics indicated by the one or more end user profiles, the one or more end user profiles indicating at least one of a particular educational background, a particular employment background, a particular technical or scientific background, a particular ethnic or religious background, a particular social background, a particular gender, a particular chronological age, and a particular sexual orientation of those associated end users who should be presented with the first one or more messages as depicted in FIG. 6c. For instance, the end user profile matching determining module 242 of the computing system 10 determining which of the group of associated end users 40* have one or more characteristics that match with the one or more characteristics indicated by the one or more end user profiles 66, the one or more end user profiles 66 indicating at least one of a particular educational background, a particular employment background, a particular technical or scientific background, a particular ethnic or religious background, a particular social background, a particular gender, a particular chronological age, and a particular sexual orientation of those associated end users 40e and 40g who should be presented with the first one or more messages 64a.

In some implementations, operation 656 may also include an operation 661 for determining which of the group of associated end users have one or more characteristics that match with the one or more characteristics indicated by the one or more end user profiles, the one or more end user profiles indicating one or more user enterprise hierarchy positions of those associated end users who should be presented with the first one or more messages as further depicted in FIG. 6c. For instance, the end user profile matching determining module 242 of the computing system 10 determining which of the group of associated end users 40* have one or more characteristics that match with the one or more characteristics indicated by the one or more end user profiles 66, the one or more end user profiles 66 indicating one or more user enterprise hierarchy positions (e.g., administrative assistant, controller, design engineer, and so forth) of those associated end users 40e and 40g who should be presented with the first one or more messages 64a.

In the same or different implementations, operation 656 may include an operation 662 for determining which of the group of associated end users have one or more characteristics that match with the one or more characteristics indicated by the one or more end user profiles by comparing the one or more end user profiles with computer usage of the group of associated end users to identify those associated end users who should be presented with the first one or more messages as depicted in FIG. 6d. For instance, the end user profile matching determining module 242 including the computer usage comparison module 244 (see FIG. 2b) of the computing system 10 determining which of the group of associated end users 40* have one or more characteristics that match with the one or more characteristics indicated by the one or more end user profiles 66 by having the computer usage comparison module 244 compare the one or more end user profiles 66 with computer usage of the group of associated end users 40* to identify those associated end users 40e and 40g who should be presented with the first one or more messages 64a.

In some implementations, operation 662 may further include an operation 663 for determining which of the group of associated end users have one or more characteristics that match with the one or more characteristics indicated by the one or more end user profiles by comparing the one or more end user profiles with computer research activities of the group of associated end users to identify those associated end users who should be presented with the first one or more messages as further depicted in FIG. 6d. For instance, the end user profile matching determining module 242 including the computer research activity comparison module 246 (see FIG. 2b) of the computing system 10 determining which of the group of associated end users 40* have one or more characteristics that match with the one or more characteristics indicated by the one or more end user profiles 66 by having the computer research activity comparison module 246 compare the one or more end user profiles 66 with computer research activities of the group of associated end users 40* to identify those associated end users 40e and 40g who should be presented with the first one or more messages 64a.

Operation 663 may, in turn, further include an operation 664 for determining which of the group of associated end users have one or more characteristics that match with the one or more characteristics indicated by the one or more end user profiles by comparing the one or more end user profiles with Internet search activities of the group of associated end users to identify those associated end users who should be presented with the first one or more messages as further depicted in FIG. 6d. For instance, the end user profile matching determining module 242 including the Internet search activity comparison module 248 (see FIG. 2b) of the computing system 10 determining which of the group of associated end users 40* have one or more characteristics that match with the one or more characteristics indicated by the one or more end user profiles 66 by having the Internet search activity comparison module 248 compare the one or more end user profiles 66 with Internet search activities of the group of associated end users 40* to identify those associated end users 40e and 40g who should be presented with the first one or more messages 64a.

In some implementations, operation 662 may include an operation 665 for determining which of the group of associated end users have one or more characteristics that match with the one or more characteristics indicated by the one or more end user profiles by comparing the one or more end user profiles with content of communication messages received or transmitted by the group of associated end users to identify those associated end users who should be presented with the first one or more messages as further depicted in FIG. 6d. For instance, the end user profile matching determining module 242 including the communication message comparison module 250 (see FIG. 2b) of the computing system 10 determining which of the group of associated end users 40* have one or more characteristics that match with the one or more characteristics indicated by the one or more end user profiles 66 by having the communication message comparison module 250 compare the one or more end user profiles 66 with content of communication messages (e.g., email, text message, IM, and so forth) received or transmitted by the group of associated end users 40* to identify those associated end users 40e and 40g who should be presented with the first one or more messages 64a.

In the same or different implementations, operation 662 may include an operation 666 for determining which of the group of associated end users have one or more characteristics that match with the one or more characteristics indicated by the one or more end user profiles by comparing the one or more end user profiles with contents of work-related products of the group of associated end users to identify those associated end users who should be presented with the first one or more messages as further depicted in FIG. 6e. For instance, the end user profile matching determining module 242 including the work-related product comparison module 252 (see FIG. 2b) of the computing system 10 determining which of the group of associated end users 40* have one or more characteristics that match with the one or more characteristics indicated by the one or more end user profiles 66 by having the work-related product comparison module 252 compare the one or more end user profiles 66 with contents of work-related products of the group of associated end users 40* to identify those associated end users 40e and 40g who should be presented with the first one or more messages 64a.

As further illustrated in FIG. 6e, operation 666 may further include one or more additional operations in various alternative implementations. For example, in some implementations, operation 666 may include an operation 667 for determining which of the group of associated end users have one or more characteristics that match with the one or more characteristics indicated by the one or more end user profiles by comparing the one or more end user profiles with contents of work-related products of the group of associated end users to identify those associated end users who should be presented with the first one or more messages, the work-related products being generated using one or more NC productivity applications as further depicted in FIG. 6e. For instance, the end user profile matching determining module 242 including the work-related product comparison module 252 (see FIG. 2b) of the computing system 10 determining which of the group of associated end users 40* have one or more characteristics that match with the one or more characteristics indicated by the one or more end user profiles 66 by having the work-related product comparison module 252 compare the one or more end user profiles 66 with contents of work-related products of the group of associated end users 40* to identify those associated end users 40e and 40g who should be presented with the first one or more messages 64a, the work-related products being generated using one or more NC productivity applications.

Operation 667, in turn, may further include an operation 668 for comparing the one or more end user profiles with the contents of work-related products of the group of associated end users to identify those associated end users who should be presented with the first one or more messages, at least a portion of the work-related products being generated using at least one of a word processing application, a spreadsheet application, a presentation application, a database application, a diagramming application, a publishing application, a design or engineering application, a search application, a document management application, and an accounting application as depicted in FIG. 6e. For instance, the work-related product comparison module 252 of the computing system 10 comparing the one or more end user profiles 66 with the contents of work-related products of the group of associated end users 40* to identify those associated end users 40e and 40g who should be presented with the first one or more messages 64a, at least a portion of the work-related products being generated using at least one of a word processing application, a spreadsheet application, a presentation application, a database application, a diagramming application, a publishing application, a design or engineering application, a search application, a document management application, and an accounting application.

In some implementations, operation 656 for “identifying which of the associated end users of the group of associated end users should be presented with the first one or more messages” may include an operation 669 for identifying from the group of associated end users those associated end users who should be presented with the first one or more messages based on one or more end user profiles provided by one or more sources of the first one or more of messages as depicted in FIG. 6f. For instance, the associated end user identifying module 240 of the computing system 10 identifying from the group of associated end users 40* those associated end users 40e and 40g who should be presented with the first one or more messages 64a based on one or more end user profiles 66 provided by one or more sources (e.g., an associated end user 40a or an organizational unit associated with the enterprise 30 of FIG. 1a) of the first one or more of messages 64a.

In the same or different implementations, operation 656 may include an operation 670 for identifying from the group of associated end users those associated end users who should be presented with the first one or more messages based on one or more end user profiles provided by an enterprise associated with the group of associated end users as further depicted in FIG. 6f. For instance, the associated end user identifying module 240 of the computing system 10 identifying from the group of associated end users 40* those associated end users 40e and 40g who should be presented with the first one or more messages 64a based on one or more end user profiles 66 provided by an enterprise 30 associated with the group of associated end users 40*.

In some implementations, the operation 655 for presenting the first one or more messages to the one or more associated end users by identifying which associated end users of the group of associated end users should be presented with the first one or more messages may include an operation 671 for identifying from the group of associated end users those associated end users who should be presented with the first one or more messages by at least identifying which work products of the group of associated end users include content that are relevant to content of at least one of the first one or more messages as further depicted in FIG. 6f. For instance, the associated end user identifying module 240 including the relevant work product identifying module 254 (see FIG. 2b) of the computing system 10 identifying from the group of associated end users 40* those associated end users 40e and 40g who should be presented with the first one or more messages 64a by having the relevant work product identifying module 254 at least identify which work products of the group of associated end users 40* include content that are relevant to content of at least one of the first one or more messages 64a.

As further illustrated in FIG. 6f, operation 671 may further include one or more additional operations in various alternative implementations. For example, in some implementations, operation 671 may include an operation 672 for identifying which work products of the group of associated end users include one or more words or terms that are relevant to content of the at least one of the first one or more messages as further depicted in FIG. 6f. For instance, the relevant work product identifying module 254 of the computing system 10 identifying which work products of the group of associated end users 40* include one or more words or terms that are relevant to content of the at least one of the first one or more messages 64a.

In the same or different implementations, operation 671 include an operation 673 for identifying which work products of the group of associated end users include one or more phrases that are relevant to content of the at least one of the first one or more messages as further depicted in FIG. 6f. For instance, the relevant work product identifying module 254 of the computing system 10 identifying which work products of the group of associated end users 40* include one or more phrases that are relevant to content of the at least one of the first one or more messages 64a.

In the same or different implementations, operation 671 include an operation 674 for identifying which work products of the group of associated end users include one or more symbols or icons that are relevant to content of the at least one of the first one or more messages as further depicted in FIG. 6f. For instance, the relevant work product identifying module 254 of the computing system 10 identifying which work products of the group of associated end users 40* include one or more symbols or icons that are relevant to content of the at least one of the first one or more messages 64a.

In the same or different implementations, operation 671 include an operation 675 for identifying which work products of the group of associated end users include one or more numerical values that are relevant to content of the at least one of the first one or more messages as further depicted in FIG. 6f. For instance, the relevant work product identifying module 254 of the computing system 10 identifying which work products of the group of associated end users 40* include one or more numerical values that are relevant to content of the at least one of the first one or more messages 64a.

In various implementations, the messages presenting operation 404 of FIG. 4 may include an operation 676 for presenting the second one or more messages to the one or more associated end users by identifying which associated end users of the group of associated end users should be presented with the second one or more messages as further depicted in FIG. 6g. For instance, the messages presenting module 104 including the associated end user identifying module 240 (see FIG. 2b) of the computing system 10 presenting the second one or more messages 64b to the one or more associated end users 40e and 40g by identifying which associated end users of the group of associated end users 40* should be presented with the second one or more messages 64b.

As further depicted in FIG. 6g, operation 676 may further include one or more additional operations in various alternative implementations. For example, in some implementations, operation 676 may include an operation 677 for identifying which of the associated end users of the group of associated end users should be presented with the second one or more messages by determining which of the group of associated end users have one or more characteristics that match with one or more characteristics indicated by one or more end user profiles, the one or more end user profiles indicating one or more characteristics of those associated end users who should be presented with the second one or more messages as depicted in FIG. 6g. For instance, the associated end user identifying module 240 including the end user profile matching determining module 242 (see FIG. 2b) of the computing system 10 identifying which of the associated end users of the group of associated end users 40* should be presented with the second one or more messages 64b by having the end user profile matching determining module 242 determine which of the group of associated end users 40* have one or more characteristics that match with one or more characteristics indicated by one or more end user profiles 66, the one or more end user profiles 66 indicating one or more characteristics of those associated end users 40e and 40g who should be presented with the second one or more messages 64b.

Operation 677, in turn, may further include an operation 678 for determining which of the group of associated end users have one or more characteristics that match with the one or more characteristics indicated by the one or more end user profiles, the one or more end user profiles indicating one or more types of user interests of those associated end users who should be presented with the second one or more messages as further depicted in FIG. 6g. For instance, the end user profile matching determining module 242 of the computing system 10 determining which of the group of associated end users 40* have one or more characteristics that match with the one or more characteristics indicated by the one or more end user profiles 66, the one or more end user profiles 66 indicating one or more types of user interests of those associated end users 40e and 40g who should be presented with the second one or more messages 64b.

In some implementations, operation 678 may further include an operation 679 for determining which of the group of associated end users have one or more characteristics that match with the one or more characteristics indicated by the one or more end user profiles, the one or more end user profiles indicating at least one of a health interest, a hobby interest, a technical or scientific interest, a professional interest, a consumer interest, an educational or academic interest, a financial interest, and a social interest of those associated end users who should be presented with the second one or more messages as further depicted in FIG. 6g. For instance, the end user profile matching determining module 242 of the computing system 10 determining which of the group of associated end users 40* have one or more characteristics that match with the one or more characteristics indicated by the one or more end user profiles 66, the one or more end user profiles 66 indicating at least one of a health interest, a hobby interest, a technical or scientific interest, a professional interest, a consumer interest, an educational or academic interest, a financial interest, and a social interest of those associated end users 40e and 40g who should be presented with the second one or more messages 64b.

In some implementations, operation 677 of FIG. 6g may include an operation 680 for determining which of the group of associated end users have one or more characteristics that match with the one or more characteristics indicated by the one or more end user profiles, the one or more end user profiles indicating one or more types of user interests of those associated end users who should be presented with the second one or more messages as further depicted in FIG. 6h. For instance, the end user profile matching determining module 242 of the computing system 10 determining which of the group of associated end users 40* have one or more characteristics that match with the one or more characteristics indicated by the one or more end user profiles 66, the one or more end user profiles 66 indicating one or more types of user interests of those associated end users 40e and 40g who should be presented with the second one or more messages 64b.

In some cases, operation 680 may further include an operation 681 for determining which of the group of associated end users have one or more characteristics that match with the one or more characteristics indicated by the one or more end user profiles, the one or more end user profiles indicating at least one of a particular educational background, a particular employment background, a particular technical or scientific background, a particular ethnic or religious background, a particular social background, a particular gender, a particular chronological age, and a particular sexual orientation of those associated end users who should be presented with the second one or more messages as further depicted in FIG. 6h. For instance, the end user profile matching determining module 242 of the computing system 10 determining which of the group of associated end users 40* have one or more characteristics that match with the one or more characteristics indicated by the one or more end user profiles 66, the one or more end user profiles 66 indicating at least one of a particular educational background, a particular employment background, a particular technical or scientific background, a particular ethnic or religious background, a particular social background, a particular gender, a particular chronological age, and a particular sexual orientation of those associated end users 40e and 40g who should be presented with the second one or more messages 64b.

In the same or different implementations, operation 677 may further include an operation 682 for determining which of the group of associated end users have one or more characteristics that match with the one or more characteristics indicated by the one or more end user profiles, the one or more end user profiles indicating one or more user enterprise hierarchy positions of those associated end users who should be presented with the second one or more messages as further depicted in FIG. 6h. For instance, the end user profile matching determining module 242 of the computing system 10 determining which of the group of associated end users 40* have one or more characteristics that match with the one or more characteristics indicated by the one or more end user profiles 66, the one or more end user profiles 66 indicating one or more user enterprise hierarchy positions (e.g., custodial staff, clerk, human resource coordinator, and so forth) of those associated end users 40e and 40g who should be presented with the second one or more messages 64b.

In the same or different implementations, operation 677 may include an operation 683 for determining which of the group of associated end users have one or more characteristics that match with the one or more characteristics indicated by the one or more end user profiles by comparing the one or more end user profiles with computer usage of the group of associated end users to identify those associated end users who should be presented with the second one or more messages as further depicted in FIG. 6i. For instance, the end user profile matching determining module 242 including the computer usage comparison module 244 (see FIG. 2b) of the computing system 10 determining which of the group of associated end users 40* have one or more characteristics that match with the one or more characteristics indicated by the one or more end user profiles 66 by having the computer usage comparison module 244 compare the one or more end user profiles 66 with computer usage of the group of associated end users 40* to identify those associated end users 40e and 40g who should be presented with the second one or more messages 64b.

In various implementations, operation 683 may further include one or more additional operations. For example, in some implementations, operation 683 may include an operation 684 for determining which of the group of associated end users have one or more characteristics that match with the one or more characteristics indicated by the one or more end user profiles by comparing the one or more end user profiles with computer research activities of the group of associated end users to identify those associated end users who should be presented with the second one or more messages as further depicted in FIG. 6i. For instance, the end user profile matching determining module 242 including the computer research activity comparison module 246 (see FIG. 2b) of the computing system 10 determining which of the group of associated end users 40* have one or more characteristics that match with the one or more characteristics indicated by the one or more end user profiles 66 by having the computer research activity comparison module 246 compare the one or more end user profiles 66 with computer research activities of the group of associated end users 40* to identify those associated end users 40e and 40g who should be presented with the second one or more messages 64b.

In some cases, operation 684 may further include an operation 685 for determining which of the group of associated end users have one or more characteristics that match with the one or more characteristics indicated by the one or more end user profiles by comparing the one or more end user profiles with Internet search activities of the group of associated end users to identify those associated end users who should be presented with the second one or more messages as further depicted in FIG. 6i. For instance, the end user profile matching determining module 242 including the Internet search activity comparison module 248 (see FIG. 2b) of the computing system 10 determining which of the group of associated end users 40* have one or more characteristics that match with the one or more characteristics indicated by the one or more end user profiles 66 by having the Internet search activity comparison module 248 compare the one or more end user profiles 66 with Internet search activities of the group of associated end users 40* to identify those associated end users 40e and 40g who should be presented with the second one or more messages 64b.

In some implementations, operation 683 may include an operation 686 for determining which of the group of associated end users have one or more characteristics that match with the one or more characteristics indicated by the one or more end user profiles by comparing the one or more end user profiles with content of communication messages received or transmitted by the group of associated end users to identify those associated end users who should be presented with the second one or more messages as depicted in FIG. 6i. For instance, the end user profile matching determining module 242 including the communication message comparison module 250 of the computing system 10 determining which of the group of associated end users 40* have one or more characteristics that match with the one or more characteristics indicated by the one or more end user profiles 66 by having the communication message comparison module 250 compare the one or more end user profiles 66 with content of communication messages (e.g., emails, text messages, IMs, and so forth) received or transmitted by the group of associated end users 40* to identify those associated end users 40e and 40g who should be presented with the second one or more messages 64b.

In the same or different implementations, operation 683 may include an operation 687 for determining which of the group of associated end users have one or more characteristics that match with the one or more characteristics indicated by the one or more end user profiles by comparing the one or more end user profiles with contents of work-related products of the group of associated end users to identify those associated end users who should be presented with the second one or more messages as depicted in FIG. 6j. For instance, the end user profile matching determining module 242 including the work-related product comparison module 252 of the computing system 10 determining which of the group of associated end users 40* have one or more characteristics that match with the one or more characteristics indicated by the one or more end user profiles 66 by having the work-related product comparison module 252 compare the one or more end user profiles 66 with contents of work-related products of the group of associated end users 40* to identify those associated end users 40e and 40g who should be presented with the second one or more messages 64b.

Operation 687, in turn, may further include an operation 688 for determining which of the group of associated end users have one or more characteristics that match with the one or more characteristics indicated by the one or more end user profiles by comparing the one or more end user profiles with contents of work-related products of the group of associated end users to identify those associated end users who should be presented with the second one or more messages, the work-related products being generated using one or more NC productivity applications as further depicted in FIG. 6j. For instance, the end user profile matching determining module 242 including the work-related product comparison module 252 of the computing system 10 determining which of the group of associated end users 40* have one or more characteristics that match with the one or more characteristics indicated by the one or more end user profiles 66 by having the work-related product comparison module 252 compare the one or more end user profiles 66 with contents of work-related products of the group of associated end users 40* to identify those associated end users 40e and 40g who should be presented with the second one or more messages 64b, the work-related products being generated using one or more NC productivity applications.

Operation 688, in various implementations, may further include an operation 689 for comparing the one or more end user profiles with the contents of work-related products of the group of associated end users to identify those associated end users who should be presented with the second one or more messages, at least a portion of the work-related products being generated using at least one of a word processing application, a spreadsheet application, a presentation application, a database application, a diagramming application, a publishing application, a design or engineering application, a search application, a document management application, and an accounting application as depicted in FIG. 6j. For instance, the work-related product comparison module 252 of the computing system 10 comparing the one or more end user profiles 66 with the contents of work-related products of the group of associated end users 40* to identify those associated end users 40e and 40g who should be presented with the second one or more messages 64b, at least a portion of the work-related products being generated using at least one of a word processing application, a spreadsheet application, a presentation application, a database application, a diagramming application, a publishing application, a design or engineering application, a search application, a document management application, and an accounting application.

In some implementations, operation 677 of FIG. 6g may further include an operation 690 for identifying from the group of associated end users those associated end users who should be presented with the second one or more messages based on one or more end user profiles provided by one or more sources of the second one or more messages as depicted in FIG. 6k. For instance, the associated end user identifying module 240 of the computing system 10 identifying from the group of associated end users 40* those associated end users 40e and 40g who should be presented with the second one or more messages 64b based on one or more end user profiles 66 provided by one or more sources of the second one or more messages 64b.

In the same or different implementations, operation 677 may include an operation 691 for identifying from the group of associated end users those associated end users who should be presented with the second one or more messages based on one or more end user profiles provided by one or more enterprises associated with the second one or more messages as further depicted in FIG. 6k. For instance, the associated end user identifying module 240 of the computing system 10 identifying from the group of associated end users 40* those associated end users 40e and 40g who should be presented with the second one or more messages 64b based on one or more end user profiles 66 provided by one or more enterprises (e.g., a third party enterprise that is unrelated to the group of associated end users 40*) associated with the second one or more messages 64b.

In some implementations, operation 676 of FIG. 6g may further include an operation 692 for identifying from the group of associated end users those associated end users who should be presented with the second one or more messages by at least identifying which work products of the group of associated end users include content that are relevant to content of at least one of the second one or more messages as depicted in FIG. 6k. For instance, the associated end user identifying module 240 including the relevant work product identifying module 254 of the computing system 10 identifying from the group of associated end users 40* those associated end users 40e and 40g who should be presented with the second one or more messages 64b by having the relevant work product identifying module 254 at least identify which work products of the group of associated end users 40* include content that are relevant to content of at least one of the second one or more messages 64b.

Operation 692, in turn, may include one or more additional operations in various alternative implementations. For example, in some implementations, operation 692 may further include an operation 693 for identifying which work products of the group of associated end users include one or more words or terms that are relevant to content of the at least one of the second one or more messages as further depicted in FIG. 6k. For instance, the relevant work product identifying module 254 of the computing system 10 identifying which work products of the group of associated end users 40* include one or more words or terms that are relevant to content of the at least one of the second one or more messages 64b.

In the same or different implementations, operation 692 may include an operation 694 for identifying which work products of the group of associated end users include one or more phrases that are relevant to content of the at least one of the second one or more messages as further depicted in FIG. 6k. For instance, the relevant work product identifying module 254 of the computing system 10 identifying which work products of the group of associated end users 40* include one or more phrases that are relevant to content of the at least one of the second one or more messages 64b.

In the same or different implementations, operation 692 may include an operation 695 for identifying which work products of the group of associated end users include one or more symbols or icons that are relevant to content of the at least one of the second one or more messages as further depicted in FIG. 6k. For instance, the relevant work product identifying module 254 of the computing system 10 identifying which work products of the group of associated end users 40* include one or more symbols or icons that are relevant to content of the at least one of the second one or more messages 64b.

In the same or different implementations, operation 692 may include an operation 696 for identifying which work products of the group of associated end users include one or more numerical values that are relevant to content of the at least one of the second one or more messages as further depicted in FIG. 6k. For instance, the relevant work product identifying module 254 of the computing system 10 identifying which work products of the group of associated end users 40* include one or more numerical values that are relevant to content of the at least one of the second one or more messages 64b.

In various implementations, the messages presenting operation 404 of FIG. 4 may include an operation 697 for presenting to the one or more associated end users the first one or more messages and the second one or more messages in a manner such that the first one or more messages are displayed or audioally indicated through the channel during a first point-in-time and the second one or more messages are displayed or audioally indicated through the channel during a second point-in-time as depicted in FIG. 61. For instance, the messages presenting module 104 of the computing system 10 presenting (e.g., transmitting or providing) to the one or more associated end users 40e and 40g the first one or more messages 64a and the second one or more messages 64b in a manner such that the first one or more messages 64a are displayed or audioally indicated through the channel during a first point-in-time and the second one or more messages 64b are displayed or audioally indicated through the channel during a second point-in-time.

In some embodiments, the messages presenting operation 404 of FIG. 4 may include an operation 698 for presenting to the one or more associated end users the first one or more messages and the second one or more messages in a manner such that the first one or more messages are displayed or audioally indicated through the channel during a first time interval and the second one or more messages are displayed or audioally indicated through the channel during a second time interval as depicted in FIG. 61. For instance, the messages presenting module 104 of the computing system 10 presenting (e.g., transmitting or providing) to the one or more associated end users 40e and 40g the first one or more messages 64a and the second one or more messages 64b in a manner such that the first one or more messages 64a are displayed or audioally indicated through the channel during a first time interval and the second one or more messages 64b are displayed or audioally indicated through the channel during a second time interval.

In some embodiments, the messages presenting operation 404 of FIG. 4 may include an operation 699 for presenting to the one or more associated end users the first one or more messages and the second one or more messages in a manner such that the first one or more messages and the second one or more messages are at least partially concurrently displayed or audioally indicated together through the channel as depicted in FIG. 6l. For instance, the messages presenting module 104 of the computing system 10 presenting (e.g., transmitting or providing) to the one or more associated end users 40e and 40g the first one or more messages 64a and the second one or more messages 64b in a manner such that the first one or more messages 64a and the second one or more messages 64b are at least partially concurrently displayed or audioally indicated together through the channel. For example, displaying both the first one or more messages 64a and the second one or more messages 64b concurrently in two display windows.

Turning now to FIG. 7, which is a high-level block diagram illustrating a particular implementation of the computing system 10 of FIG. 1b. As illustrated, the computing system 10, which in some cases may comprise of one or more network devices such as one or more servers, may include one or more processors 702 (e.g., one or more microprocessors, one or more controllers, and so forth) linked to storage medium 706 (e.g., volatile and/or non-volatile memory). The storage medium 706 may store computer readable instructions 704 (e.g., computer program product). The processor 702, in various implementations, may execute the computer readable instructions 704 in order to execute one or more operations described above and as illustrated in FIGS. 4, 5a, 5b, 5c, 5d, 5e, 5f, 5g, 6a, 6b, 6c, 6d, 6e, 6f, 6g, 6h, 6i, 6j, 6k, and 6l.

For example, the processor 702 may execute the computer readable instructions 704 in order to provide at least to one or more associated end users from a group of associated end users a non-communication (NC) productivity application interface including a channel for accessing messages; and/or to present to the one or more associated end users, via the channel, at least a first one or more messages and a second one or more messages, the first one or more messages being associated with the group of associated end users and the second one or more messages being independent of the group of associated end users as illustrated by the operational flow 400 of FIG. 4.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

1.-201. (canceled)

202. A system, comprising:
a non-communication (NC) productivity application interface providing module configured to provide a non-communication (NC) productivity application interface including a channel for accessing messages to at least one or more associated end users from a group of associated end users; and
a messages presenting module configured to present at least a first one or more messages and a second one or more messages to the one or more associated end users via the channel, the first one or more messages being associated with the group of associated end users and the second one or more messages being independent of the group of associated end users.

203.-205. (canceled)

206. The system of claim 202, wherein said non-communication (NC) productivity application interface providing module comprises:
an NC productivity application interface providing module configured to provide an NC productivity application display interface including the channel for accessing the messages to at least the one or more associated end users.

207. The system of claim 206, wherein said NC productivity application interface providing module comprises:
an NC productivity application interface providing module configured to provide an NC productivity application display interface including a display window for accessing the messages to at least the one or more associated end users.

208. The system of claim 206, wherein said NC productivity application interface providing module comprises:
an NC productivity application interface providing module configured to provide an NC productivity application display interface including a plurality of display windows for accessing the messages to at least the one or more associated end users.

209. The system of claim 208, wherein said NC productivity application interface providing module comprises:
an NC productivity application interface providing module configured to provide an NC productivity application display interface including at least a first display window for accessing the first one or more messages and second display window for accessing the second one or more messages, the NC productivity application display interface to be provided to the one or more associated end users.

210. The system of claim 206, wherein said NC productivity application interface providing module comprises:
an NC productivity application interface providing module configured to provide the NC productivity application display interface including the channel for accessing the messages to the one or more associated end users, the NC productivity application display interface including at least a tool-bar portion and a workspace portion.

211. The system of claim 210, wherein said NC productivity application interface providing module comprises:
an NC productivity application interface providing module configured to provide the NC productivity application display interface including at least one window for accessing the messages to the one or more associated end users, the at least one window disposed at least in the tool-bar portion.

212. The system of claim 211, wherein said NC productivity application interface providing module comprises:
an NC productivity application interface providing module configured to provide the NC productivity application display interface including at least one window for accessing the messages to the one or more associated end users, the at least one window replacing at least a portion of the tool-bar portion that previously indicated one or more tool-bar icons that was previously included in the tool-bar portion.

213. The system of claim 210, wherein said NC productivity application interface providing module comprises:
an NC productivity application interface providing module configured to provide the NC productivity application display interface including at least one window for accessing the messages to the one or more associated end users, the at least one window disposed at least in the workspace portion.

214. The system of claim 210, wherein said NC productivity application interface providing module comprises:
an NC productivity application interface providing module configured to provide the NC productivity application display interface including at least one window for accessing the messages to the one or more associated end users, the at least one window disposed at least in the tool-bar portion and the workspace portion.

215. The system of claim 202, wherein said non-communication (NC) productivity application interface providing module comprises:
an NC productivity application interface providing module configured to provide an NC productivity application audio interface including the channel for accessing the messages to the one or more associated end users.

216. The system of claim 215, wherein said NC productivity application interface providing module comprises:
an NC productivity application interface providing module configured to provide an NC productivity application audio interface including an audio window for accessing the messages to the one or more associated end users.

217.-243. (canceled)

244. The system of claim 202, wherein said messages presenting module comprises:
a transmitting module configured to transmit the first one or more messages and the second one or more messages in a form that are visually displayable through the channel.

245. The system of claim 202, wherein said messages presenting module comprises:
a transmitting module configured to transmit the first one or more messages and the second one or more messages in a form that are audioally indictable through the channel.

246. The system of claim 202, wherein said messages presenting module comprises:
a transmitting module configured to transmit one or more electronic copies of the first one or more messages and the second one or more messages to the one or more associated end users.

247. The system of claim 246, wherein said transmitting module comprises:
a network transmitting module configured to transmit, via at least one communication network, the one or more electronic copies of the first one or more messages and the second one or more messages.

248. The system of claim 246, wherein said transmitting module comprises:
an Internet transmitting module configured to transmit, via the Internet, the one or more electronic copies of the first one or more messages and the second one or more messages.

249. The system of claim 202, wherein said messages presenting module comprises:
a messages presenting module configured to present the first one or more messages to the one or more associated end users, the first one or more messages to be presented including at least one message from an organization associated with the group of associated end users.

250. The system of claim 249, wherein said messages presenting module comprises:
a messages presenting module configured to present the first one or more messages to the one or more associated end users, the first one or more messages to be presented including at least one message from an enterprise associated with the group of associated end users.

251. The system of claim 250, wherein said messages presenting module comprises:
a messages presenting module configured to present the first one or more messages to the one or more associated end users, the first one or more messages to be presented including at least one message originating from an organizational unit of the enterprise.

252. The system of claim 250, wherein said messages presenting module comprises:
a messages presenting module configured to present the first one or more messages to the one or more associated end users, the first one or more messages to be presented including at least one message originating from at least one member of the enterprise.

253. The system of claim 202, wherein said messages presenting module comprises:
a messages presenting module configured to present the second one or more messages to the one or more associated end users, the second one or more messages to be presented including at least one message originating from at least one organization that is unrelated to the group of associated end users.

254. The system of claim 202, wherein said messages presenting module comprises:
a messages presenting module configured to present the second one or more messages to the one or more associated end users, the second one or more messages to be presented including at least one message originating from at least one advertiser.

255. The system of claim 254, wherein said messages presenting module comprises:
a messages presenting module configured to present at least one advertisement from the at least one advertiser to the one or more associated end users.

256. The system of claim 202, wherein said messages presenting module comprises:
an associated end user identifying module configured to identify which associated end users from the group of associated end users should be presented with the first one or more messages.

257. The system of claim 256, wherein said associated end user identifying module comprises:
an end user profile matching determining module configured to determine which associated end users from the group of associated end users has one or more characteristics that match with one or more characteristics indicated by one or more end user profiles, the one or more end user profiles indicating one or more characteristics of those associated end users who should be presented with the first one or more messages.

258. The system of claim 257, wherein said end user profile matching determining module comprises:
an end user profile matching determining module configured to determine which associated end users from the group of associated end users has one or more characteristics that match with the one or more characteristics indicated by the one or more end user profiles, the one or more end user profiles indicating one or more types of user interests of those associated end users who should be presented with the first one or more messages.

259. The system of claim 258, wherein said end user profile matching determining module comprises:
an end user profile matching determining module configured to determine which associated end users from the group of associated end users has one or more characteristics that match with the one or more characteristics indicated by the one or more end user profiles, the one or more end user profiles indicating at least one of a health interest, a hobby interest, a technical or scientific interest, a professional interest, a consumer interest, an educational or academic interest, a financial interest, and a social interest of those associated end users who should be presented with the first one or more messages.

260. The system of claim 257, wherein said end user profile matching determining module comprises:
an end user profile matching determining module configured to determine which associated end users from the group of associated end users has one or more characteristics that match with the one or more characteristics indicated by the one or more end user profiles, the one or more end user profiles indicating one or more types of user interests of those associated end users who should be presented with the first one or more messages.

261. The system of claim 260, wherein said end user profile matching determining module comprises:
an end user profile matching determining module configured to determine which associated end users from the group of associated end users has one or more characteristics that match with the one or more characteristics indicated by the one or more end user profiles, the one or more end user profiles indicating at least one of a particular educational background, a particular employment background, a particular technical or scientific background, a particular ethnic or religious background, a particular social background, a particular gender, a particular chronological age, and a particular sexual orientation of those associated end users who should be presented with the first one or more messages.

262. The system of claim 257, wherein said end user profile matching determining module comprises:
an end user profile matching determining module configured to determine which associated end users from the group of associated end users has one or more characteristics that match with the one or more characteristics indicated by the one or more end user profiles, the one or more end user profiles indicating one or more user enterprise hierarchy positions of those associated end users who should be presented with the first one or more messages.

263. The system of claim 257, wherein said end user profile matching determining module comprises:
a computer usage comparison module configured to compare the one or more end user profiles with computer usage of the group of associated end users to identify those associated end users who should be presented with the first one or more messages.

264. The system of claim 263, wherein said computer usage comparison module comprises:
a computer research activity comparison module configured to compare the one or more end user profiles with computer research activities of the group of associated end users to identify those associated end users who should be presented with the first one or more messages.

265. (canceled)

266. The system of claim 263, wherein said computer usage comparison module comprises:
a communication message comparison module configured to compare the one or more end user profiles with content of communication messages received or transmitted by the group of associated end users to identify those associated end users who should be presented with the first one or more messages.

267. The system of claim 263, wherein said computer usage comparison module comprises:
a work-related product comparison module configured to compare the one or more end user profiles with contents of work-related products of the group of associated end users to identify those associated end users who should be presented with the first one or more messages.

268. The system of claim 267, wherein said work-related product comparison module comprises:
a work-related product comparison module configured to compare the one or more end user profiles with contents of work-related products of the group of associated end users to identify those associated end users who should be presented with the first one or more messages, the work-related products being generated using one or more NC productivity applications.

269. The system of claim 268, wherein said work-related product comparison module comprises:
a work-related product comparison module configured to compare the one or more end user profiles with the contents of work-related products of the group of associated end users to identify those associated end users who should be presented with the first one or more messages, at least a portion of the work-related products being generated using at least one of a word processing application, a spreadsheet application, a presentation application, a database application, a diagramming application, a publishing application, a design or engineering application, a document management application, and an accounting application.

270. (canceled)

271. The system of claim 257, wherein said associated end user identifying module comprises:
an associated end user identifying module configured to identify from the group of associated end users those associated end users who should be presented with the first one or more messages based on one or more end user profiles provided by an enterprise associated with the group of associated end users.

272. The system of claim 256, wherein said associated end user identifying module comprises:
a relevant work product identifying module configured to identify which work products of the group of associated end users include content that are relevant to content of at least one of the first one or more messages.

273. The system of claim 272, wherein said relevant work product identifying module comprises:
a relevant work product identifying module configured to identify which work products of the group of associated end users include one or more words or terms that are relevant to content of the at least one of the first one or more messages.

274. The system of claim 272, wherein said relevant work product identifying module comprises:
a relevant work product identifying module configured to identify which work products of the group of associated end users include one or more phrases that are relevant to content of the at least one of the first one or more messages.

275. The system of claim 272, wherein said relevant work product identifying module comprises:
a relevant work product identifying module configured to identify which work products of the group of associated end users include one or more symbols or icons that are relevant to content of the at least one of the first one or more messages.

276. The system of claim 272, wherein said relevant work product identifying module comprises:
a relevant work product identifying module configured to identify which work products of the group of associated end users include one or more numerical values that are relevant to content of the at least one of the first one or more messages.

277.-297. (canceled)

298. The system of claim 202, wherein said messages presenting module comprises:
a messages presenting module configured to present the first one or more messages and the second one or more messages in a manner such that the first one or more messages are displayed or audioally indicated through the channel during a first point-in-time and the second one or more messages are displayed or audioally indicated through the channel during a second point-in-time.

299. The system of claim 202, wherein said messages presenting module comprises:
a messages presenting module configured to present the first one or more messages and the second one or more messages to the one or more associated end users in a manner such that the first one or more messages are displayed or audioally indicated through the channel during a first time interval and the second one or more messages are displayed or audioally indicated through the channel during a second time interval.

300. (canceled)
